(19) United States
(12) Patent Application Publication
(10) Pub. No.: US 2016/0283420 A1
(43) Pub. Date: Sep. 29, 2016

(54) TRANSACTION PROCESSING SYSTEM, TRANSACTION PROCESSING METHOD AND TRANSACTION EQUIPMENT

(71) Applicant: PANASONIC INTELLECTUAL PROPERTY MANAGEMENT CO., LTD., Osaka (JP)

(72) Inventor: Ichiro HAGA, Fukuoka (JP)

(73) Assignee: PANASONIC INTELLECTUAL PROPERTY MANAGEMENT CO., LTD., Osaka (JP)

(21) Appl. No.: 15/066,254

(22) Filed: Mar. 10, 2016

(30) Foreign Application Priority Data
Mar. 27, 2015 (JP) 2015-067320
Mar. 27, 2015 (JP) 2015-067321
Apr. 17, 2015 (JP) 2015-085452
Apr. 17, 2015 (JP) 2015-085453
Aug. 5, 2015 (JP) 2015-155444

(51) Int. Cl. G06F 13/24; G06F 13/40; G06F 13/22

(52) U.S. Cl. CPC G06F 13/24; G06F 13/22; G06F 13/4068

(57) ABSTRACT

A transaction processing system includes portable transaction equipment, and a docking device which is capable of being connected to various peripheral equipment and of being attached to and detached from the transaction equipment. The transaction equipment is set in a state in which an operation of the transaction equipment is restricted in a case where it is not checked that the transaction equipment is connected to the docking device connected to at least one peripheral equipment. The transaction equipment is set in a state in which an operation for a specific application is restricted in a case where a user with a specific authority does not log on after it is checked that authentication fails through the detachment of the transaction equipment from the docking device. The transaction equipment performs a transaction process by performing communication connection with permitted peripheral equipment based on identification information thereof.

### BACKGROUND OF THE INVENTION

1. Field of the Invention

The present disclosure relates to a transaction processing system, a transaction processing method and transaction equipment used to perform at least one procedure of a merchandise registration process and a settlement process in a commercial transaction.

2. Description of the Related Art

In a store (for example, a convenience store), a merchandise registration process of registering merchandise items as sales targets in a commercial transaction (for example, merchandise sales, the same applies later) in a POS (Point Of Sales) terminal such as cash register is generally performed. For example, the POS terminal is a stationary type as in a POS terminal with a fixed scanner which is described in Japanese Patent Unexamined Publication No. 04-279995, and is fixedly provided in, for example, an exclusive counter of a store in many cases. In the POS terminal with a fixed scanner which is described in Japanese Patent Unexamined Publication No. 04-279995, a fixed scanner is supported by a supporting stand of the POS terminal through support means so as to be moved in upward and downward directions and forward, backward, leftward and rightward directions and so as to be tilted and rotated. In the merchandise registration process, a salesperson directly performs a touch input of merchandise items as sales targets on a touch panel provided at the POS terminal without using the fixed scanner, or performs a touch input of merchandise items displayed on a touch panel of portable transaction equipment in which an application for merchandise registration is installed so as to be executable in some cases.

For example, when a settlement process using a card (for example, a credit card) is performed in order to pay the amount of money required in the commercial transaction, in a case where an authorization inquiry about a owner of the card is performed and a response indicating that there are no particular problems with the authorization is obtained, the POS terminal transmits sales information to a settlement server (for example, a settlement center device operated by a settlement center or a settlement relay center device operated by a settlement relay center) connected to the POS terminal via a communication network (sales registration). In the settlement process, portable transaction equipment (for example, a settlement terminal) in which an application for a settlement process is installed so as to be executable and communication can be performed with the settlement server is used instead of the POS terminal in some cases.

Preventive measures against an unauthorized operation or an unauthorized input on the POS terminal or the settlement terminal is a very important issue, but a possibility that the unauthorized operation will occur depends on the environment in which the equipment is provided. In a case where the settlement terminal is a fixed device that is fixed in a predetermined place in a store, it is considered that a possibility that the unauthorized operation will be performed is low due to a physical deterrent effect based on the difficulty of movement and a conspicuous psychological deterrent effect. Even in a case where the settlement terminal is a portable settlement device, if the device is provided while being fixed in the predetermined place (is locked into a predetermined device or is latched on a predetermined place by using a wire which is hardly broken), it is considered that a possibility that the unauthorized operation will be performed is low due to the physical deterrent effect and the conspicuous psychological deterrent effect.

However, in the portable settlement device, on the assumption that the device is carried out of the predetermined place and is operated, the physical deterrent effect and the psychological deterrent effect due to the carrying of the device are decreased, and thus, a possibility that the unauthorized operation will occur becomes high. In Japanese Patent Unexamined Publication No. 04-279995, a technology in which at least one procedure of the merchandise registration process and the settlement process using the portable transaction equipment is performed is not disclosed. There is a concern that a relevant person including a card user may suffer from unpredicted disadvantages which include, for example, a direct pecuniary loss, a leakage of personal information, and alteration or destruction of information within the settlement device due to the unauthorized operation on the portable settlement device.

There is a concern that unpredicted disadvantages may occur due to an erroneous operation of a staff member in the store on the settlement device other than an intentional unauthorized operation. It is necessary to improve the convenience of the settlement device by preventing such an unauthorized operation and providing preventive measures to the settlement device such that the unpredicted disadvantages do not occur.

For example, peripheral equipments such as a keyboard for inputting items or quantities of merchandises, a printer for printing a receipt related to the sales of the merchandises, a drawer for storing cash, and a display for displaying a sales amount of money to a customer are provided in, or are connected to the POS terminal provided in the store or near the POS terminal. Since the POS terminal is provided on the exclusive counter in the store, in order to improve operation convenience when the procedure of the merchandise registration process or the settlement process of the salesperson is performed, it is preferable to distinguish between a case where the portable transaction equipment and the peripheral equipment are used in cooperation with each other and a case where the transaction equipment is independently used.

The preventive measure against the unauthorized operation or the unauthorized input on the POS terminal or the settlement terminal is also a very important issue in order to prevent deterioration of the reliability of the store, but a possibility that the unauthorized operation will occur greatly depends on the environment in which the POS terminal or the settlement terminal is provided. For example, in a case where the transaction equipment is a fixed device that is fixed in a predetermined place in a store, it is considered that a possibility that the unauthorized operation will be performed is low due to a physical deterrent effect based on the difficulty of movement and a conspicuous psychological deterrent effect. Even in a case where the transaction equipment is a portable type, if the transaction equipment is provided while being fixed in the predetermined place (for example, the transaction equipment is locked into a predetermined device or is latched on a predetermined place by using a wire which is hardly broken), it is considered that a possibility that the unauthorized operation will be performed is low due to the physical deterrent effect and the conspicuous psychological deterrent effect.

However, in the portable transaction equipment, it is easy to carry the equipment out of the predetermined place and to operate the equipment, and the physical deterrent effect and the psychological deterrent effect due to the carrying of the device are decreased. As a result, a possibility that the unauthorized operation will occur becomes high. There is a concern that an involved person including a card user may suffer from unpredicted disadvantages which include, for example, a direct pecuniary loss, a leakage of personal information, and alteration or destruction of information within the transaction equipment due to the unauthorized operation on the portable transaction equipment. It is necessary to improve operation convenience while ensuring the continuity of a business when the transaction equipment is independently used by preventing such an unauthorized operation and providing a security countermeasure to the transaction equipment such that the unpredicted disadvantages do not occur.

In addition, if the portable transaction equipment and the peripheral equipment can cooperate at the time of the establishment of physical connection therebetween, there is a concern that safety at the time of the transaction process such as the merchandise registration process or the settlement process may be degraded depending on the attribute (classification) of the peripheral equipment or a user who uses the transaction equipment.

### SUMMARY OF THE INVENTION

An object of the present disclosure is to prepare preventive measures against an unauthorized operation with a simple operation without requiring a complicated setting operation in a case where portable transaction equipment and peripheral equipment used in at least one procedure of a merchandise registration process and a settlement process are used in cooperation with each other.

An object of the present disclosure is also to guarantee continuity in a business procedure by preparing security countermeasures against an unauthorized operation with a simple operation without requiring a complicated setting operation, even when the transaction equipment is used in at least one procedure of the merchandise registration process and the settlement process, as single equipment.

An object of the present disclosure is also to improve safety at the time of a transaction process in the case where the portable transaction equipment and the peripheral equipment cooperate.

According to the present disclosure, there is provided transaction equipment or a transaction processing method in the transaction equipment including: an application controller that controls the execution of a predetermined application, and checks whether or not the transaction equipment is connected to a docking device connected to at least one peripheral equipment used in the application. The application controller sets the transaction equipment to be in an operation restriction state in which an operation is restricted in a case where the connection check fails.

According to the present disclosure, there is provided transaction equipment or a transaction processing method in the transaction equipment including: an application controller that controls the execution of a predetermined application, and checks whether or not the transaction equipment is connected to a docking device connected to at least one peripheral equipment used in the application. The application controller sets the transaction equipment to be in an operation restriction state in which an operation is restricted in a case where the connection check fails and the detachment of the transaction equipment from the docking device is not performed according to a predetermined procedure.

According to the present disclosure, there is provided transaction equipment or a transaction processing method in the transaction equipment including: an application controller that controls the execution of a predetermined application, and checks whether or not transaction equipment is connected to a docking device connected to at least one peripheral equipment used in the application. The application controller determines whether or not the detachment of the transaction equipment from the docking device is performed according to a predetermined procedure when the connection check fails, and changes the setting of the transaction equipment between a predetermined procedure case where the detachment is performed according to the predetermined procedure and an abnormality procedure case where the detachment is not performed according to the predetermined procedure.

According to the present disclosure, there is provided a transaction processing system including: the transaction equipment; and a docking device which is capable of being connected to peripheral equipment used in a transaction process and is capable of being attached to and detached from the transaction equipment.

According to the present disclosure, even in a case where the portable transaction equipment is detached from the docking device, it is possible to effectively prevent the unauthorized operation without the complicated operation. Thus, for example, it is possible to prevent an involved person including a card user from suffering from unpredicted disadvantages which include, for example, a direct pecuniary loss, a leakage of personal information, and alteration or destruction of information within the settlement device.

According to the present disclosure, even when the transaction equipment is used in at least one procedure of the merchandise registration process and the settlement process, as single equipment, it is possible to guarantee continuity in a business procedure by preparing a security countermeasure against an unauthorized operation with a simple operation without requiring a complicated setting operation.

According to the present disclosure, it is possible to improve safety at the time of the transaction process in the case where the portable transaction equipment and the peripheral equipment cooperate.

### BRIEF DESCRIPTION OF DRAWINGS

FIG. 1 is a diagram showing an example of the system configuration of a transaction processing system of the present exemplary embodiment;

FIG. 2 is a diagram for describing an example of a state in which transaction equipment is attached to or is detached from a docking device;

FIG. 3 is a diagram showing an example of a state in which the transaction equipment is attached to the docking device;

FIG. 4A is a diagram showing an example of the docking device in which an upper supporting part is rotated around a lower supporting part through a hinge in a tilt direction (arrow v1 direction);

FIG. 4B is a diagram showing an example of the docking device in which a holder rotation part rotates an equipment holder in an arrow v2 direction about 90 degrees from the position in the state of FIG. 4A;

FIG. 4C is a diagram showing an example of the docking device in which a rotatable pedestal is rotated in a panning direction (arrow v3 direction) from the position in the state of FIG. 3;

FIG. 5 is a diagram showing an example of the hardware configuration of the transaction equipment of the present exemplary embodiment;

FIG. 6 is a diagram showing an example of the hardware configuration of the docking device of the present exemplary embodiment;

FIG. 7A is a diagram showing a first example in which an operation screen of a card settlement application executable in the transaction equipment is displayed on a touch panel of the transaction equipment;

FIG. 7B is a diagram showing a second example in which the operation screen of the card settlement application executable in the transaction equipment is displayed on the touch panel of the transaction equipment;

FIG. 8 is a diagram showing an example in which a screen of a merchandise registration application executable in the transaction equipment is displayed on the touch panel of the transaction equipment;

FIG. 9 is a flowchart for describing a first example of the operation of the transaction equipment in a case where the transaction equipment is attached to the docking device;

FIG. 10 is an example of an unlocked state screen displayed on the transaction equipment in an unlocked state;

FIG. 11 is a flowchart for describing a first example of the operation of the transaction equipment in a case where the transaction equipment is normally detached from the docking device;

FIG. 12 is an example of a locked state screen displayed on the transaction equipment in a locked state;

FIG. 13 is a flowchart for describing a second example of the operation of the transaction equipment in a case where the transaction equipment is attached to the docking device;

FIG. 14 is an example of an attachment function table used in a case where the transaction equipment is attached to the docking device;

FIG. 15 is a flowchart for describing a second example of the operation of the transaction equipment in a case where the transaction equipment is detached from the docking device;

FIG. 16 is an example of a detachment function table used in a case where the transaction equipment is detached from the docking device;

FIG. 17 is an example of a function restriction state screen displayed on the transaction equipment in a state in which the function is restricted;

FIG. 18 is a flowchart for describing a third example of the operation of the transaction equipment in a case where the transaction equipment is attached to the docking device;

FIG. 19 is an example of a detachment procedure table in which predetermined procedure items to be adopted are represented in a list form at the time of detaching the transaction equipment from the docking device;

FIG. 20 is an example in which a state in which the executed procedure items are marked and are represented in a table form;

FIG. 21 is an example in which execution histories are represented in a table form;

FIG. 22 is a flowchart for describing an operation subsequent to the operation of the flowchart of FIG. 18;

FIG. 23 is a flowchart for describing an operation that can be optionally performed between S58 and S59 of FIG. 22, and is a modification example of the third example;

FIG. 24 is a flowchart for describing an operation procedure of setting the transaction equipment in an unlocked state again after the operation of FIG. 22;

FIG. 25 is a flowchart for describing an operation procedure of setting the transaction equipment in the unlocked state again after the setting of FIG. 23 is performed;

FIG. 26 is a modification example of a process after S58 of FIG. 22, and is a flowchart for describing a fourth example of a detachment operation of the transaction equipment from the docking device;

FIG. 27 is another modification example of a process after S58 of FIG. 22, and is a flowchart for describing a fifth example of the detachment operation of the transaction equipment from the docking device;

FIG. 28 is an example of Table 1 that restricts the functions of the transaction equipment;

FIG. 29 is an example of Table 2 that restricts the functions of the transaction equipment;

FIG. 30 is another modification example of a process after S58 of FIG. 22, and is a flowchart for describing a sixth example of the detachment operation of the transaction equipment from the docking device;

FIG. 31A is a flowchart for describing an example of an operation procedure of initial registration of the transaction equipment;

FIG. 31B is a flowchart for describing an example of an operation procedure when the transaction equipment is attached to the docking device;

FIG. 32 is a flowchart for describing a first example of an operation procedure when the transaction equipment is detached from the docking device;

FIG. 33 is a table showing a first example of user information;

FIG. 34 is a flowchart for describing a second example of the operation procedure when the transaction equipment is detached from the docking device;

FIG. 35 is a table showing a second example of the user information;

FIG. 36 is a flowchart for describing a first example of an operation procedure when the transaction equipment is attached to the docking device after the transaction equipment is detached from the docking device;

FIG. 37 is a flowchart for describing a second example of the operation procedure when the transaction equipment is attached to the docking device after the transaction equipment is detached from the docking device;

FIG. 38A is a diagram showing a first example of a screen showing a state in which the use of the transaction equipment is locked;

FIG. 38B is a diagram showing a second example of the screen showing a state in which the use of the transaction equipment is locked;

FIG. 38C is a diagram showing a third example of the screen showing a state in which the use of the transaction equipment is locked;

FIG. 38D is a diagram showing an example of a business menu screen when a user logs on with the authority of a store manager;

FIG. 38E is a diagram showing an example of a business menu screen when a user logs on with the authority of a temporary salesperson;

FIG. 38F is a diagram showing an example of a business menu screen when a user logs on with the authority of a part-time salesperson;

FIG. 39A is a diagram showing a first example of a screen when user information is registered;

FIG. 39B is a diagram showing a second example of the screen when the user information is registered;

FIG. 39C is a diagram showing another example of the operation screen of a merchandise registration application;

FIG. 39D is a diagram showing an example of an operation screen of a merchandise inventory application;

FIG. 40 is a schematic diagram showing an example of a function use restriction table.

FIG. 41 is a flowchart showing an operation example of the transaction equipment;

FIG. 42 is a schematic diagram showing an example of the connection form of a cradle set capable of performing a cash settlement;

FIG. 43 is a schematic diagram showing an example of the connection form of a cradle set capable of performing a card settlement;

FIG. 44 is a schematic diagram showing an example of the connection form of a cradle set capable of performing returned-merchandise reception;

FIG. 45 is a schematic diagram showing an example of the connection form of a cradle set capable of performing delivery reception;

FIG. 46 is a schematic diagram showing an example of the connection form of a cradle set capable of performing merchandise registration;

FIG. 47 is a schematic diagram showing an example of a communication connection authority table;

FIG. 48 is a flowchart showing the operation example of the transaction equipment;

FIG. 49 is a schematic diagram showing an example of the communication connection authority table;

FIG. 50 is a flowchart showing the operation example of the transaction equipment;

FIG. 51 is a schematic diagram showing an example of the function use restriction table;

FIG. 52 is a flowchart showing the operation example of the transaction equipment;

FIG. 53 is a schematic diagram showing an example of the function use restriction table;

FIG. 54 is a flowchart showing the operation example of the transaction equipment;

FIG. 55A is a schematic diagram showing an example of an attribute table;

FIG. 55B is a schematic diagram showing an example of an individual equipment table;

FIG. 56 is a flowchart showing an operation example of the transaction equipment when the transaction equipment and the cradle set cooperate;

FIG. 57 is a schematic diagram showing a connection example of the transaction equipment to a maintenance PC;

FIG. 58A is a schematic diagram for describing a state change of the individual equipment table;

FIG. 58B is a schematic diagram for describing the state change of the individual equipment table;

FIG. 59 is a sequence diagram showing a second operation example of a transaction processing system when a predetermined trigger is generated;

FIG. 60 is a schematic diagram showing a connection example of the transaction equipment to a maintenance server;

FIG. 61 is a flowchart showing the operation example of the transaction equipment when the transaction equipment and the cradle set cooperate;

FIG. 62A is a schematic diagram showing an example of the attribute table;

FIG. 62B is a schematic diagram showing an example of the individual equipment table;

FIG. 63 is a schematic diagram showing another example of the individual equipment table;

FIG. 64 is a schematic diagram showing an example of the attribute table in a case where information regarding user registration is used as attribute information of the transaction equipment;

FIG. 65 is a schematic diagram showing an example of the attribute table in a case where information regarding log-on is used as attribute information of the transaction equipment; and

FIG. 66 is a schematic diagram showing an example of the communication connection authority table.

### DETAILED DESCRIPTION OF THE PREFERRED EMBODIMENTS

Hereinafter, an exemplary embodiment (hereinafter, referred to as “present exemplary embodiment”) in which transaction equipment, a transaction processing method, and a transaction processing program according to the present disclosure are specifically disclosed will be described in detail by appropriately referring to the drawings. Unnecessary descriptions may be omitted in some cases. For example, the detailed descriptions of the already well-known matters or the redundant descriptions of substantially the same configurations may be omitted in some cases. Such omissions are performed in order to allow a person skilled in the art to easily understand the present disclosure by preventing the following description from becoming unnecessarily redundant. The accompanying drawings and the following descriptions are provided to help a person skilled in the art fully understand the present disclosure, and thereby are not intended to limit the subject matter described in the claims.

### System Configuration of Transaction Processing System

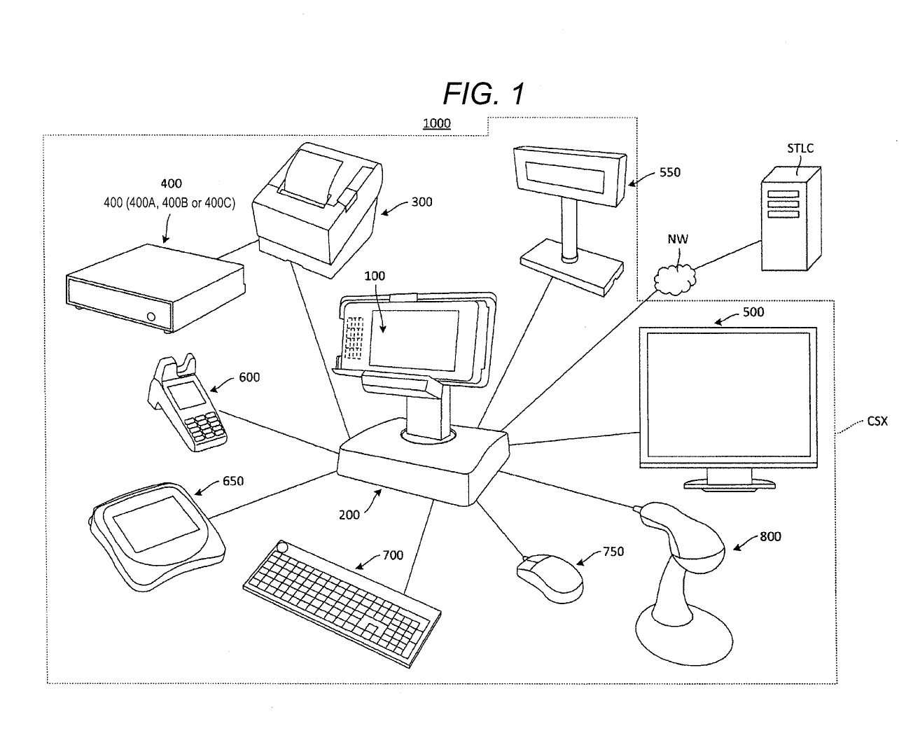

Initially, the system configuration of transaction processing system 1000 of the present exemplary embodiment will be described with reference to FIG. 1. FIG. 1 is a diagram showing an example of the system configuration of transaction processing system 1000 of the present exemplary embodiment. For example, transaction processing system 1000 shown in FIG. 1 is provided in a store such as a convenience store or a supermarket, and includes transaction equipment 100, docking device 200, receipt printer 300, cash drawer 400, external display 500, customer display 550, PINPAD 600, sign pad 650, keyboard 700, mouse 750, and barcode reader 800. Hereinafter, at least one of receipt printer 300, cash drawer 400, external display 500, customer display 550, PINPAD 600, sign pad 650, keyboard 700, mouse 750, and barcode reader 800 is referred to as “peripheral equipment” in some cases.

In transaction processing system 1000, docking device 200 on which transaction equipment 100 is mounted is connected to a settlement server (for example, a settlement relay center device operated by third party processor or a settlement center device operated by an issuer or an acquirer, to be described below) in a settlement application which is installed to be executable in transaction equipment 100 via network NW.

Network NW is, for example, an intranet or the Internet. For example, the intranet is a wireless or wired local area network within the store in which transaction equipment 100 is provided. The internet is a network connected using the wireless network or the wired network as an interface. For example, the wireless network is a wireless LAN (Local Area Network), a wireless WAN (Wide Area Network), 3G, HSPA (High Speed Packet Access), LTE (Long Term Evolution), or WiGig (Wireless Gigabit). For example, the wired network is IEEE802.3/Ethernet (registered trademark). For example, network NW may be a wide area network established using 3G, HSPA or LTE, or may be a network established using an existing telephone line. Network NW may be established using another connection network such as an internet connection network through an access point which is a spot of Wifi (registered trademark). The Internet may be established using another connection network such as a dedicated line or an intranet.

The settlement relay center device is a server device for a settlement relay process in a third party processor (that is, a company which is requested a business from an issuer (a card issuing company) or an acquirer (a company that invites member stores which perform specific card transaction, and manages sales information based on the card transaction of the member store), and relays a settlement process from each member store). The settlement relay center device receives a request for sales registration or an authorization inquiry for the settlement process of a commercial transaction from transaction equipment 100 via network NW, inquires about the determination of whether or not to grant authorization by the settlement center device, and requests the processing of the sales registration by the settlement center device.

For example, settlement center device STLC2 is a server device for a settlement process which is operated by the issuer or the acquirer that directly fulfills member-store contracts with the member stores. The settlement center device sends the authorization result, the determination result of the authorization inquiry or the processing result of the sales registration to transaction equipment 100 through the settlement relay center device in response to the inquiry about the determination from the settlement relay center device. Settlement center device STLC2 may receive a request for the sales registration or the authorization inquiry of the settlement process of the commercial transaction from transaction equipment 100 via network NW, may perform the determination of whether or not to authorize, and may directly send the processing result of the sales registration or the determination result of the authorization inquiry to transaction equipment 100.

For example, transaction equipment 100 is a settlement terminal device, such as a tablet terminal which is easily held with one hand or both hands of a salesperson, which includes a portable housing and in which at least one of a settlement application and a general-purpose business application (for example, a merchandise registration application or a stock management application) required for the business in the store where transaction equipment 100 is provided is installed so as to be executable. Hereinafter, the transaction equipment may be referred to as MPOS (Mobile Point Of Sales) in some cases. Transaction equipment 100 receives information (settlement information) regarding various items related to the settlement process of a transaction using a card through touch panels TP2 and TP1 by a user (for example, a salesperson or a customer), and reads a card number and an expiration date of the card.

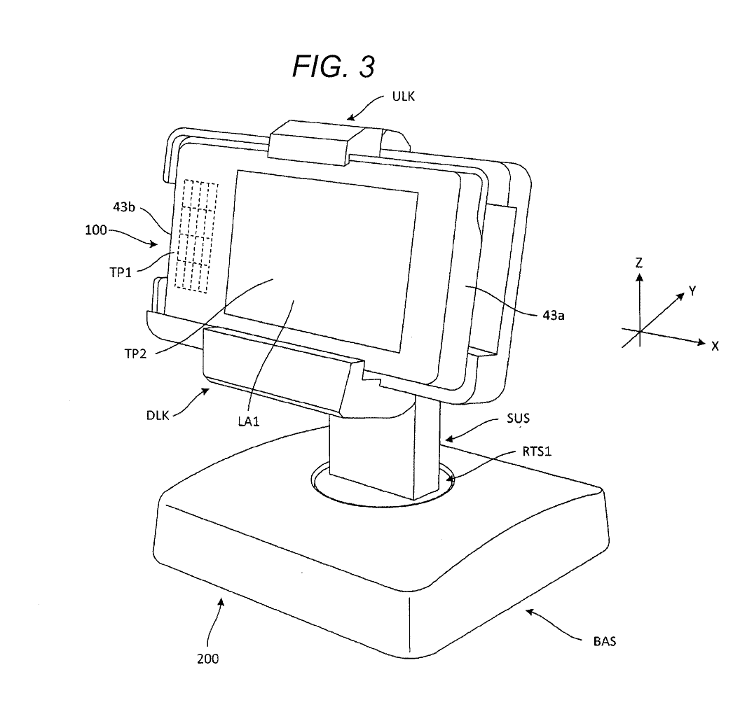

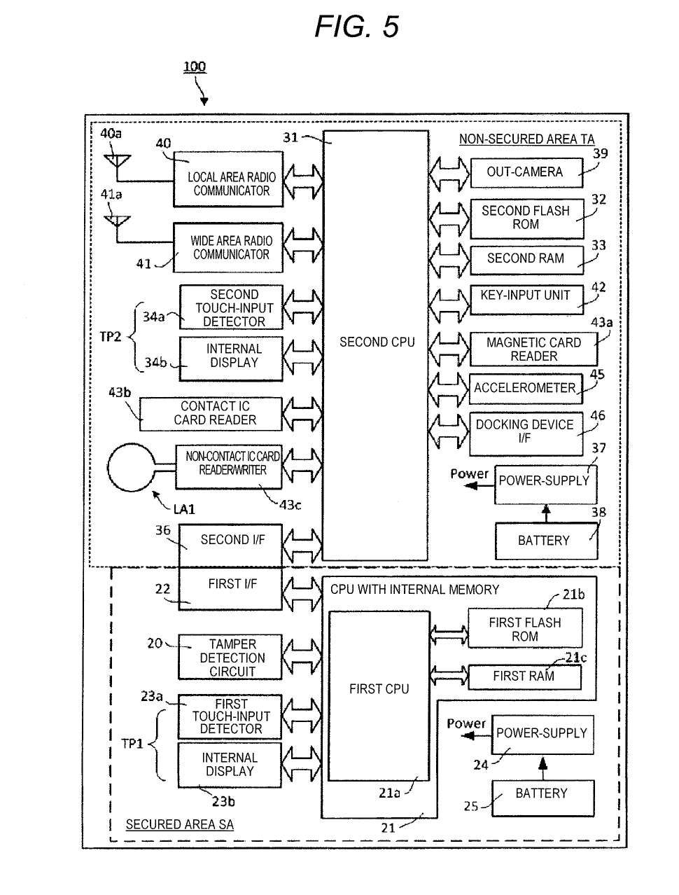

In a case where the transaction equipment is attached to docking device 200 (see FIG. 3), transaction equipment (MPOS) 100 performs communication related to the settlement process of the commercial transaction using the card (for example, an IC credit card. The same applies later) with settlement server STLC (for example, the settlement relay center device or the settlement center device) via docking device 200 and network NW. Even in a case where the transaction equipment is detached from docking device 200, transaction equipment 100 may perform the communication related to the settlement process of the commercial transaction using the card with settlement server STLC via the network. The specific configuration of transaction equipment 100 will be described with reference to FIG. 5.

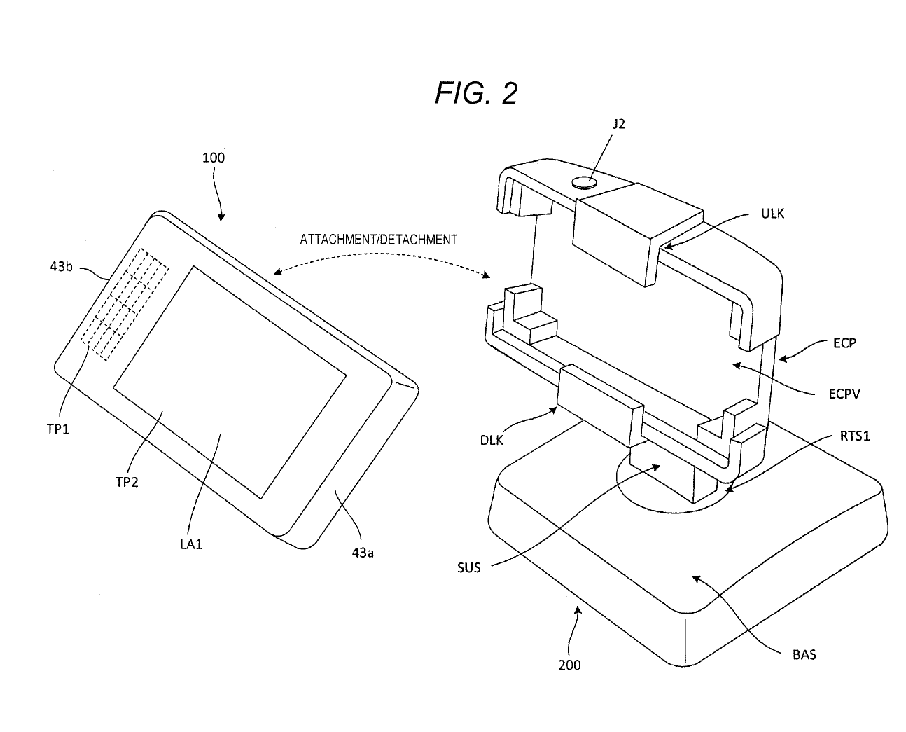

Docking device 200 is connected to at least one peripheral equipment (see FIG. 1) used in at least one of the settlement application and the general-purpose business application installed in transaction equipment 100, and allows transaction equipment 100 to be attached and detached (see FIGS. 2 and 3).

Receipt printer 300 as an example of the peripheral equipment is connected to docking device 200 and cash drawer 400, and prints predetermined receipts by using print data regarding the predetermined receipts (for example, a customer receipt and a store receipt) output from docking device 200 in a case where the settlement related to the commercial transaction is normally ended. For example, in a case where the receipts are printed, receipt printer 300 switches a switch built in cash drawer 400 from an OFF state (a locked state) to an ON state (an unlocked state), and pushes cash drawer 400 in an opening direction, in response to a control signal from transaction equipment 100. In a case where transaction equipment 100 is attached to and is connected to docking device 200, the control signal is a signal which is transmitted from transaction equipment 100 and is received by docking device 200, and is transmitted to receipt printer 300 through docking device 200.

Cash drawer 400 as an example of the peripheral equipment is connected to only receipt printer 300, and strictly stores cash possessed in the store where transaction processing system 1000 is provided.

External display 500 as an example of the peripheral equipment is a display device which is connected to docking device 200 and has a display area greater than internal display 34b of transaction equipment 100. External display 500 may be a touch panel capable of detecting a touch input of the salesperson or the customer.

Customer display 550 as an example of the peripheral equipment is a display device which is connected to docking device 200 and has a display area having a predetermined size, and displays, for example, a sales amount of money (settlement amount of money) related to the commercial transaction of the customer in a direction in which the information can be easily seen by the customer. Customer display 550 may be a touch panel capable of detecting a touch input of the salesperson or the customer.

PINPAD 600 as an example of the peripheral equipment is an input device which is connected to docking device 200 and allows the customer to input a PIN (Personal Identification Number) as authentication information for authenticating the customer as a legitimate owner of the card during the execution of the settlement application using the card.

Sign pad 650 as an example of the peripheral equipment is an input device which is connected to docking device 200 and allows the customer to input electronic data regarding a handwritten signature as authentication information for authenticating the customer as a legitimate owner of the card during the execution of the settlement application using the card.

Keyboard 700 as an example of the peripheral equipment is connected to docking device 200, and is used by the salesperson in order to input characters or numerals on an operation screen of an application executable in transaction equipment 100.

Mouse 750 as an example of the peripheral equipment is connected to docking device 200, and is used by the salesperson in order to select a specific item on an operation screen of an application executable in transaction equipment 100.

Barcode reader 800 as an example of the peripheral equipment is connected to docking device 200, and is used by the salesperson in order to read a barcode assigned to a merchandise or a coupon as a target of the commercial transaction.

Attachment and Detachment of Transaction Equipment to and from Docking Device

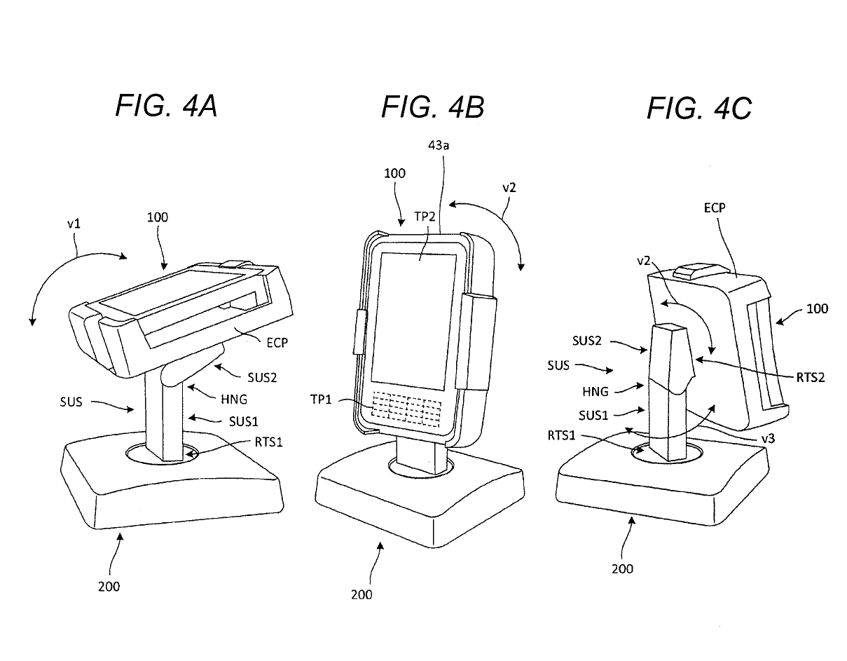

Hereinafter, the attachment and detachment of transaction equipment 100 to and from docking device 200 will be described with reference to FIGS. 2, 3, and 4A to 4C. FIG. 2 is a diagram for describing an example of a state in which transaction equipment 100 is attached to and is detached from docking device 200. FIG. 3 is a diagram showing an example of a state in which transaction equipment 100 is attached to docking device 200. FIG. 4A is a diagram showing an example of docking device 200 in which upper supporting part SUS2 is rotated around lower supporting part SUS1 in a tilt direction (arrow v1 direction) through hinge HNG. FIG. 4B is a diagram showing an example of docking device 200 in which holder rotation part RTS2 rotates equipment holder ECP in an arrow v2 direction about 90 degrees from the position in the state of FIG. 4A. FIG. 4C is a diagram showing an example of docking device 200 in which rotatable pedestal RTS1 is rotated in a panning direction (arrow v3 direction) from the position in the state of FIG. 3.

For example, docking device 200 is disposed in a predetermined position of a checkout counter of the store, and includes equipment holder ECP supported by supporting part SUS which is erected upward from columnar rotatable pedestal RTS1, which is provided in a near central position of square-columnar fixing pedestal BAS, in a vertical direction. Rotatable pedestal RTS1 is rotated around fixing pedestal BAS about 180 degrees (see FIG. 4C). Equipment holder ECP includes upper locking part ULK, and lower locking part DLK, and holds and locks transaction equipment 100 in equipment holding space ECPV formed between upper locking part ULK and lower locking part DLK so as to expose transaction equipment 100. Locking part J2 is formed in upper locking part ULK, and if transaction equipment 100 is attached in equipment holding space ECPV of docking device 200 and then is locked by a tool such as a driver, upper locking part ULK and lower locking part DLK lock transaction equipment 100 so as to sandwich transaction equipment in both directions of an upward direction and a downward direction. Thus, transaction equipment 100 is physically attached to docking device 200.

In the case where the transaction equipment is attached to docking device 200 (see FIG. 3) and in the case where the transaction equipment is detached from the docking device (see FIG. 2), for example, transaction equipment 100 can receive an input operation of the salesperson on touch panel TP2 provided in non-secured area TA (see FIG. 5), and can receive an input operation of the customer on touch panel TP1 provided in secured area SA (see FIG. 5).

In transaction equipment 100, magnetic card reader 43a is provided on a side surface of the housing of transaction equipment 100 close to non-secured area TA, in a transverse direction, and contact IC card reader 43b is provided on a side surface of the housing of transaction equipment 100 close to secured area SA in a transverse direction. Loop antenna LA1 connected to non-contact IC card reader/writer 43c, to be described below, is provided in a portion of the housing of transaction equipment 100 close to non-secured area TA (that is, a portion which is substantially parallel to touch panel TP2). In the case where the transaction equipment is attached to docking device 200 (see FIG. 3) and in the case where the transaction equipment is detached from the docking device (see FIG. 2), transaction equipment 100 can read a magnetic card in magnetic card reader 43a, can read a contact IC card in contact IC card reader 43b, and can read a non-contact IC card approaching near loop antenna LA1 in non-contact IC card reader/writer 43c through the operation of the salesperson.

As shown in FIGS. 4A to 4C, docking device 200 to which transaction equipment 100 is attached can be rotated in various directions. For example, as shown in FIG. 4A, in docking device 200, upper supporting part SUS2 can be rotated around lower supporting part SUS1 through hinge HNG in the tilt direction (arrow v1 direction). Supporting part SUS shown in FIG. 2 or 3 is configured such that lower supporting part SUS1 which is erected from rotatable pedestal RTS1, hinge HNG which rotates upper supporting part SUS2 around lower supporting SUS1 in the tilt direction, and upper supporting part SUS2 which supports equipment holder ECP are sequentially connected (see FIG. 4A). Thus, the salesperson or the customer can easily input the operations on touch panels TP2 and TP1 by rotating docking device 200 such that touch panels TP2 and TP1 of transaction equipment 100 face a ceiling surface of the store.

As shown in FIG. 4B, in docking device 200, holder rotation part RTS2 (see FIG. 4C) can rotate equipment holder ECP in the arrow v2 direction about 90 degrees from the position in the state of FIG. 4A. Thus, since the salesperson or the customer can rotate touch panels TP2 and TP1 of transaction equipment 100 such that the longitudinal direction of the housing of transaction equipment 100 is parallel to the vertical direction, the salesperson or the customer can easily see the operation screen of the application including characters or numerals displayed on touch panels TP2 and TP1, and can easily operate the operation screen.

As shown in FIG. 4C, in docking device 200, rotatable pedestal RTS1 can be rotated in the panning direction (arrow v3 direction) from the position in the state of FIG. 3 (that is, a state in which transaction equipment 100 is attached to docking device 200). Thus, since the salesperson can turn the operation screen of the application displayed on touch panel TP2 of transaction equipment 100 toward the salesperson or the customer, the salesperson and the customer facing the salesperson can simply perform the operation on touch panel TP2.

### Configuration of Transaction Equipment

Hereinafter, the hardware configuration of transaction equipment 100 of the present exemplary embodiment will be described with reference to FIG. 5. FIG. 5 is a diagram showing an example of the hardware configuration of transaction equipment 100 of the present exemplary embodiment. Transaction equipment 100 shown in FIG. 5 has non-secured area TA and secured area SA. “Secure” mentioned herein means that the area has tamper resistance. “Non-secure” means that the area has no tamper resistance. “Tamper resistance” refers to resistance to illegal analysis and modification of software or hardware within equipment, illegal piracy and modification, of information within the equipment, and attack to allow the information to be disabled. That is, the tamper resistance refers to the difficulty of analyzing stored data or the internal structure of the hardware or the software. The area has the tramper resistance, and thus, information of a service receiver (for example, the customer) can be protected and the transaction can be safely performed.

In secured area SA, tamper detection circuit 20 that detects whether or not a physical unauthorized behavior (for example, breakage and damage of transaction equipment 100) is performed, CPU 21 with internal memory, first I/F (interface) 22, first touch-input detector 23a, internal display 23b, power-supply 24, and battery 25 are provided. First touch-input detector 23a and internal display 23b constitute touch panel TP1. In CPU 21 with internal memory, first CPU 21a, first flash ROM (Read Only Memory) 21b, and first RAM (Random Access Memory) 21c are provided.

In secured area SA, various components are electrically and logically connected to first CPU 21a. First CPU 21a manages all the components in secured area SA. For example, first CPU 21a performs various controls, processes, settings, determinations, checks, authentications, inquires (for example, an inquiry about PIN or signature), and instructions by executing programs stored in first flash ROM 21b.

First flash ROM 21b stores an encryption key used in communication with settlement server STLC (see FIG. 1, for example, the settlement relay center device or the settlement center device), personal information such as a PIN, confidential information such as settlement information regarding the settlement, or programs for transaction equipment 100 to receive a PIN input and an inquiry of the settlement. First flash ROM 21b is an example of a storage medium that stores programs and data for information processing in first CPU 21a.

For example, when processes associated with the reception of the PIN input and the inquiry of the settlement of transaction equipment 100 (for example, secured area SA) are performed, first RAM 21c is a work memory used to temporarily store processing data generated during the process.

Tamper detection circuit 20 constantly monitors secured area SA, and detects the physical unauthorized behavior (for example, the analysis, breakage or unsealing of secured area SA of transaction equipment 100) of secured area SA. In other words, tamper detection circuit 20 detects whether or not abnormality occurs in secured area SA. In a case where an event of the physical unauthorized behavior is detected by tamper detection circuit 20, CPU 21 with internal memory or second CPU 31 may forcibly stop the settlement process in the settlement application, or may notify that the physical unauthorized behavior is detected in secured area SA through at least one of touch panels TP1 and TP2.

First I/F 22 is provided to electrically connect non-secured area TA to secured area SA, and delivers various data items or commands between non-secured area TA and secured area SA through second I/F 36. First I/F 22 and second I/F 36 can be coupled to each other.

First touch-input detector 23a detects the touch input of the salesperson or the customer on touch panel TP1. For example, first touch-input detector 23a may detect an input on a PIN pad as a physical keypad or a software keyboard for inputting the PIN. For example, first touch-input detector 23a may detect a signature input using a finger or a stylus pen. For example, first touch-input detector 23a may detect a handwritten input of the PIN by using a finger or a stylus pen.

For example, internal display 23b is an LCD (Liquid Crystal Display) or an organic EL (Electroluminescence), and displays, for example, predetermined data (for example, numeric keys) for inputting the authentication information (for example, the PIN or signature) of the customer in the settlement application. Data displayed on internal display 23b is not limited to the numeric keys.

Power-supply 24 is a power supply of secured area SA, receives power from battery 25, and supplies power to secured area SA (for example, first CPU 21a). First CPU 21a can supply the power and stop the supply of the power to a part or all of the circuits arranged in secured area SA by controlling power-supply 24.

In non-secured area TA, second CPU 31, second flash ROM 32, second RAM 33, second touch-input detector 34a, internal display 34b as an example of a display unit, second I/F 36, power-supply 37, battery 38, out-camera 39, local area radio communicator 40 to which local area radio antenna 40a is connected, wide area radio communicator 41 to which wide area radio antenna 41a is connected, key-input unit 42, magnetic card reader 43a, contact IC card reader 43b, non-contact IC card reader/writer 43c to which loop antenna LA1 is connected, accelerometer 45, and docking device I/F 46 are provided. Second touch-input detector 34a and internal display 34b constitute touch panel TP2.

In non-secured area TA, various components are electrically and logically connected to second CPU 31. Second CPU 31 manages all the components in non-secured area TA. For example, second CPU 31 performs various controls, processes, settings, determinations and instructions by executing programs stored in second flash ROM 32. Second CPU 31 as an example of an application controller starts and executes various applications stored in second flash ROM 32, and pauses or ends the execution in response to the operation of the salesperson.

Second flash ROR 32 stores various data items and programs. The stored data and program are a program and data used in the settlement application and the business application (for example, a merchandise registration application, a stock management application, a document creation application used on a daily basis, and a spread sheet application), and may be a program for controlling transaction equipment 100 (for example, non-secured area TA). Accordingly, second flash ROM 32 is an example of a storage medium that stores programs and data for information processing in second CPU 31.

For example, when processes associated with the operations of transaction equipment 100 (for example, the components in non-secured area TA) are performed, second RAM 33 is a work memory used to temporarily store processing data generated during the process.

Second touch-input detector 34a detects the touch input of the salesperson or the customer on touch panel TP2. For example, second touch-input detector 34a detects the input on the operation screen of at least one of the settlement application and the business application (for example, the merchandise registration application) displayed on touch panel TP2.

Internal display 34b is, for example, an LCD (Liquid Crystal Display) or an organic EL (Electroluminescence), and displays data regarding the operation screen for inputting various information items (for example, a card brand, a card number, an expiration date, an amount of money, a payment method, and the number of payments) related to the settlement process using the card in, for example, the settlement application, or displays data regarding the operation screen for inputting the quantities or items of merchandises as a sales target in the merchandise registration application. The size of the display area of internal display 34b is less than the size of the display area of external display 500. In other words, even though the operation screens of the same application are considered, the operation screen displayed on external display 500 is larger than the operation screen displayed on internal display 34b, and thus, the salesperson or the customer can easily see the screens. Second I/F 36 is provided to electrically connect non-secured area TA to secured area SA, and delivers various data items and commands between non-secured area TA and secured area SA through first I/F 22. First I/F 22 and second I/F 36 can be coupled to each other.

Power-supply 37 is a power supply of non-secured area TA, and receives power from battery 38, and supplies power to non-secured area TA (for example, second CPU 31). Second CPU 31 can supply the power and stop the supply of the power to a part or all of the circuits arranged in non-secured area TA by controlling power-supply 37.

Out-camera 39 is a camera provided such that a lens is exposed from the housing of transaction equipment 100, and obtains image data by capturing an image of light in a range in which the light is incident on the lens in response to the operation on key-input unit 42 or touch panel TP2, for example.

Local area radio communicator 40 is connected to local area radio antenna 40a, and performs communication using, for example, a wireless LAN by using local area radio communication path. Local area radio communicator 40 may perform communication (for example, communication using Bluetooth (registered trademark)) other than wireless LAN communication.

Wide area radio communicator 41 is connected to wide area radio antenna 41a, and performs communication using a wide area radio communication path (for example, a WAN (Wide Area Network)). The communication in the wide area radio communication path may be performed using, for example, a radio telephone network (a cellular network (W-CDMA (Wideband Code Division Multiple Access)), CDMA (Code Division Multiple Access) 2000, or LTE (Long Term Evolution)).

For example, in a case where various buttons are provided on the housing of transaction equipment 100, key-input unit 42 receives push operations of various buttons. In a case where various buttons are not provided on the housing of transaction equipment 100, key-input unit 42 may be omitted from the configuration of transaction equipment 100.

Magnetic card reader 43a is provided on a side surface of the housing of transaction equipment 100 close to non-secured area TA in the transverse direction (see FIG. 3), is provided with a slit which is formed in the side surface and through which a swipe operation is performed in a state in which the salesperson holds the magnetic card, and reads a magnetic stripe of the magnetic card in response to the swipe operation. Information regarding the magnetic stripe read by magnetic card reader 43a is input to second CPU 31.

Contact IC card reader 43b is disposed within an insertion hole of the contact IC card which is formed in the side surface of the housing of transaction equipment 100 close to secured area SA in the transverse direction (see FIG. 3), and reads card information recorded in a chip within the contact IC card through an electrode of the contact IC card (for example, an IC credit card) inserted into the insertion hole. The card information read by contact IC card reader 43b is input to second CPU 31. Contact IC card reader 43b may be provided within secured area SA.

Non-contact IC card reader 43c is connected to loop antenna LA1 disposed in a portion of the housing of transaction equipment 100 close to non-secured area TA (that is, a portion which is substantially parallel to touch panel TP2), performs radio communication with the card (for example, the IC credit card) in a non-contact manner using NFC (Near Field Communication), and reads or writes the card information recorded in the card. The card information read by non-contact IC card reader/writer 43c is input to second CPU 31. Non-contact IC card reader/writer 43c may regularly authenticate with respect to non-contact reader/writer 71 of docking device 200 whether or not the transaction equipment is electrically connected to docking device 200 through communication between loop antenna LA1 of transaction equipment 100 and loop antenna LA2 of docking device 200. Magnetic card reader 43a, contact IC card reader 43b, and non-contact IC card reader/writer 43c may be connected to first CPU 21a present in secured area SA. Non-contact IC card reader/writer 43c to which loop antenna LA1 is connected may be provided within secured area SA.

Accelerometer 45 detects accelerations in an X-axis direction, a Y-axis direction and a Z-axis direction (see three-axis direction shown in FIG. 3) of transaction equipment 100, and outputs the detection result to second CPU 31. Accelerometer 45 can detect a gravity direction (a vertically downward direction, that is, a −Z-axis direction) of transaction equipment 100.

Docking device I/F 46 as an example of an authentication controller performs a regular inquiry (for example, a challenge response process to be described below) about the determination of whether or not transaction equipment 100 and docking device 200 are electrically connected with respect to device authentication controller 63 (to be described below) of docking device 200 through a connector.

As described above, transaction equipment 100 includes secured area SA and non-secured area TA. A “secured” portion requiring “tamper resistance” in transaction equipment 100 during the execution of various applications is localized to secured area SA. Meanwhile, many information processing devices (for example, smartphones or tablet terminals) distributed as devices for consumers or some devices thereof are used in non-secured area TA, as a general-purpose platform.

By using the general-purpose platform in non-secured area TA, development resources of the settlement application and the business application are easily reduced or applied. The settlement application and the business application are flexibly operated without stress by being processed by second CPU 31 of non-secured area TA having, for example, high arithmetic processing ability. Since various settlement application or business applications in which settlement schemes are diversified can be easily used, these applications can be installed in transaction equipment 100 in a short period.

### Configuration of Docking Device

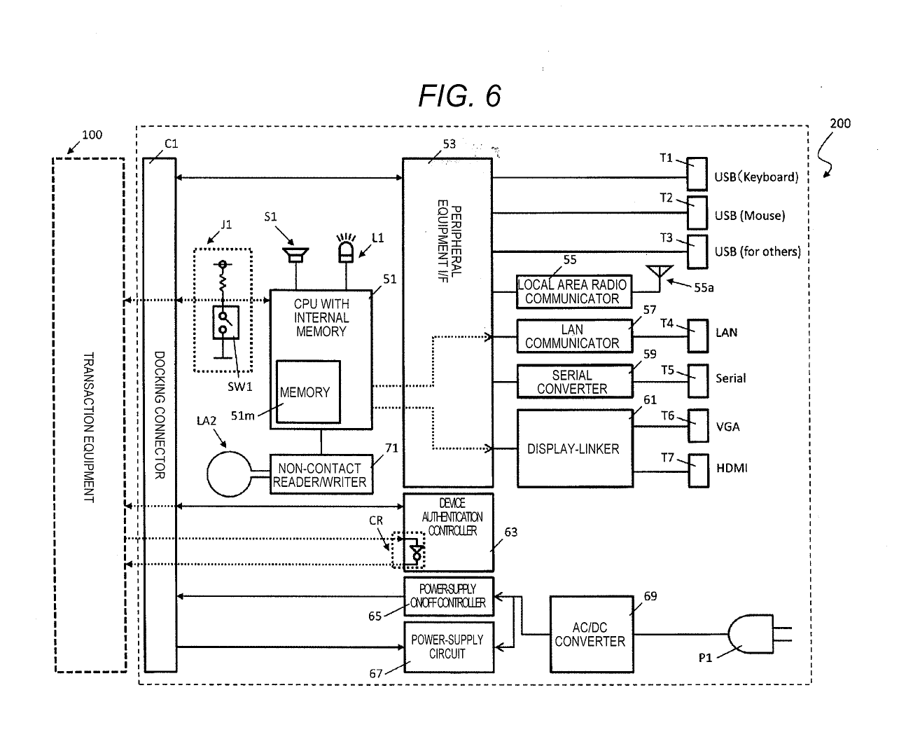

Hereinafter, the hardware configuration of docking device 200 of the present exemplary embodiment will be described with reference to FIG. 6. FIG. 6 is a diagram showing an example of the hardware configuration of docking device 200 of the present exemplary embodiment. In FIG. 6, transaction equipment 100 is also illustrated in order to conveniently describe the operation of docking device 200. Docking device 200 shown in FIG. 6 includes CPU 51 with internal memory, peripheral equipment I/F 53, local area radio communicator 55 to which local area radio antenna 55a is connected, LAN communicator 57, serial converter 59, display-linker 61, device authentication controller 63, power-supply on/off controller 65, power-supply circuit 67, AC/DC converter 69 to which power plug P1 is connected, non-contact reader/writer 71 to which loop antenna LA2 is connected, lock determination part J1, docking connector C1, speaker S1, and LED (Light Emitting Diode) lamp L1.

CPU 51 with internal memory includes memory 51m, and manages all the components in docking device 200. For example, CPU 51 with internal memory performs various controls, processes, settings, determinations, authentications, checks, inquiries and instructions by executing programs stored in memory 51m.

Memory 51m stores various programs and data required for the operation of docking device 200, and functions as a work memory which temporarily stores processing data generated during the operation of CPU 51 with internal memory.

Peripheral equipment I/F 53 delivers data with respect to various peripheral equipments (see FIG. 1) connected to various terminals (terminals T1, T2, T3, T4, T5, T6 and T7) in a direct manner or in an indirect manner through LAN communicator 57, serial converter 59 and display-linker 61. Terminals T1, T2 and T3 are directly connected to peripheral equipment I/F 53. Keyboard 700 is connected to terminal T1. Mouse 750 is connected to terminal T2. Other peripheral equipments (for example, PINPAD 600, sign pad 650, and barcode reader 800) are connected to terminal T3.

Local area radio communicator 55 is connected to local area antenna 55a, and performs communication using, for example, a wireless LAN by using a local area radio communication path. Local area radio communicator 55 may perform communication (for example, communication using Bluetooth (registered trademark)) other than wireless LAN communication.

LAN communicator 57 is connected to terminal T4, is connected to a local network (for example, an intranet of the store) through terminal T4, and performs transmission and reception of data with the network. For example, the intranet of the store is connected to terminal T4.

Serial converter 59 is connected to terminal T5, performs serial-to-parallel conversion of data, and performs the transmission of print data of the predetermined receipts (for example, the customer receipt and the store receipt) transmitted from transaction equipment 100 or the reception of a print completion notification of the print data transmitted from receipt printer 300 with respect to receipt printer 300 connected to terminal T5. Serial converter 59 transmits a control signal for pushing cash drawer 400 in the opening direction to cash drawer 400 through receipt printer 300. Receipt printer 300 is connected to terminal T5.

Display-liner 61 is connected to terminals T6 and T7, and delivers data regarding at least one operation screen of the settlement application and the business application transmitted from transaction equipment 100 to external display 500 or customer display 550 connected to terminals T6 and T7. External display 500 or customer display 550 capable of handling data corresponding to VGA (Video Graphical Array) is connected to terminal T6. External display 500 or customer display 550 capable of handling data corresponding to HDMI (High-Definition Multimedia Interface) (registered trademark) is connected to terminal T7.

Device authentication controller 63 includes, for example, challenge response controller CR, and regularly performs a challenge response process as a method for checking or authenticating whether or not transaction equipment 100 and docking device 200 are correctly connected. In the challenge response process, challenge data is sequentially delivered to challenge response controller CR, docking connector C1, the connector of transaction equipment 100, docking device I/F 46, and second CPU 31, and response data is sequentially delivered to second CPU 31, docking device I/F 46, the connector of transaction equipment 100, docking connector C1, and challenge response controller CR. In a case where correct response data is obtained as the processing result of challenge response controller CR, device authentication controller 63 determines that correct transaction equipment 100 is attached to and is connected to docking device 200. The method for checking or authenticating whether or not transaction equipment 100 and docking device 200 are correctly connected is not limited to the above-described challenge response. For example, a method in which transaction equipment 100 detects the power supply from docking device 200, and transmits the detection signal to docking device 200 may be used.

Power-supply on/off controller 65 receives a part of a DC power obtained by converting (for example, rectification and smoothing) a commercial power supply (power) supplied to power plug P1 in AC/DC converter 69 and determines whether or not to supply the DC power to transaction equipment 100 through docking connector C1. The commercial power supply is constantly supplied to docking device 200 through power plug P1. However, since only batteries 25 and 38 are provided in transaction equipment 100, in a case where it is determined that the remaining capacity of batteries 25 and 38 of transaction equipment 100 is less than a predetermined value, power-supply on/off controller 65 can supply the power to transaction equipment 100. In other words, if the transaction equipment is attached to and is connected to docking device 200, transaction equipment 100 can charge batteries 25 and 38.

Power-supply circuit 67 supplies power supplies (powers) that are suitable for various components for operating the various components of docking device 200 by using a part of the DC power obtained by performing conversion (for example, rectification and smoothing) in AC/DC converter 69.

Non-contact reader/writer 71 is connected to loop antenna LA2, and regularly authenticates whether or not the docking device is electrically connected to transaction equipment 100 with respect to non-contact IC card reader/writer 43c of transaction equipment 100 through communication between loop antenna LA2 and loop antenna LA1 of transaction equipment 100.

Locking determination part J1 includes switch SW1, and determines whether or not transaction equipment 100 is physically attached to and is fixed to docking device 200. Specifically, in a case where the housing of transaction equipment 100 is held in and is attached to equipment holder ECP of docking device 200 and locking part J2 is fixed through a tool such as a driver, switch SW1 is turned on, and thus, locking determination part J1 determines that transaction equipment 100 is physically attached to and is fixed to docking device 200. Meanwhile, in a case where the housing of transaction equipment 100 is not held in equipment holding space ECPV of docking device 200, or in a case where the housing of the transaction equipment is held in and is attached to equipment holding space and locking part J2 is not fixed through the tool such as the driver, switch SW1 is turned off, and thus, locking determination part J1 determines that transaction equipment 100 is not physically fixed to docking device 200. Although it has been described that the ON and OFF of switch SW1 and the attachment and detachment of transaction equipment 100 to and from docking device 200 correspond to each other, and vice versa. In other words, in a case where switch SW1 is turned off, transaction equipment 100 may be physically fixed to docking device 200, and in a case where switch SW1 is turned on, transaction equipment 100 may not be physically fixed to docking device 200.

In a case where the housing of transaction equipment 100 is held in and is attached to equipment holder ECP of docking device 200, docking connector C1 electrically connects transaction equipment 100 and docking device 200.

In a case where a predetermined condition is satisfied, speaker S1 outputs an alert sound having a predetermined volume in response to an instruction of CPU 51 with internal memory.

LED lamp L1 can emit light of an LED, and emits light of predetermined color (for example, blue) in response to an instruction of CPU 51 with internal memory in a case where a predetermined condition is satisfied. Example of Operation Screen of Settlement Application

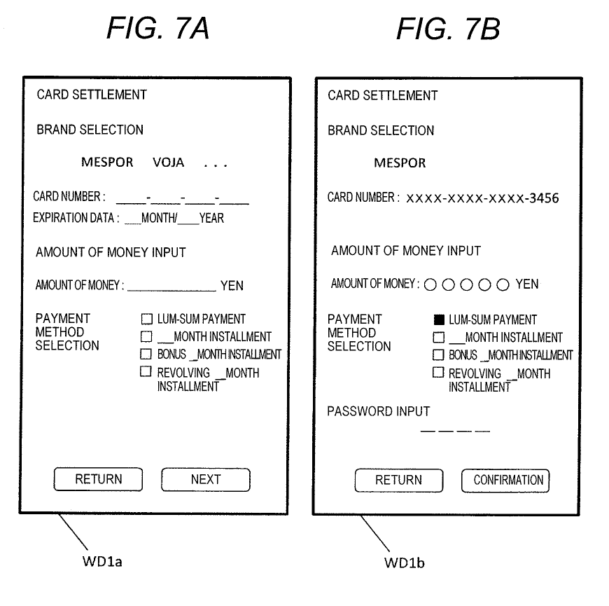

Hereinafter, the operation screen of the settlement application (for example, a card settlement application) installed in transaction equipment 100 will be described with reference to FIGS. 7A and 7B. FIG. 7A is a diagram showing a first example in which operation screen WD1a of the card settlement application executable in transaction equipment 100 is displayed on touch panel TP2 of transaction equipment 100. FIG. 7B is a diagram showing a second example in which operation screen WD1b of the card settlement application executable in transaction equipment 100 is displayed on touch panel TP2 of transaction equipment 100.

On operation screen WD1a shown in FIG. 7A, a card brand of a card used in the settlement of the commercial transaction is displayed such that the salesperson can select the card brand from “MESPOR”, “VOJA”, . . . , and a card number, an expiration date of the card, a settlement amount of money of the commercial transaction, a payment method as a settlement method of the card, and the number of payments are displayed. If the number of payments is input, an item “next” is input through the touch, and an input screen of settlement information (for example, a PIN as authentication information) which is subsequently input is displayed.

On operation screen WD1b shown in FIG. 7B, an input area for inputting the authentication information (for example, the PIN) for authenticating the customer as a legitimate owner of the card in addition to screen operation WD1a shown in FIG. 7A. On the operation screen shown in FIG. 7B, a card brand “MESPOR” is already selected, a card number “xxxx-xxxx-xxxx-3456” and an expiration data thereof (is not displayed after the card number and the expiration data are input) are input, and the payment amount of money and “lum-sum payment” as the payment method are input.

For example, in a case where the PIN is input as the authentication information for authenticating the customer as the legitimate owner of the card, transaction equipment 100 transmits the authorization inquiry of the settlement process including the card brand, the card number, the expiration data, the amount of money, the payment method, the number of payments, and the PIN to settlement server STLC through in a direct manner or in an indirect manner through docking device 200, in response to the input operation of the salesperson. In settlement server STLC, the determination (that is, the determination of whether or not to authorize the customer as a target of the settlement process) of the authorization inquiry is performed, and the determination result (for example, notification that the authorization is possible) of the authorization inquiry is transmitted to transaction equipment 100 from settlement server STLC in the direct manner or in the indirect manner through docking device 200. If the determination result (for example, notification that the authorization is possible) of the authorization inquiry is received, transaction equipment 100 transmits a process request for sales registration of the amount of money in the settlement process of the commercial transaction to settlement server STLC in the direct manner or the indirect manner through docking device 200. In settlement server STLC, a sales registration process is performed in response to the process request for the sales registration from transaction equipment 100, and the processing result of the sales registration is sent to transaction equipment 100. Thus, transaction equipment 100 can determine that the settlement process related to one commercial transaction is normally ended in the settlement application. Example of Operation Screen of Merchandise Registration Application

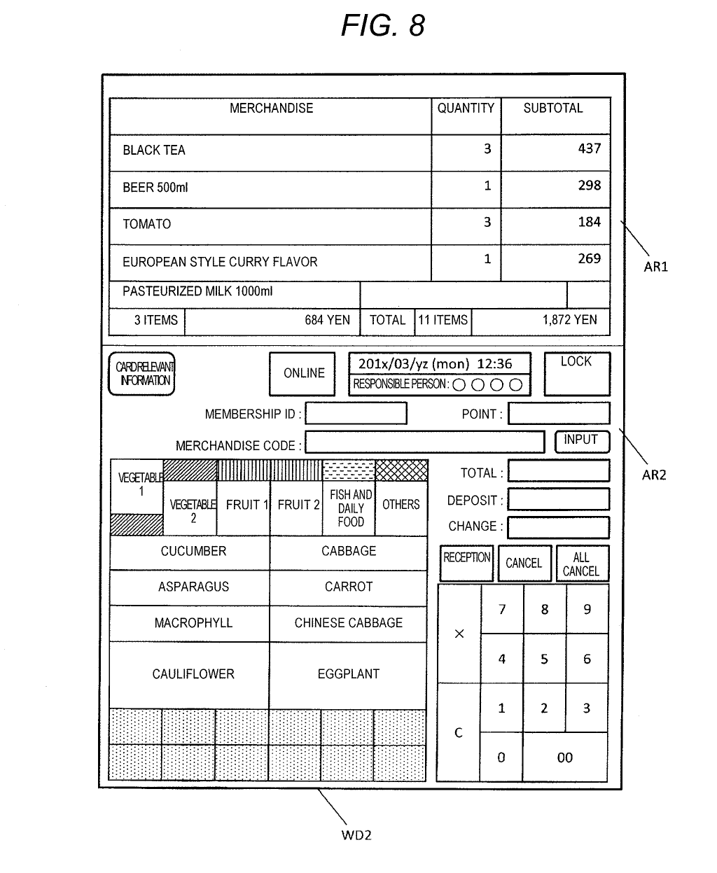

Hereinafter, operation screen WD2 of the merchandise registration application (that is, an application for registering the quantities or items of the services or merchandises as sales targets in a database inside or outside the store) installed in transaction equipment 100 will be described with reference to FIG. 8. FIG. 8 is a diagram showing an example in which operation screen WD2 of the merchandise registration application executable in transaction equipment 100 is displayed on touch panel TP2 of transaction equipment 100.

Operation screen WD2 shown in FIG. 8 includes an item and quantity display area AR2 for inputting the items and quantities of the merchandises or services as sales targets, and a registering target list display area AR1 for displaying the item, quantity and subtotal (that is, the product of the unit price and quantity of merchandises or services) of the merchandises or services input in item and quantity display area AR2 and the total amount of money (that is, the payment amount of money of the customer) related to the settlement (for example, a cash settlement or a card settlement) of the commercial transaction.

Transaction equipment 100 displays operation screen WD2 on internal display 34b shown in FIG. 8 after the merchandise registration application is started. For example, in a case where the customer purchases “three black tea products”, “one can of 500-ml beer”, “three tomatoes”, “one European style curry flavor” and “three cartons of 1000-m pasteurized milk”, the salesperson sequentially inputs combinations of the items and quantities of the merchandises as sales targets on item and quantity display area AR2 of operation screen WD2 displayed on internal display 34b through the touch. For example, the salesperson may input the items and quantities of all the merchandises by reading barcodes assigned to the merchandises by means of barcode reader 800 even though the salesperson does not perform the touch input. If the input of the items and quantities of all the merchandises is ended, transaction equipment 100 displays the merchandises as sales targets, the quantities of the merchandises, and the payment amount of money on registering target list display area AR1 of operation screen WD2 displayed on internal display 34b. Thus, during the execution of the merchandise registration application, transaction equipment 100 can register the services or merchandises as sales targets, and the quantities and the total amount of money thereof in correlation with a sales date and identification information (for example, the name of the salesperson) regarding the salesperson in response to the operation on operation screen WD2 shown in FIG. 8.

### First Exemplary Embodiment

In the first exemplary embodiment, the same configuration and operation as the configuration and operation described in the above-described exemplary embodiment will be assigned same reference numerals, and thus, the description thereof will be omitted or simplified.

Description of Operation Corresponding to Attachment or Detachment of Transaction Equipment to or from Docking Device

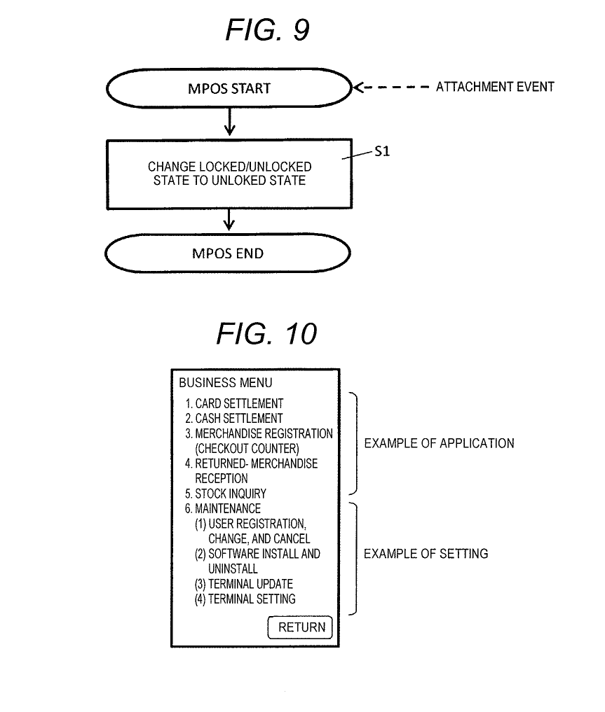

Hereinafter, the operation corresponding to the attachment or detachment of transaction equipment 100 to or from docking device 200 of the above-described exemplary embodiment shown in FIGS. 1 to 8 will be described with reference to FIG. 9 and the subsequent drawings.

In the following description, it is assumed that the case where transaction equipment 100 is attached to docking device 200 is, for example, a case where transaction equipment 100 is held in and is attached to equipment holding space ECPV of docking device 200, locking part J2 is fixed through the tool such as the driver and is physically fixed, and device authentication controller 63 checks or authenticates that correct transaction equipment 100 is attached to and is electrically connected to docking device 200 as the result of the challenge response process between transaction equipment 100 and docking device 200. In transaction equipment 100, second CPU 31 functions as an application controller which controls the execution of a predetermined application and checks or authenticates whether or not the communication with docking device 200 connected to at least one peripheral equipment used in the application and is connected. In a state in which the connection check or authentication succeeds, second CPU 31 determines that transaction equipment 100 is attached to docking device 200.

In the following description, it is assumed that the case where transaction equipment 100 is detached from docking device 200 is, for example, a case that satisfies at least one of a case where transaction equipment 100 is detached from equipment holding space ECPV of docking device 200, a case where the physical fixation of transaction equipment 100 to docking device 200 is released as the result in which the locked state of locking part J2 is unlocked, and a case where an abnormality result is obtained in the challenge response process between transaction equipment 100 and docking device 200 and the connection check or authentication fails. In transaction equipment 100, second CPU 31 determines that transaction equipment 100 is detached from docking device 200 in a state in which the connection check or authentication fails.

Initially, a first example of another operation of the attachment of transaction equipment 100 to docking device 200 or the detachment of the transaction equipment from docking device 200 will be described with reference to FIGS. 9 to 12. In FIG. 9, the operation of transaction equipment 100 (MPOS) in the case where transaction equipment 100 is normally attached to docking device 200 is shown. In this case, second CPU 31 of transaction equipment 100 sets transaction equipment 100 to be in the unlocked state of the locked state (non-operable state) or the unlocked state (operable state) (S1). The user can operate transaction equipment 100, and can basically use the entire function of transaction equipment 100.

FIG. 10 shows an unlocked state screen displayed on internal display 34b of transaction equipment 100 in the unlocked state. In the present example, six applications including 1. card settlement, 2. cash settlement, 3. merchandise registration (checkout counter), 4. returned-merchandise reception, 5. stock inquiry, and 6. maintenance are displayed. In the maintenance application, four setting examples including (1) user registration, change and deletion, (2) software install and uninstall, (3) terminal update, and (4) terminal setting are displayed. These applications and settings are collectively recognized as “functions” of transaction equipment 100.

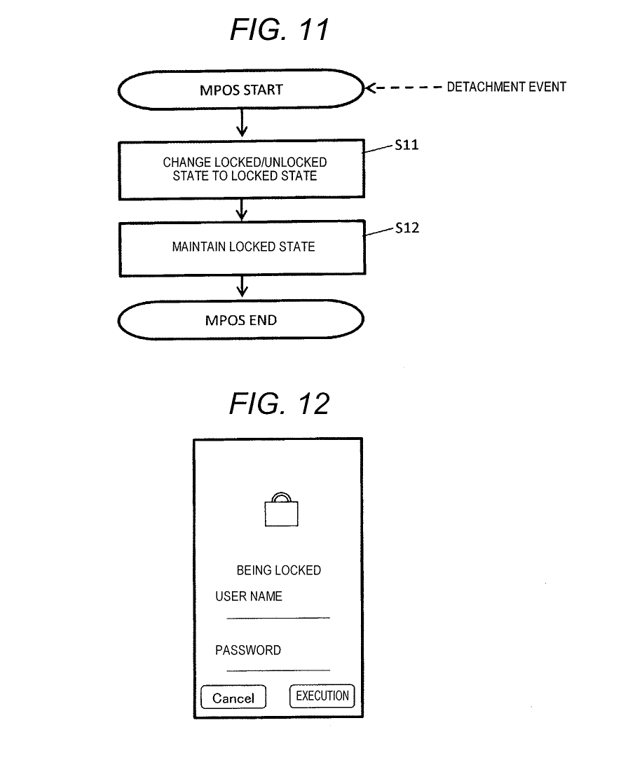

FIG. 11 is a flowchart for describing a first example of the operation of the transaction equipment in the case where the transaction equipment is normally detached from the docking device. In FIG. 11, the operation of transaction equipment 100 in the case where transaction equipment 100 is normally detached from docking device 200 after the process of FIG. 9 is shown. Here, an example in which transaction equipment 100 is set in an operation restriction state in which the operation is restricted, and an example in which transaction equipment 100 is set in the locked state is shown. Initially, in transaction equipment 100, second CPU 31 determines that transaction equipment 100 is detached from docking device 200. Second CPU 31 sets transaction equipment 100 to be in the locked state of the locked state or the unlocked state (S11). Second CPU 31 stores the setting indicating the locked state in second flash ROM 32 (S12). The user cannot operate transaction equipment 100, and is not able to basically use the entire function of transaction equipment 100.

FIG. 12 shows an example of a locked state screen displayed on the transaction equipment in the locked state. FIG. 12 shows the locked state screen displayed on internal display 34b of transaction equipment 100 in the locked state. In the present example, a display (an icon or a message) indicating the transaction equipment is being locked is displayed, and an area which prompts the user to input a user name and a password for releasing the locked state is displayed. The user inputs a predetermined password, and thus, second CPU 31 changes transaction equipment 100 to the unlocked state in which the transaction equipment can be operated.

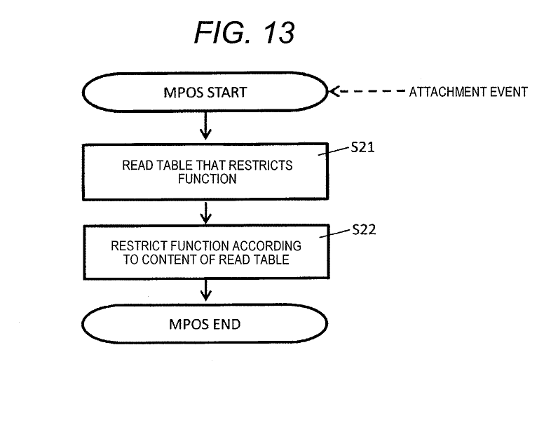

Hereinafter, a second example of the operation of the attachment of transaction equipment 100 to docking device 200 or the detachment of the transaction equipment from docking device 200 will be described with reference to FIGS. 13 to 16. FIG. 13 is a flowchart for describing a second example of the operation of the transaction equipment in the case where the transaction equipment is attached to the docking device. In FIG. 13, the operation of transaction equipment 100 in the case where transaction equipment 100 is attached to docking device 200 is shown. In this case, second CPU 31 of transaction equipment 100 reads a table (attachment function table) which stores a process of restricting (permitting or prohibiting) a predetermined function from second flash ROM 32 at the time of the attachment of transaction equipment 100 (S21). Second CPU 31 restricts the function of transaction equipment 100 according to the read table (S22). Here, transaction equipment 100 may read the table into transaction equipment 100 from an external server via network NW.

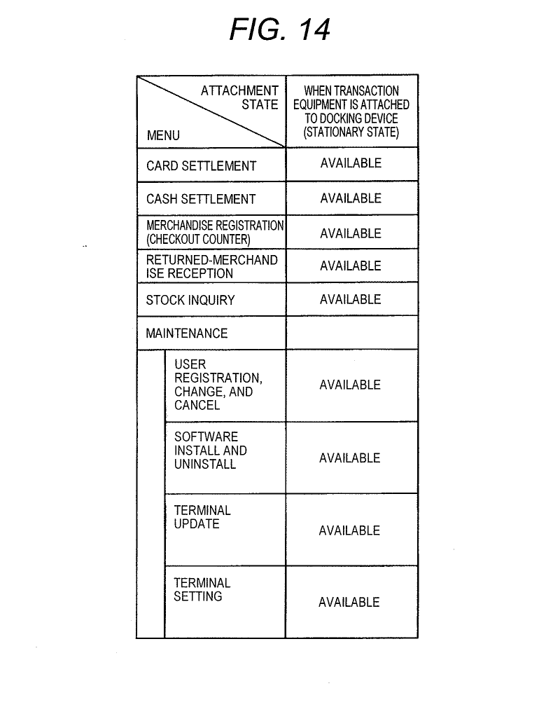

FIG. 14 shows an example of the attachment function table used in the case where the transaction equipment is attached to the docking device. FIG. 14 shows an example of the above-described table (attachment function table). At the time of the attachment of transaction equipment 100 to docking device 200, any application and setting of the card settlement, the cash settlement, the merchandise registration (checkout counter), the returned-merchandise reception, the stock inquiry, and the maintenance are executable. Accordingly, in the operation of FIG. 13, no functions are actually restricted.

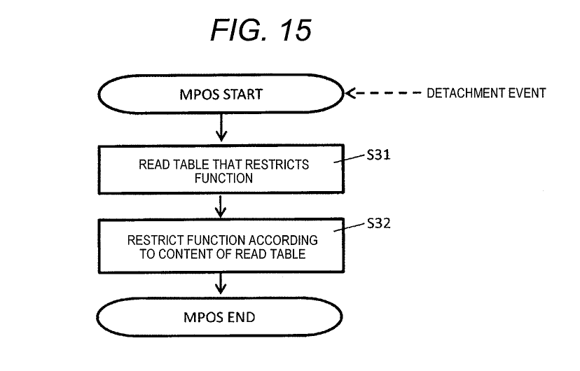

FIG. 15 is a flowchart for describing a second example of the operation of the transaction equipment in the case where the transaction equipment is detached from the docking device. In FIG. 15, the operation of transaction equipment 100 in the case where transaction equipment 100 is detached from docking device 200 is shown. Second CPU 31 of transaction equipment 100 determines that transaction equipment 100 is detached from docking device 200. Second CPU 31 reads a table (detachment function table) which stores a process of permitting or prohibiting a predetermined function from second flash ROM 32 at the time of the detachment of transaction equipment 100 (S31). Second CPU 31 restricts the function of transaction equipment 100 according to the read table (S32). Here, transaction equipment 100 may read the table into transaction equipment 100 from an external server via network NW.

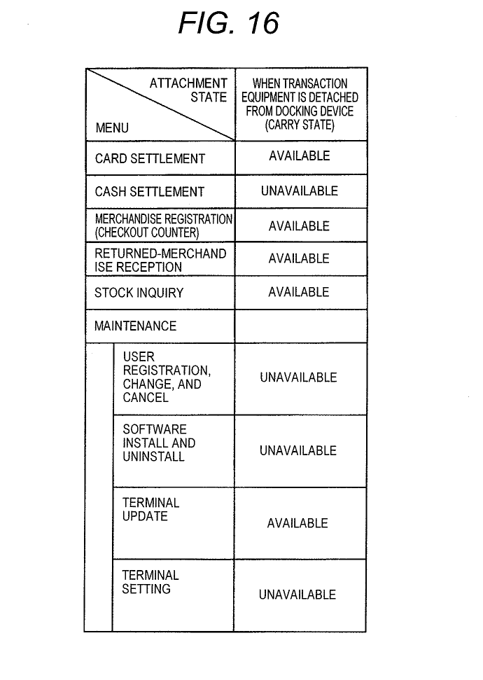

FIG. 16 shows an example of the detachment function table used in the case where the transaction equipment is detached from the docking device. FIG. 16 shows an example of the above-described table (detachment function table). After transaction equipment 100 is detached from docking device 200, the applications of the card settlement, the merchandise registration (checkout counter), the returned-merchandise acceptance and the stock inquiry, and the setting of the terminal update of the maintenance are available. Meanwhile, the application of the cash settlement and the user registration, change and deletion of the maintenance, the software install and uninstall, and the setting of the terminal setting are prohibited (unavailable). That is, unlike the table used at the time of the attachment of transaction equipment 100 shown in FIG. 14 to docking device 200, at least a part of the function of transaction equipment 100 is restricted. That is, the execution of a predetermined application (particularly, the settlement application and the business application) in which the execution is controlled by second CPU 31 is restricted, and a predetermined setting (the user registration, change and deletion of the maintenance) is restricted.

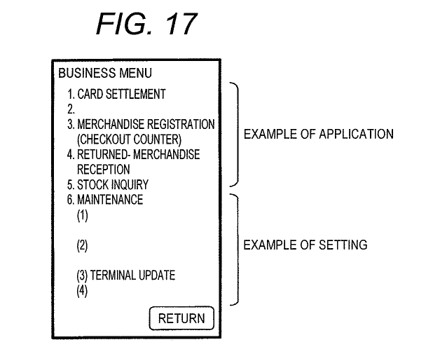

FIG. 17 shows an example of a function restriction state screen displayed on the transaction equipment in a state in which the function is restricted. FIG. 17 shows the function restriction state screen displayed on internal display 34b of transaction equipment 100 in the state in which the function is restricted. As shown in the table of FIG. 16, the cash settlement with restricted functions and the user registration, change and deletion, the software install and uninstall, and the terminal setting of the maintenance are in a non-display state. These items may be in a non-accessible state by displaying these items a gray-out state, and the form of the display with restricted functions is not particularly limited.

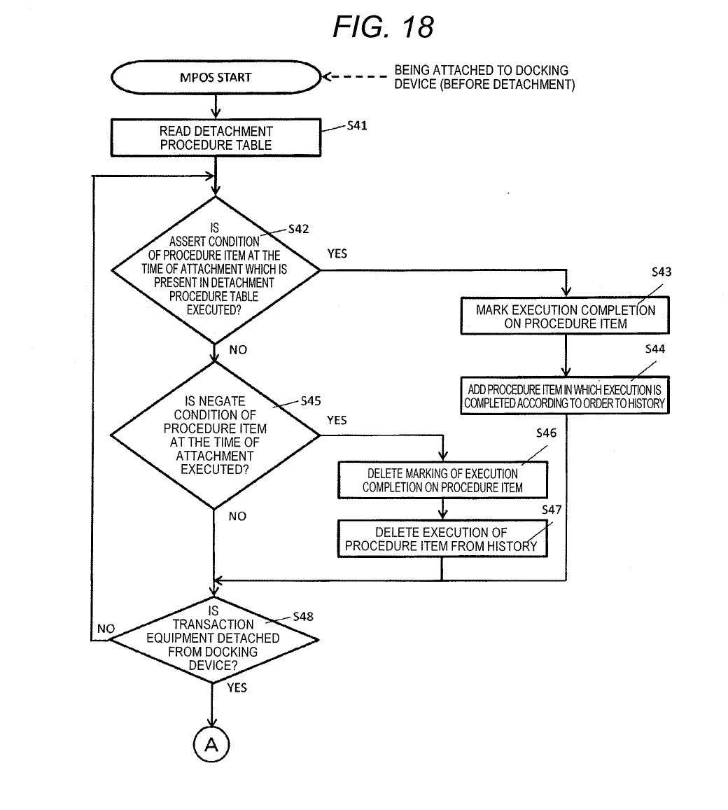

Hereinafter, a third example of the operation of the attachment of transaction equipment 100 to docking device 200 or the detachment of the transaction equipment from docking device 200 will be described with reference to FIGS. 18 to 22. In the present example, second CPU 31 of transaction equipment 100 determines whether or not the detachment of transaction equipment 100 from docking device 200 is performed according to a predetermined procedure. In a case where the detachment is not performed according to the predetermined procedure, transaction equipment 100 is set in an operation restriction state in which the operation is restricted. Here, the “determination of whether or not the detachment is performed according to the predetermined procedure” means “the determination whether or not the detachment is performed according to the predetermined procedure” before and after transaction equipment 100 is detached from docking device 200, that is, at the time of the attachment or after the detachment. The “predetermined procedure” includes at least one procedure (operation), but does not necessarily require a plurality of procedures, and does not necessarily require the order of the plurality of procedures.

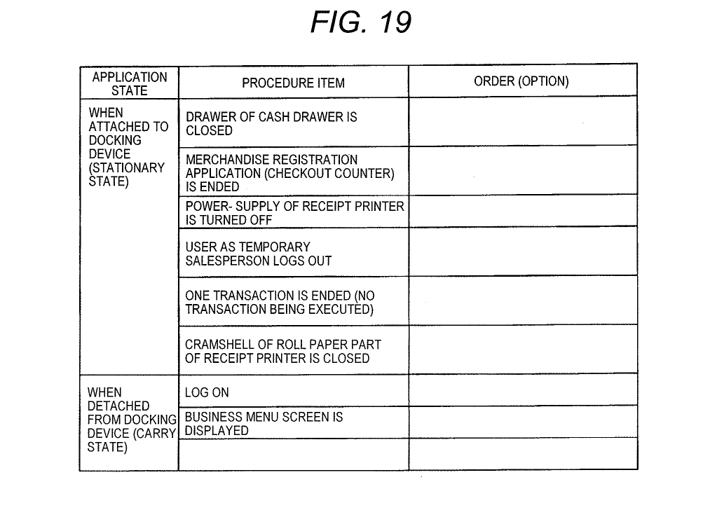

FIG. 18 is a flowchart for describing a third example of the operation of the transaction equipment in the case where the transaction equipment is attached to the docking device. In FIG. 18, the operation of transaction equipment 100 in the case where transaction equipment 100 is normally attached to docking device 200 is shown. At the time of the attachment of the transaction equipment to docking device 200, second CPU 31 of transaction equipment 100 reads and refers to a detachment procedure table stored in second flash ROM 32 shown in FIG. 19 (S41).

FIG. 19 shows an example of the detachment procedure table obtained by representing predetermined procedure items to be adopted in a list form at the time of the detachment of the transaction equipment from the docking device. At the time of the detachment of transaction equipment 100 from docking device 200, the detachment procedure table of FIG. 19 represents the predetermined procedure items to be adopted in the list form, and is greatly divided into procedure items to be adopted at the time of the attachment of the transaction equipment to docking device 200 and procedure items to be adopted after the transaction equipment is detached from docking device 200. The procedure item to be adopted at the time of the attachment of the transaction equipment to docking device 200 includes, for example, procedure items such as 1) a drawer of cash drawer 400 is closed, 2) a merchandise registration application (checkout counter) is ended, 3) the power supply of receipt printer 300 is turned off, 4) a temporary salesperson logs out, 5) a transaction is ended (there is not a transaction being executed), and 6) a clamshell portion of a roll paper part of receipt printer 300. The procedure item to be adopted after the transaction equipment is detached from docking device 200 includes, for example, procedure items such as 1) the salesperson logs on, and 2) a business menu screen is displayed.

The detachment procedure table includes a plurality of procedure items. At least one procedure item may be regarded as a predetermined procedure, and some procedure items may be arbitrarily combined and may be regarded as a predetermined procedure. There is no description in the field of the order, but the order is merely an option, and may be set or may not be set. For example, it is assumed that the order of “clamshell portion of roll paper part of receipt printer 300 is closed” is set to be 1 and the order of “power supply of receipt printer 300 is turned off” is set to be 2. In this case, a predetermined procedure is performed by closing the clamshell portion of the roll paper part of receipt printer 300 and then turning off the power supply of receipt printer 300 before transaction equipment 100 is detached from docking device 200. Through the determination, it is determined that transaction equipment 100 is correctly detached from docking device 200.

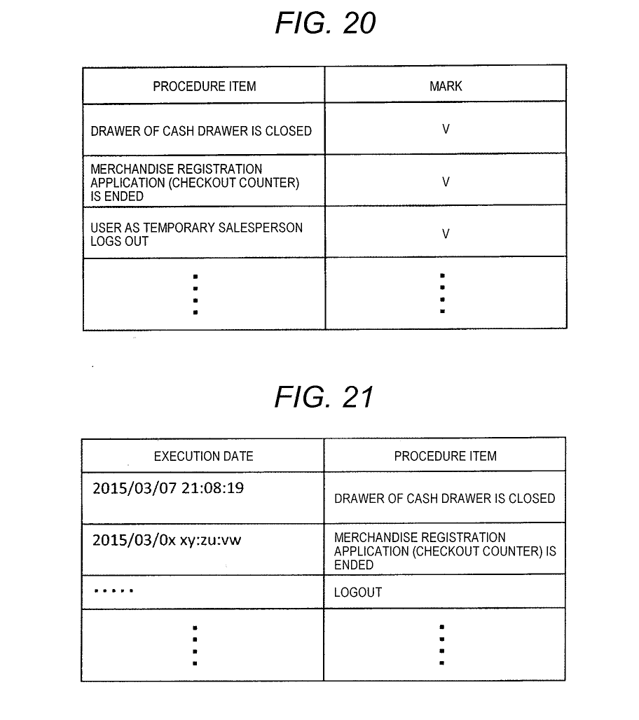

Subsequently, second CPU 31 determines whether or not an assert condition (a procedure condition to be satisfied) of the procedure item to be adopted at the time of attachment present in the detachment procedure table is executed (S42). For example, in a case where “drawer of cash drawer 400 is closed” is the procedure item, the user closing the drawer of cash drawer 400 means the execution of the assert condition. In a case where it is determined that the assert condition is executed (S42, YES), second CPU 31 gives (marks) an execution completion mark on the procedure item corresponding to the assert condition (S43). FIG. 20 shows an example in which the executed procedures are marked and are represented in the table form, and this table can be stored in second flash ROM 32. Second CPU 31 adds the procedure item in which the execution is completed to a history according to the execution procedure (S44). FIG. 21 shows an example in which an execution history is represented in the table form, and can be stored in second flash ROM 32.

Meanwhile, in a case where it is determined that the assert condition is not executed (S42, NO), second CPU 31 determines whether or not a negate condition of the procedure item to be adopted at the time of attachment present in the detachment procedure table is executed (S45). Here, the “negate condition” is a condition corresponding to a procedure of negating the procedure item corresponding to the above-described assert condition. For example, in the case where the drawer of the cash drawer 400 being closed is the assert condition, the drawer of cash drawer 400 being open is the negate condition. In a case where the drawer is closed before the operation shown in FIG. 18, since an event in which the drawer is closed after the operation is started does not occur, it is determined that the assert condition is not executed (S42, NO). Thereafter, since the drawer may be open, it is possible to accurately check whether or not the procedure item in which the drawer is finally closed is satisfied by checking whether or not the negate condition is present.

In a case where it is determined that the negate condition of the procedure item is executed (S45, YES), second CPU 31 removes the execution completion mark (see FIG. 20) stored in second flash ROM 32 (S46). Second CPU 31 newly adds the removal of the procedure item to the execution history (see FIG. 21) stored in second flash ROM 32 (S47). Instead of the addition of the removal of the procedure item, the procedure item which is originally present may be removed.

In a case where it is determined that the negate condition is not executed (S45, NO), after the removal of the procedure item based on the negate condition is added to the execution history stored in second flash ROM 32 (S47), or after the procedure item in which the execution is completed is added to the history (S44), second CPU 31 determines whether or not transaction equipment 100 is detached from docking device 200 (S48). In a case where it is determined that transaction equipment 100 is not detached from docking device 200, second CPU 31 repeats steps subsequent to S41 again (S48, NO).

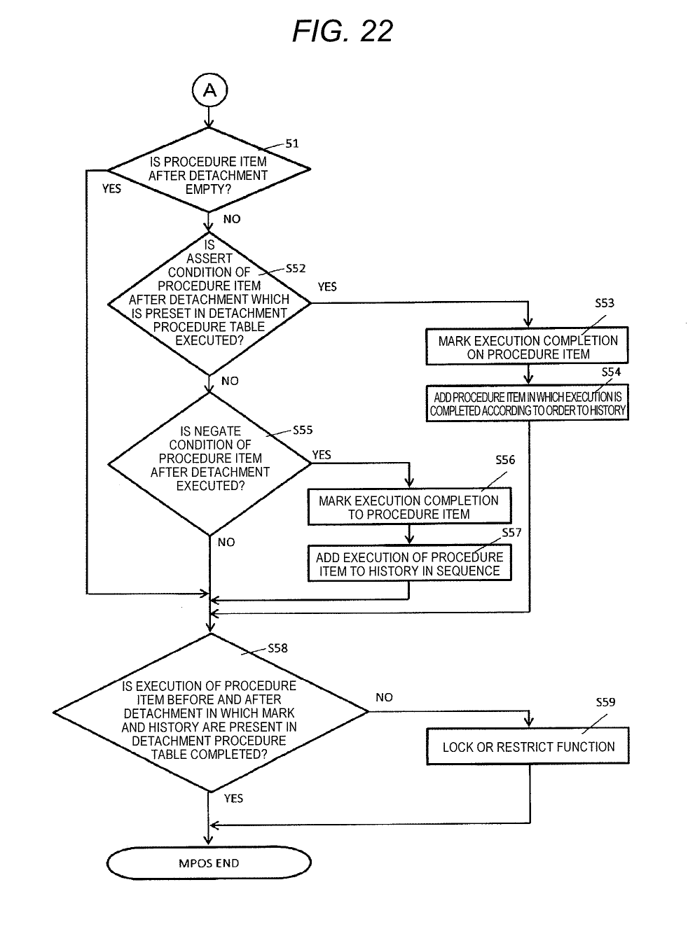

In FIG. 22, the operation of transaction equipment 100 after it is determined as being YES in S48 in FIG. 18, that is, after transaction equipment 100 is detached from docking device 200 is illustrated. Initially, second CPU 31 of transaction equipment 100 determines whether or not the procedure item after the detachment is present, that is, whether or not the procedure item after the detachment of the table of FIG. 19 is empty (S51). In a case where it is determined that the procedure item after the detachment is not present (S51, YES), the operation of S58 to be described below is executed. In a case where it is determined that the procedure item after the detachment is present (S51, NO), second CPU 31 determines whether or not the assert condition of the procedure item to be adopted after the detachment present in the detachment procedure table is executed (S52). For example, in a case where “the user logs on” is the procedure item, the log-on of user is the execution of the assert condition. In a case where it is determined that the procedure item is executed (S52, YES), second CPU 31 marks the execution completion on the procedure item, as shown in FIG. 20 (S53). Second CPU 31 adds the procedure item in which the execution is completed to the history according to the execution order shown in FIG. 21 (S54).

Meanwhile, in a case where it is determined that the assert condition (procedure condition to be satisfied) of the procedure item to be adopted after the detachment present in the detachment procedure table is not executed (S52, NO), second CPU 31 determines whether or not the negate condition of the procedure item to be adopted after the detachment present in the detachment procedure table is executed (S55). For example, in the case where the log-on of the user is the assert condition, the user logging out is the negate condition. In a case where the user logs on before the operation shown in FIG. 22, since an event in which the user logs on after the operation is started does not occur, it is determined that the assert condition is not executed (S52, NO). Subsequently, since the user may log out, it is possible to accurately check whether or not the procedure item in which the user ultimately logs on is satisfied by checking whether or not the negate condition is present.

In a case where it is determined that the negate condition of the procedure item is performed (S55, YES), second CPU 31 removes the execution completion mark (see FIG. 20) stored in second flash ROM 32 from the procedure item (S56). Second CPU 31 newly adds the removal of the procedure item to the execution history (see FIG. 21) stored in second flash ROM 32 (S57). Instead of the addition of the removal of the procedure item, the procedure item which is originally present may be removed.

In a case where it is determined that the procedure item after the detachment of the table of FIG. 19 is not present (empty) (S51, YES), in a case where it is determined that the negate condition is not executed (S55, NO), or after the removal of the procedure item based on the negate condition is added to the execution history stored in second flash ROM 32 (S57), second CPU 31 executes step S58. In S58, second CPU 31 determines whether or not the execution of the procedure item before the detachment (at the time of attachment) present in the detachment procedure table and after the detachment is completed from the mark of FIG. 20 and the execution history of FIG. 21 (the order in a case where the order of options is defined is also considered). In a case where it is determined that the procedure item is executed (S58, YES), second CPU 31 maintains transaction equipment 100 in the present state (unlocked state). Meanwhile, in a case where it is determined that the procedure item is not executed (S58, NO), second CPU 31 sets transaction equipment 100 to be in the locked state or in the function restriction state (S59). In the “locked state”, the locked state screen of FIG. 12 is displayed, and the user inputs a predetermined password, and thus, second CPU 31 changes transaction equipment 100 to the unlocked state in which the transaction equipment can be operated. The “function restriction” means that at least a part of the functions including a predetermined application and a predetermined setting is restricted as in the table shown in FIG. 16, and the screen of FIG. 17 is displayed.

Here, in a case where it is determined that transaction equipment 100 needs to be locked in only the operation of FIG. 18, it is not necessary to perform all the operations of FIG. 22. Specifically, in a case where it is determined that transaction equipment 100 is detached from docking device 200 (S48, YES), second CPU 31 may directly perform the determination of S58 of FIG. 22 after the determination of S48. In this case, in S58, second CPU 31 determines whether or not the execution of the procedure item before the detachment present in the detachment procedure table is completed from the mark of FIG. 20 and the execution history of FIG. 21.

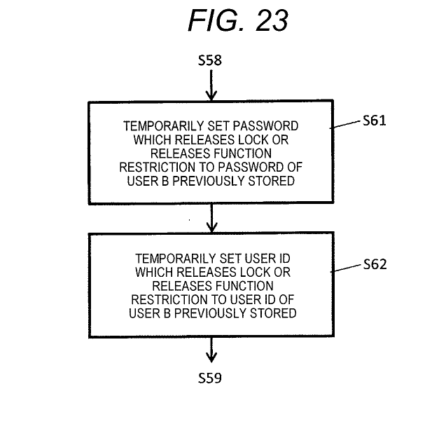

FIG. 23 shows an operation optionally executable between S58 and S59 of FIG. 22, and can be referred to as a modification example of the third example. In the present example, in a case where it is determined that the procedure item is not executed (S58, NO), second CPU 31 temporarily sets the password for unlocking the locked state or releasing the function restriction state to a password of user B stored in advance without suddenly performing the locked state or the function restriction state (S61). Second CPU 31 temporarily sets a user ID capable of unlocking the locked state or releasing the function restriction state to a user ID of user B stored in advance (S62). In such a state, second CPU 31 sets transaction equipment 100 to be in the locked state or the function restriction state (S59). The setting of the user ID to user B in S62 may be set so as to be omitted.

For example, in a case where user B is a store manager, only the store manager can set transaction equipment 100 to be in the unlocked state according to the above-described process. Only a user who has authority and responsibility can release the locked state or the function restriction state (S59).

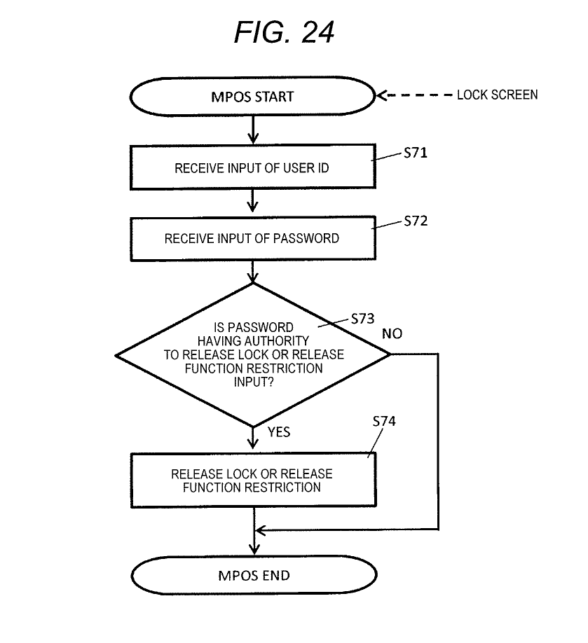

FIG. 24 is a flowchart for describing an operation procedure of setting the transaction equipment in the unlocked state again after the operation of FIG. 22. FIG. 24 shows an operation procedure of setting transaction equipment 100 in the unlocked state again after transaction equipment 100 is set in the locked state or the function restriction state (S59) in the state of FIG. 22. Second CPU 31 receives the input of the user ID in key-input unit 42 by the user (S71), and receives the input of the password in key-input unit 42 by the user (S72). Second CPU 31 determines whether or not the password with the authority to release the locked state or the function restriction state is input (S73). In a case where it is determined that the password is input (S73, YES), second CPU 31 releases the locked state or the function restriction state of transaction equipment 100 (S74). In a case where it is determined that the password is not input (S73, NO), the transaction equipment is ended in the locked state or the function restriction state. The setting of user B to the user ID in S71 may be set so as to be omitted.

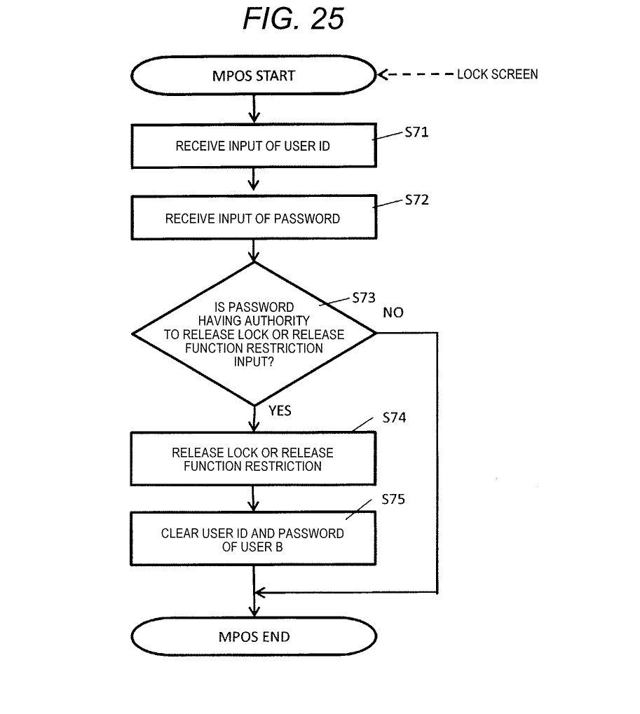

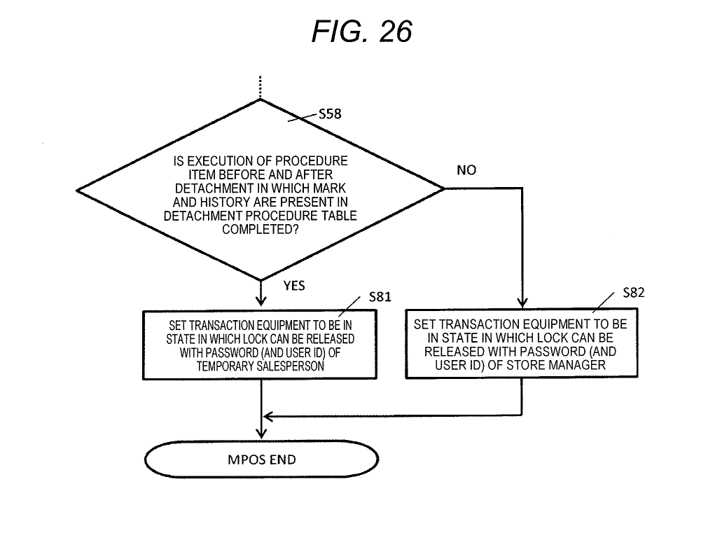

FIG. 25 is a flowchart for describing the operation procedure of setting the transaction equipment in the unlocked state again after the setting of FIG. 23 is performed. FIG. 25 shows the operation procedure of setting transaction equipment 100 in the unlocked state again after the setting of FIG. 23 is performed. This procedure is substantially the same as that shown in FIG. 24, but step S75 is added. That is, in FIG. 23, second CPU 31 temporarily sets the password for releasing the locked state or the function restriction state to the password of user B stored in advance (S61). Thus, in S75, the temporal setting of user B to the password is reset, and the password is returned to the original password.

In S59 of FIG. 22, second CPU 31 may remove or destroy information such that the stored information is not able to be read. That is, in a case where the connection check or authentication between transaction equipment 100 and docking device 200 fails and the detachment is not performed according to a predetermined procedure, second CPU 31 may allow information stored in second flash ROM 32 so as not to be read. The information being able to be read includes various methods such as the removal or destruction of the information allowing the information so as not to be read. The information items include the encryption key of the settlement center, the PIN, the card information.

FIG. 26 is a modification example of the process after S58 of FIG. 22 and is a flowchart for describing a fourth example of the detachment operation of the transaction equipment from the docking device. FIG. 26 is a modification example of the process after S58 of FIG. 22, and is a fourth example of the detachment operation of transaction equipment 100 from docking device 200. In the present example, second CPU 31 determines whether or not the detachment is performed according to the predetermined procedure when the connection check or authentication between transaction equipment 100 and docking device 200 fails through the detachment. The setting of transaction equipment 100 is changed between a predetermined procedure case where the detachment is performed according to the predetermined procedure and an abnormality procedure case where the detachment is not performed according to the predetermined procedure. Specifically, in a case where it is determined that the procedure item is executed (S58, YES), second CPU 31 sets transaction equipment 100 to be in a state in which the locked state of the transaction equipment can be released using the password (and the user ID) of the temporary salesperson (S81). Meanwhile, in a case where it is determined that the procedure item is not executed (S58, NO), second CPU 31 sets transaction equipment 100 to be in a state in which the locked state of the transaction equipment can be released through the input of the password (and the user ID) of the store manager (S82). The present example is an example in which different passwords for changing transaction equipment 100 to the unlocked state in which the transaction equipment can be operated are used between the predetermined procedure case and the abnormality procedure case.

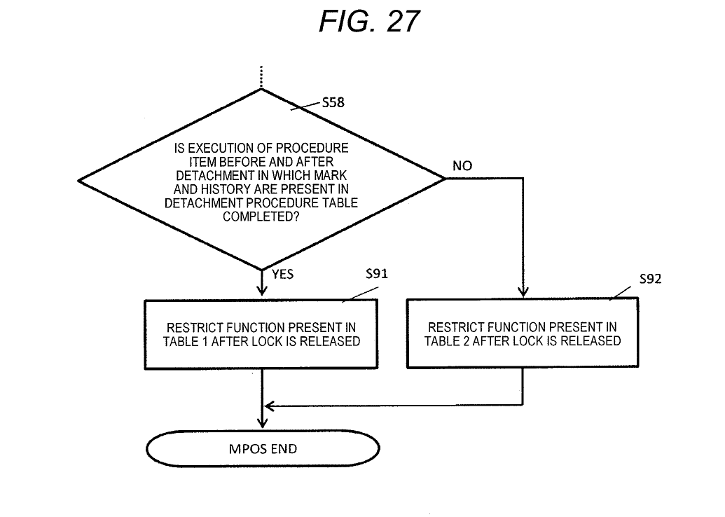

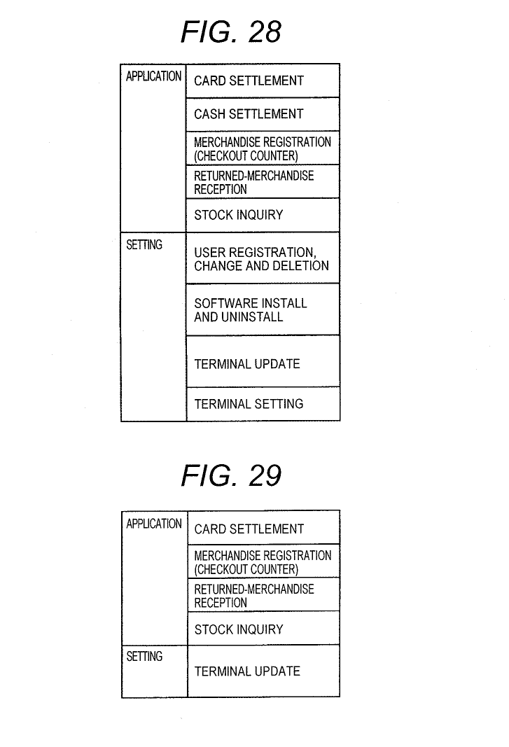

FIG. 27 is another modification example of the process after S58 of FIG. 22, and is a flowchart for describing a fifth example of the detachment operation of the transaction equipment from the docking device. FIG. 28 is an example of Table 1 in which the functions of the transaction equipment are restricted. FIG. 29 is an example of Table 2 in which the functions of the transaction equipment are restricted. FIG. 27 is another modification example of the process after S58 of FIG. 22, and is a fifth example of the detachment operation of transaction equipment 100 from docking device 200. In a case where it is determined that the procedure item is executed (S58, YES), second CPU 31 restricts (permits or prohibits) the use of the functions (including the applications and settings) present in Table 1 shown in FIG. 28 after the locked state of transaction equipment 100 is unlocked (S91). That is, after the locked state is unlocked, the user can use all the applications and all the settings of transaction equipment 100 as shown in Table 1. Meanwhile, in a case where it is determined that the procedure item is not executed (S58, NO), second CPU 31 restricts (permits or prohibits) the use of the functions (including the applications and settings) present in Table 2 shown in FIG. 29 after the locked state of transaction equipment 100 is released (S92). That is, the user can use only the restricted applications and settings of transaction equipment 100 as shown in Table 2 after the locked state is unlocked. The present example is an example in which different functions of transaction equipment 100 are restricted between the predetermined procedure case and the abnormality procedure case.

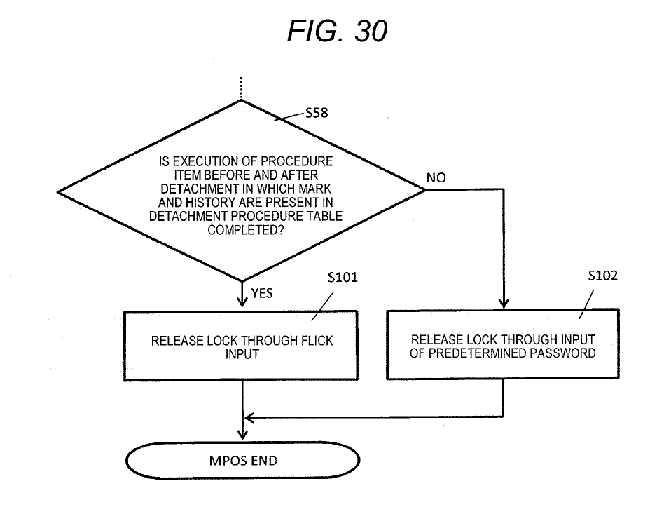

FIG. 30 is another modification example of the process after S58 of FIG. 22, and is a flowchart for describing a sixth example of the detachment operation of the transaction equipment from the docking device. FIG. 30 is another modification example of the process after S58 of FIG. 22, and is a sixth example of the detachment operation of transaction equipment 100 from docking device 200. In a case where it is determined that the procedure item is executed (S58, YES), second CPU 31 sets transaction equipment 100 to be in a state in which the locked state of the transaction equipment can be unlocked through a flick input (S101). Meanwhile, in a case where it is determined that the procedure item is not executed (S58, NO), second CPU 31 sets transaction equipment 100 to be in a state in which the locked state of the transaction equipment can be unlocked through the input of the predetermined password (and the user ID) (S102). The present example is an example in which different operations for changing transaction equipment 100 to the unlocked state in which the transaction equipment can be operated between the predetermined procedure case and the abnormality procedure case.

As stated above, in transaction equipment 100 of the present exemplary embodiment or the transaction processing method in transaction equipment 100, application controller (second CPU) 31 that controls the execution of the predetermined application, and checks and authenticates whether or not communication with docking device 200 connected to at least one peripheral equipment used in the application is connected is used. In a case where the connection check or authentication between transaction equipment 100 and docking device 200 is not established through the detachment of transaction equipment 100 from docking device 200, application controller 31 sets transaction equipment 100 to be in the operation restriction state in which the operation is restricted.

As mentioned above, even in a case where the transaction equipment is used while being detached from docking device 200, transaction equipment 100 is set in the operation restriction state without requiring a complicated setting operation of the salesperson as the user. Thus, it is possible to effectively control an unauthorized operation associated with a reduction in physical deterrent effect and psychological deterrent effect.

In a case where the connection check or authentication between transaction equipment 100 and docking device 200 fails, application controller 31 may set transaction equipment 100 to be in the locked state in which the transaction equipment is not able to be operated. In this case, application controller 31 may change the transaction equipment in the unlocked state in which the transaction equipment can be operated through the input of the predetermined password. As described above, it is possible to effectively prevent the unauthorized operation, and it is possible to improve the convenience of the user.

In the case where the connection check or authentication between transaction equipment 100 and docking device 200 fails, application controller 31 may restrict at least a part of the functions of transaction equipment 100. Thus, it is possible to effectively prevent the unauthorized operation, and it is possible to secure the convenience of the user to some extent.

In transaction equipment 100 of the present exemplary embodiment, or the transaction processing method in transaction equipment 100, application controller 31 which controls the execution of the predetermined application, and checks and authenticates whether or not the communication with docking device 200 connected to at least one peripheral equipment used in the application is connected is used. In a case where the connection check or authentication between transaction equipment 100 and docking device 200 fails through the detachment of transaction equipment 100 from docking device 200 and the detachment is not performed according to the predetermined procedure, application controller 31 sets transaction equipment 100 to be in the operation restriction state in which the operation is restricted.

Thus, even in a case where the transaction equipment is used while being detached from docking device 200, transaction equipment 100 is set in the operation restriction state without requiring a complicated setting operation of the salesperson as the user. Accordingly, it is possible to effectively prevent the unauthorized operation associated with the reduction in the physical deterrent effect and psychological deterrent effect.

In a case where the connection check or authentication between transaction equipment 100 and docking device 200 fails and the detachment is not performed according to the predetermined procedure, application controller 31 may set transaction equipment 100 to be in the locked state in which the operation is not able to be performed. In this case, application controller 31 may change the transaction equipment in the unlocked state in which the transaction equipment can be operated through the input of the predetermined password. Thus, it is possible to effectively prevent the unauthorized operation, and it is possible to improve the convenience of the user.

In a case where the connection check and authentication between transaction equipment 100 and docking device 200 fails and the detachment is not performed according to the predetermined procedure, application controller 31 may restrict at least a part of the functions of transaction equipment 100. Thus, it is possible to effectively prevent the unauthorized operation, and it is possible to secure the convenience of the user to some extent.

In a case where the connection check and authentication between transaction equipment 100 and docking device 200 fails and the detachment is not performed according to the predetermined procedure, application controller 31 may allow information stored in transaction equipment 100 so as not to be read. Accordingly, it is possible to effectively prevent the unauthorized operation.

In transaction equipment 100 of the present exemplary embodiment, or the transaction processing method in transaction equipment 100, application controller 31 which controls the execution of the predetermined application, and checks and authenticates whether or not the communication with docking device 200 connected to at least one peripheral equipment used in the application is connected is used. When the connection check or authentication between transaction equipment 100 and docking device 200 fails through the detachment of transaction equipment 100 from docking device 200, application controller 31 determines whether or not the detachment is performed according to the predetermined procedure, and changes the setting of transaction equipment 100 between the predetermined procedure case in which the detachment is performed according to the predetermined procedure and the abnormality procedure case in which the detachment is not performed according to the predetermined procedure.

Thus, even in the case where the transaction equipment is used while being detached from docking device 200, transaction equipment 100 can change the setting according to the detachment order without requiring a complicated setting operation of the salesperson as the user. Accordingly, it is possible to effectively prevent the unauthorized operation associated with the reduction in the physical deterrent effect and psychological deterrent effect while securing the convenience of the user.

Application controller 31 may use different passwords for changing transaction equipment 100 to the unlocked state in which the transaction equipment can be operated between the predetermined procedure case and the abnormality procedure case. Application controller 31 may perform different operations for changing transaction equipment 100 to the unlocked state in which the transaction equipment can be operated between the predetermined procedure case and the abnormality procedure case. Application controller 31 may restrict different functions of transaction equipment 100 between the predetermined procedure case and the abnormality procedure case. Thus, even in the case where the transaction equipment is used while being detached from docking device 200, transaction equipment 100 can change the setting according to the detachment order without requiring a complicated setting operation of the salesperson as the user. Accordingly, it is possible to effectively prevent the unauthorized operation associated with the reduction in the physical deterrent effect and psychological deterrent effect while securing the convenience of the user.

### Second Exemplary Embodiment

In the second exemplary embodiment, the same configuration and operation as the configuration and operation described in the above-described exemplary embodiment will be assigned same reference numerals, and thus, the description thereof will be omitted or simplified.

### Initial Registration of User Information in Transaction Equipment

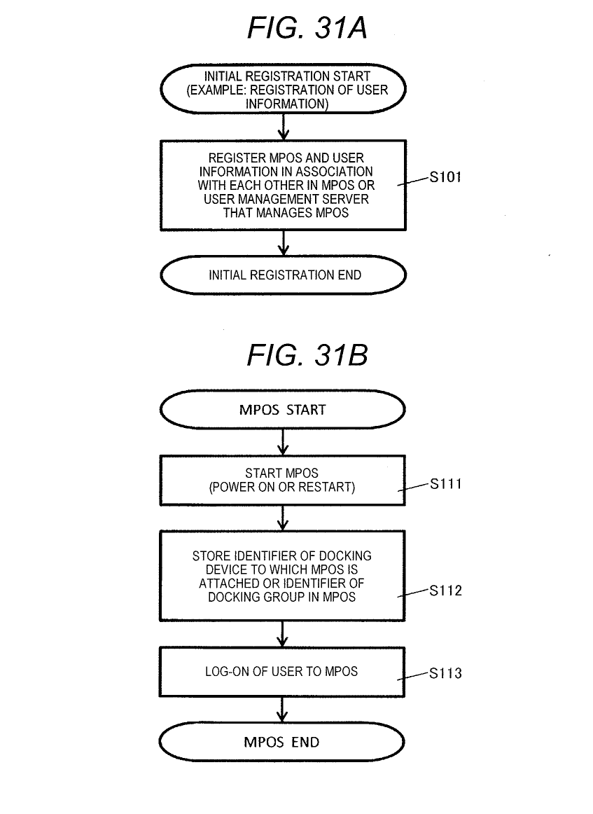

Hereinafter, the operation procedure of the initial registration of the user information in transaction equipment 100 will be described with reference to FIG. 31A. FIG. 31A is a flowchart for describing an example of the operation procedure of the initial registration of transaction equipment 100.

In FIG. 31A, second CPU 31 of transaction equipment 100 stores an equipment number of transaction equipment 100 and user information (for example, a log-on ID and a password) of the user (for example, the store manager, the temporary salesperson, or the part-time salesperson) who uses transaction equipment 100 so as to be correlated with one another in second RAM 33 in response to the input operation of the user (for example, the store manager) with the authority to register the user information (S101, initial registration). In the initial registration of step S1, a data storing destination indicating the correlation between the equipment number of transaction equipment 100 and the user who uses transaction equipment 100 is not limited to transaction equipment 100, but may be, for example, a user management server to which transaction equipment 100 is connected through docking device 200 and the network. The user management server manages at least one transaction equipment, and manages the user information of the user who uses each transaction equipment.

Hereinafter, the operation procedure when transaction equipment 100 is turned on by being attached to docking device 200 will be described with reference to FIG. 31B. FIG. 31B is a flowchart for describing an example of the operation procedure when transaction equipment 100 is started by being attached to docking device 200. On the assumption of the description of FIG. 31B, the present operation procedure is performed when transaction equipment 100 is attached to docking device 200.

In the following description, it is assumed that the case where transaction equipment 100 is attached to docking device 200 is, for example, a case where transaction equipment 100 is held in and is attached to equipment holding space ECPV of docking device 200, locking part J2 is fixed through the tool such as the driver and is physically fixed, and it is authenticated that correct transaction equipment 100 is attached to and is electrically connected to docking device 200 by device authentication controller 63 as the result of the challenge response process between transaction equipment 100 and docking device 200.

In the following description, it is assumed that the case where transaction equipment 100 is detached from docking device 200 is, for example, a case that satisfies at least one of a case where transaction equipment 100 is detached from equipment holding space ECPV of docking device 200, a case where the physical fixation of transaction equipment 100 to docking device 200 is released as the result in which the locked state of locking part J2 is unlocked, and a case where the abnormality result is obtained in the challenge response process between transaction equipment 100 and docking device 200 and the authentication fails.

In FIG. 31B, it is assumed that transaction equipment 100 is started in a state in which transaction equipment 100 is attached to docking device 200 (S111). For example, the start of transaction equipment 100 in step S111 corresponds to a case where transaction equipment 100 is turned on or a case where transaction equipment 100 is restarted.

If transaction equipment 100 is started, second CPU 31 of transaction equipment 100 obtains an identifier of docking device 200 to which transaction equipment 100 is attached or an identifier (group identifier) of various peripheral equipments (hereinafter, referred to as a “docking group”) connected to docking device 200 from docking device 200 through docking device I/F 46, and stores the obtained identifiers in second RAM 33 (5112). For example, since a plurality of checkout counters is set to the store in many cases, it is considered that the docking group is formed to each checkout counter. The identifier of the docking group is provided in order to identify each docking group.

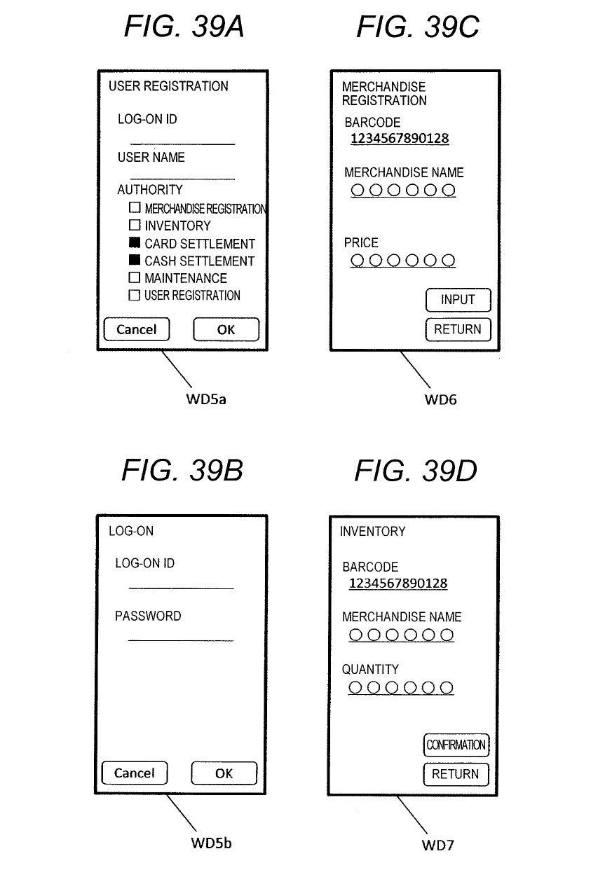

After step S112, second CPU 31 displays screen WD5b (see FIG. 39B) for obtaining the log-on of the user who uses transaction equipment 100 on touch panel TP2, and prompts the user to perform the log-on process (S113). The user ID and password for log-on are input, and when the input user ID and password match with the user ID and password which are initially registered in step S1, the log-on process of the user is ended.

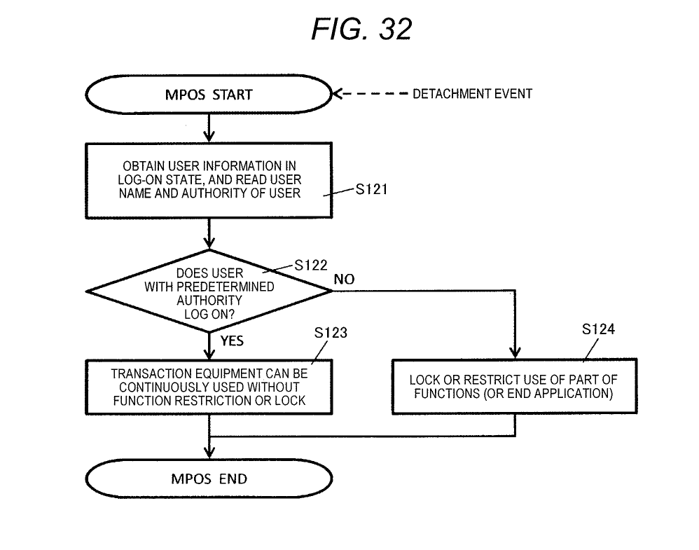

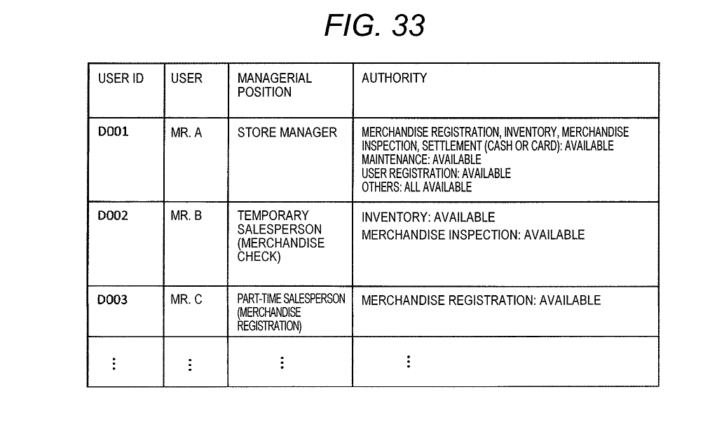

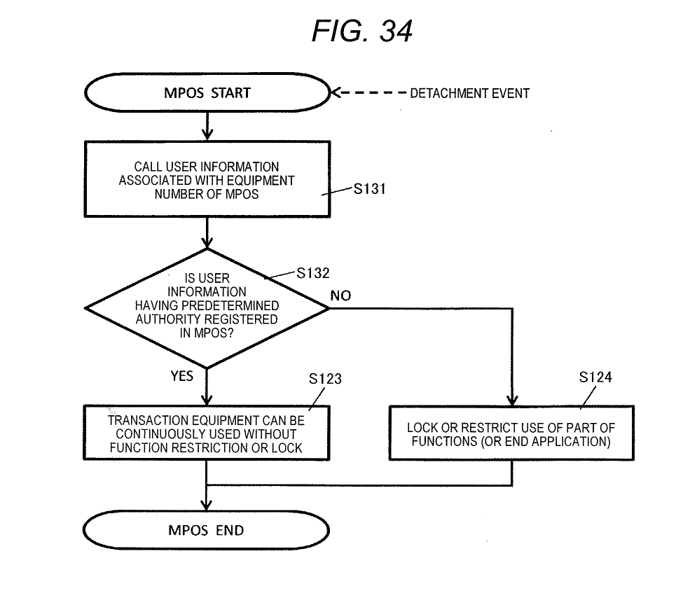

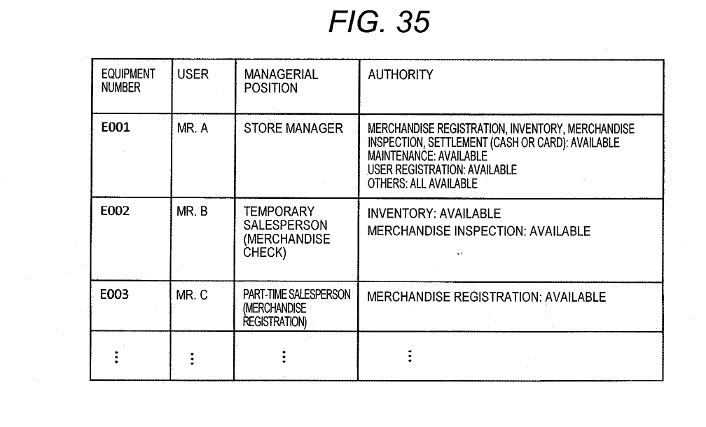

Hereinafter, the operation procedure when transaction equipment 100 is detached from docking device 200 will be described with reference to FIGS. 32 to 35. FIG. 32 is a flowchart for describing a first example of the operation procedure when transaction equipment 100 is detached from docking device 200. FIG. 33 is a table showing a first example of the user information. FIG. 34 is a flowchart for describing a second example of the operation procedure when transaction equipment 100 is detached from docking device 200. FIG. 35 is a table showing a second example of the user information. On the assumption of the description of FIGS. 32 and 34, it is assumed that transaction equipment 100 is attached to docking device 200 and the user logs on to transaction equipment 100.

In FIG. 32, if transaction equipment 100 is detached from docking device 200, second CPU 31 of transaction equipment 100 obtains the user information (for example, the user ID) of the user which has logged on by referring to second RAM 33, for example. Second CPU 31 at least reads the authority of the user and the user name corresponding to the user ID by referring to the table of the user information shown in FIG. 33 (S121).

In a case where the user (for example, the store manager as a business responsible person in the store) with a predetermined authority logs on (S122, YES), second CPU 31 sets transaction equipment to be in an operation permission state (in other words, a state in which the operation of the user is not locked or a state in which the operation for a partial of the functions is not restricted) in which the operation of the user is permitted without restricting or locking the functions (for example, the applications executable in transaction equipment 100) of transaction equipment 100 (S123). The locking means that the operation of the user on transaction equipment 100 is unavailable. Thus, in a case where a user (for example, the store manager) with a specific authority logs on, transaction equipment 100 can be continuously used by the user without distinguishing between a case where transaction equipment 100 is used as single equipment and a case where transaction equipment 100 is used while being attached to docking device 200. That is, even in the case where the user uses transaction equipment 100 as the single equipment, since the continuity of the business in the store can be guaranteed, it is possible to prevent the convenience of the salesperson who conducts the business in the store from being degraded.

Meanwhile, in a case where the user (for example, the store manager as a business responsible person in the store) with the predetermined authority does not log on (S122, NO), second CPU 31 sets transaction equipment 100 to be in the locked state for allowing the user so as not to operate transaction equipment 100 (S124). Second CPU 31 restricts a specific function (for example, a specific application executable in transaction equipment 100) of transaction equipment 100, and sets the transaction equipment to be in the operation restriction state in which the operation of the user is restricted (S124). The specific application as the operation restricting target is previously set depending on the user information of the user who has logged on. The specific application is, for example, an application that uses personal information having high security, an application for maintenance executable in transaction equipment 100, and an application that handles articles (for example, cash) which is strictly managed in the store, and the same applies later. Thus, in a case where another user other than the user (for example, the store manager) with the specific authority logs on, transaction equipment 100 is distinguished between the case where transaction equipment 100 is used as the single equipment and the case where transaction equipment 100 is used while being attached to docking device 200, and thus, it is possible to secure the security of transaction equipment 100 by locking the use of transaction equipment 100. Since transaction equipment 100 serves to restrict the operation of the another user with respect to the specific function of transaction equipment 100, the continuity of the business in the store can be guaranteed while securing the security by executing only the functions corresponding to the authority given to the user who has logged on, and thus, it is possible to prevent the convenience of the salesperson who conducts the business in the store from being degraded.

In the table shown in FIG. 33, the user ID, and the name, managerial position and authority of the user are correlated with one another. All the functions related to the settlement application and the business application in transaction equipment 100 is set to Mr. A (user ID: “D001”) with the managerial position of the store manager so as to be available. Specifically, a merchandise registration application, an inventory application, a merchandise inspection application, a settlement application (including both an application for cash settlement and an application for card settlement), and an application for maintenance are executable, and another business such as a user registration process is available. That is, Mr. A who is the store manager can perform the operations related to all the businesses in the store where transaction processing system 1000 is provided and execute the applications without distinguishing between the case where transaction equipment 100 is used as the single equipment and the case where the transaction equipment is used while being attached to docking device 200.

For example, only the inventory application and the merchandise inspection application are set to Mr. B (user ID: “D002”) of a temporary salesperson who is mainly in charge of merchandise check, as the business application using transaction equipment 100 so as to be executable. For example, only the merchandise registration application is set to Mr. C (user ID: “D003”) of a part-time salesperson who is mainly in charge of merchandise registration, as the business application using transaction equipment 100 so as to be executable.

That is, in a case where Mr. B who is the temporary salesperson and Mr. C who is the part-time salesperson use transaction equipment 100 as single equipment, the usable functions are restricted unlike the case where the transaction equipment is used while being attached to docking device 200. In the case where Mr. B who is the temporary salesperson and Mr. C who is the part-time salesperson use transaction equipment 100 being attached to docking device 200, the use of the specific function (for example, the application) may be restricted as shown in FIG. 33, or the use of the specific function may not be restricted. Even though the use of the specific function is not restricted, in the case where transaction equipment 100 is used while being attached to docking device 200, it is possible to prevent the salesperson from performing the unauthorized operation due to the reduction in the physical deterrent effect and conspicuous psychological deterrent effect through the attachment of transaction equipment 100 to stationary type docking device 200.

In FIG. 34, for example, if transaction equipment 100 is detached from docking device 200, second CPU 31 of transaction equipment 100 obtains the equipment number of transaction equipment 100 by referring to second RAM 33. Second CPU 31 reads at least the user name corresponding to the equipment number and the authority of the user by referring to the table of the user information shown in FIG. 35 (S131).

Here, in a case where the user (for example, the store manager who is a business responsible person in the store) with the predetermined authority is correlated with the equipment number (S132, YES), second CPU 31 sets the transaction equipment to be in the operation permission state (in other words, a state in which the operation of the user is not locked, or a state in which the operation for a part of the functions is not restricted) in which the operation of the user is permitted without restricting or locking the functions (for example, the application executable in transaction equipment 100) of transaction equipment 100 (S123). Thus, in a case where the user (for example, the store manager) with the specific authority is correlated to the equipment number, transaction equipment 100 can be continuously used by the user without distinguishing the case where transaction equipment 100 is used as the single equipment and the case where transaction equipment 100 is used while being attached to docking device 200. That is, even in the case where transaction equipment 100 is used as the single equipment, since the use can guarantee the continuity of the business in the store, it is possible to prevent the convenience of the salesperson who conducts the business in the store from being degraded.

Meanwhile, in a case where the user (for example, the store manager who is a business responsible person in the store) with the predetermined authority is not correlated with the equipment number (S132, NO), second CPU 31 sets transaction equipment 100 to be in the locked state in order to the user so as not to operate the transaction equipment (S124). Second CPU 31 restricts the specific function (for example, the specific application executable in transaction equipment 100) of transaction equipment 100, and sets the transaction equipment to be in the operation restriction state in which the operation of the user is restricted (S124). Thus, in a case where another user who is not the user (for example, the store manager) with the specific authority is correlated with the equipment number, the case where transaction equipment 100 is used as the single equipment and the case where transaction equipment 100 is used while being attached to docking device 200 are distinguished, and thus, it is possible to ensure the security of transaction equipment 100 by locking the use of transaction equipment 100. Since the operation of the another user on the specific function of transaction equipment 100 is restricted, transaction equipment 100 can guarantee the continuity of the business in the store while ensuring the security by executing only the functions corresponding to the authority given to the user corresponding to the equipment number, and thus, it is possible to prevent the convenience of the salesperson who conducts the business of the store from being degraded.

In the table shown in FIG. 35, there is a difference from the table shown in FIG. 33 is that the user ID is replaced with the equipment number, and the contents of other items are the same. Thus, the description thereof will be omitted.

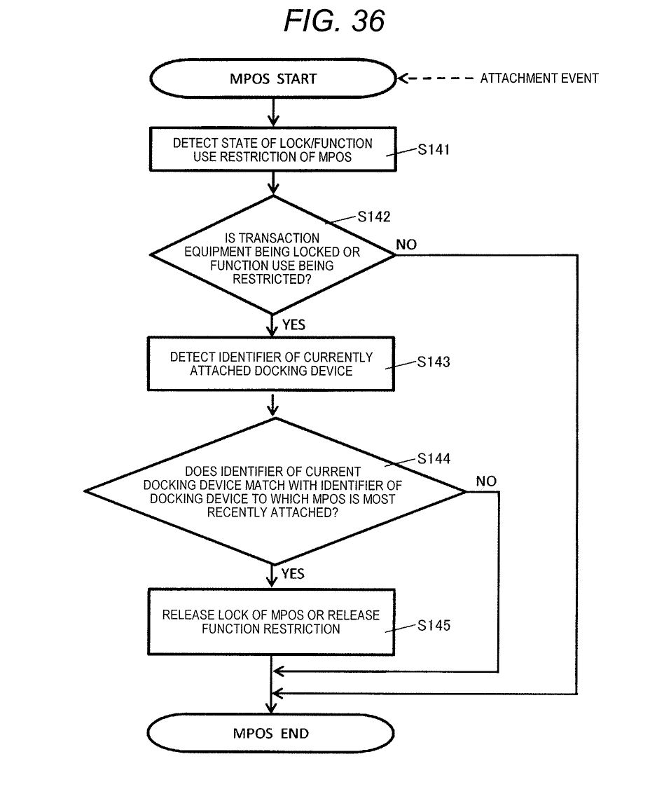

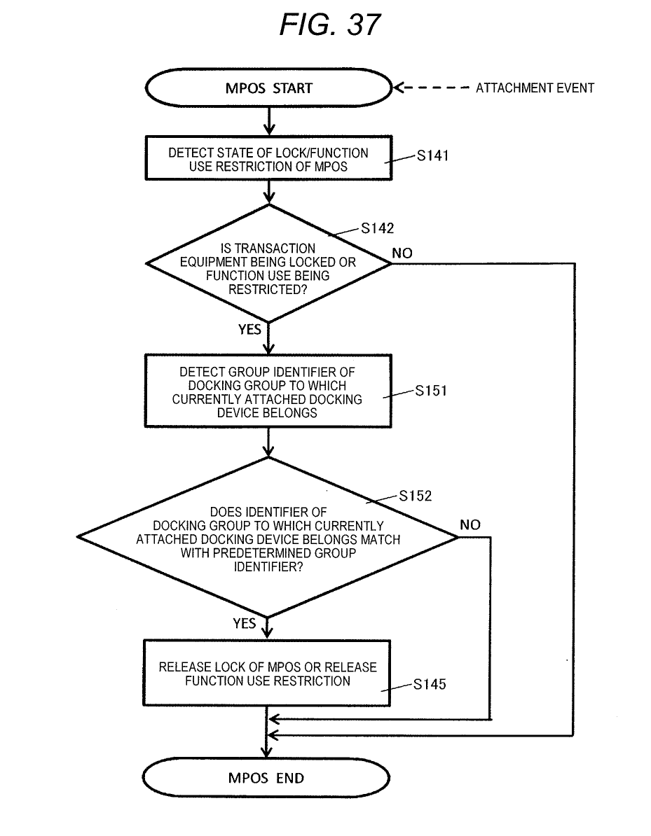

Hereinafter, the operation procedure when the transaction equipment is attached to the same or another docking device after transaction equipment 100 is detached from docking device 200 once will be described with reference to FIGS. 36 and 37. FIG. 36 is a flowchart for describing a first example of the operation procedure when the transaction equipment is attached to the docking device after transaction equipment 100 is detached from docking device 200. FIG. 37 is a flowchart for describing a second example of the operation procedure when the transaction equipment is attached to the docking device after transaction equipment 100 is detached from docking device 200. On the assumption of the description of FIGS. 36 and 37, the present operation procedure is performed when the transaction equipment is attached to the docking device after transaction equipment 100 is detached from docking device 200 once.

In FIG. 36, for example, if transaction equipment 100 is attached to the docking device, second CPU 31 of transaction equipment 100 detects whether transaction equipment 100 is set in the locked state or the transaction equipment is set in the state in which the specific function is restricted through the process shown in FIG. 32 or 34 (S141). Information for setting transaction equipment 100 in the locked state, or information for setting the transaction equipment in the state (operation restriction state) in which the specific function is restricted are retained, for example, in second RAM 33.

In a case where transaction equipment 100 is set neither in the locked state nor in the state in which the specific function is restricted (S142, NO), the process of transaction equipment 100 shown in FIG. 36 is ended.

Meanwhile, in a case where transaction equipment 100 is set in the locked state or the state in which the specific function is restricted (S142, YES), second CPU 31 detects an identifier of the currently attached docking device, and obtains the detected identifier (S143).

Second CPU 31 determines whether or not the identifier (that is, the identifier of the currently attached docking device) of the docking device obtained in step S43 matches with the identifier of most recently attached docking device 200 (S144).

In a case where it is determined that the identifier of the currently attached docking device matches with the identifier of most recently attached docking device 200 (S144, YES), second CPU 31 releases the locked state or the operation restriction state of transaction equipment 100 (S145). Thus, for example, even in both a state which the use of transaction equipment 100 is locked and a state in which the specific function (for example, the operation for the application) is restricted, in a case where the transaction equipment is attached to most recently attached docking device 200, transaction equipment 100 is set such that the operations for all the applications are permitted even in a state in which the user (for example, the store manager) with the specific authority does not log on. Accordingly, it is possible to prevent the unauthorized operation of the salesperson from being caused due to the physical deterrent effect through the attachment of the transaction equipment to stationary type docking device 200 and the conspicuous psychological deterrent effect, and thus, it is possible to smoothly perform the business of the store without delay by using transaction equipment 100 even in a case where troubles occur during the typical business.

Meanwhile, in a case where it is determined that the identifier of the currently attached docking device does not match with the identifier of most recently attached docking device 200 (S144, NO), second CPU 31 does not release the locked state or operation restriction state of transaction equipment 100. Thus, in a case where the user (for example, the store manager who is the business responsible person in the store) with the specific authority is not present, the locked state of transaction equipment 100 is continued or the use of the specific application (for example, the application using information having high security) is continuously restricted, and thus, it is possible to prevent the unauthorized operation of the salesperson from being caused due to the reduction in the physical deterrent effect through the detachment of the transaction equipment from stationary type docking device 200 and the reduction in the conspicuous psychological deterrent effect.

In FIG. 37, in a case where transaction equipment 100 is set in the locked state or the state in which the specific function is restricted (S142, YES), second CPU 31 detects a group identifier of a docking group including the currently attached docking device and at least one peripheral equipment connected to the docking device, and obtains the detected group identifier (S151).

Second CPU 31 determines whether or not the group identifier obtained in step S151 matches with a predetermined group identifier (S152). That is, it is determined whether or not the salesperson attaches transaction equipment 100 to the specific docking device to which the specific peripheral equipment of the store is connected.

In a case where it is determined that the group identifier of the docking group to which the currently attached docking device belongs matches with the predetermined group identifier (S152, YES), second CPU 31 releases the locked state or operation restriction state of transaction equipment 100 (S145). Thus, for example, even in both a state in which the use of transaction equipment 100 is locked and a state in which the specific function (for example, the operation for the application) thereof is restricted, in a case where the transaction equipment is attached to the specific docking device (for example, docking device 200) connected to the specific peripheral equipment, transaction equipment 100 is set such that the operations for all the applications are permitted even in a state in which the user (for example, the store manager) with the specific authority does not log on. Accordingly, it is possible to prevent the unauthorized operation of the salesperson from being caused due to the physical deterrent effect through the attachment of transaction equipment 100 to stationary type docking device 200 and the conspicuous psychological deterrent effect, and thus, it is possible to smoothly perform the business of the store without delay by using transaction equipment 100 even in a case where troubles occur during the typical business.

Meanwhile, in a case where it is determined that the group identifier of the docking group to which the currently attached docking device belongs does not match with the predetermined group identifier (S152, No), second CPU 31 does not release the locked state or operation restriction state of transaction equipment 100. Thus, in a case where the user (for example, the store manager who is the business responsible person in the store) with the specific authority is not present, the use of the specific application (for example, the application using information having high security) is restricted, and thus, it is possible to prevent the unauthorized operation of the salesperson from being caused due to the reduction in the physical deterrent effect through the detachment of the transaction equipment from stationary type docking device 200 and the reduction in the conspicuous psychological deterrent effect.

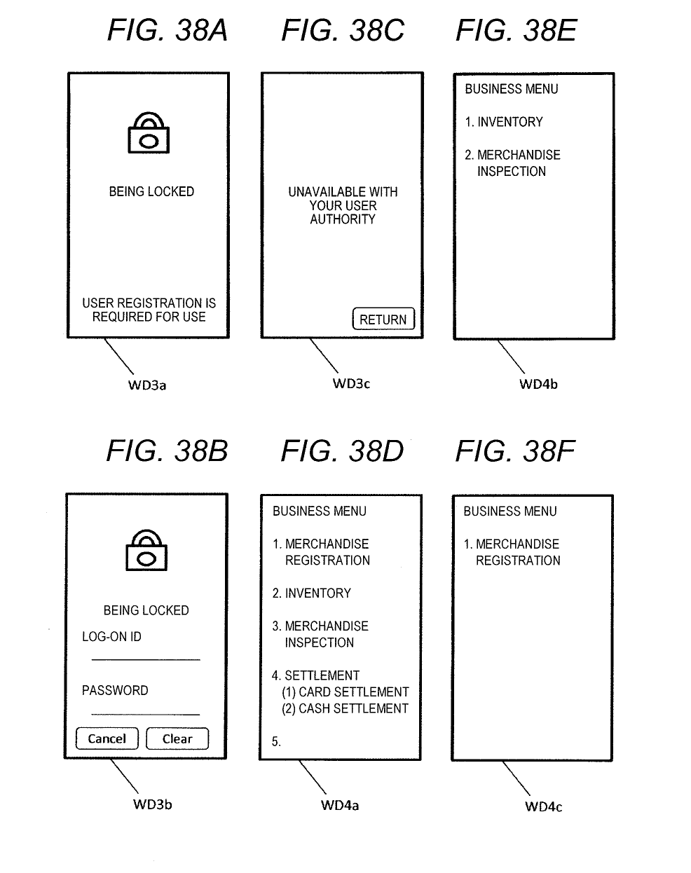

FIG. 38A is a diagram showing a first example of a screen showing a state in which the use of transaction equipment 100 is locked. FIG. 38B is a diagram showing a second example of the screen showing the state in which the use of transaction equipment 100 is locked. FIG. 38C is a diagram showing a third example of the screen showing the state in which the use of transaction equipment 100 is locked. FIG. 38D is a diagram showing an example of a business menu screen when the user logs on with the authority of the salesperson. FIG. 38E is a diagram showing an example of a business menu screen when the user logs on with the authority of the temporary salesperson. FIG. 38F is a diagram showing an example of a business menu screen when the user logs on with the authority of the part-time salesperson.

If screen WD3a or screen WD3c shown in FIG. 38A or 38C is displayed, since transaction equipment 100 is locked, the user is not able to use transaction equipment 100 (see, for example, step S124 of FIG. 32 or 34, step S144 of FIG. 36, or step S152 of FIG. 37). In this case, for example, if a user (for example, the temporary salesperson) wants to use transaction equipment 100, a user (for example, the store manager) with the specific authority needs to unlock the locked state of the transaction equipment by attaching the transaction equipment to the docking device shown in FIG. 36 or 37, and the store manager needs to newly register the user information of the temporary salesperson.

If screen WD3b shown in FIG. 38B is displayed, since transaction equipment 100 is locked, the user is not able to use transaction equipment 100 (see, for example, step S124 of FIG. 32 or 34, step S144 of FIG. 36, or step S152 of FIG. 37). In this case, if a user (for example, the temporary salesperson) wants to use transaction equipment 100, a user (for example, the store manager) with the specific authority needs to unlock the transaction equipment by inputting the log-on ID and password, and the store manager needs to newly register the user information of the temporary salesperson.

In a case where the user (for example, the store manager) with the specific authority logs on or a case where the equipment number of transaction equipment 100 is correlated with the user (for example, the store manager) with the specific authority, screen WD4a shown in FIG. 38D is displayed on touch panel TP2 (see, for example, step S123 of FIG. 32 or 34, or step S145 of FIG. 36 or 37). This screen may be displayed on touch panel TP1. Since a list of business menus related to all the businesses is displayed on screen WD4a, the user (for example, the store manager) of transaction equipment 100 can perform all the operations for the applications corresponding to the business menus related to all the businesses.

In a case where the temporary salesperson who conducts the merchandise check as the main responsible business logs on or a case where the equipment number of transaction equipment 100 is correlated with the temporary salesperson with only the authority of the merchandise check, screen WD4b shown in FIG. 38E is displayed on touch panel TP2 (see, for example, step S124 of FIG. 32 or 34, step S144 of FIG. 36, or step S152 of FIG. 37). This screen may be displayed on touch panel TP1. Since a list of business menus related to the merchandise inventory and merchandise inspection businesses is displayed on screen WD4b, the user (for example, the temporary salesperson) of transaction equipment 100 can perform only the operations for the merchandise inventory application and the merchandise inspection application.

In a case where the part-time salesperson who conducts the merchandise registration (that is, the checkout counter) as the main responsible business logs on or a case where the equipment number of transaction equipment 100 is correlated to the part-time salesperson with only the authority of the merchandise registration, screen WD4c shown in FIG. 38F is displayed on touch panel TP2 (see, for example, step S124 of FIG. 32 or 34, step S144 of FIG. 36, or step S152 of FIG. 37). This screen may be displayed on touch panel TP1. Since a list of business menus related to the merchandise registration business is displayed on screen WD4c, the user (for example, the part-time salesperson) of transaction equipment 100 can perform only the operation for the merchandise registration application.

FIG. 39A is a diagram showing a first example of a screen at the time of the registration of the user information. FIG. 39B is a diagram showing a second example of the screen at the time of the registration of the user information. FIG. 39C is a diagram showing another example of the operation screen of the merchandise registration application. FIG. 39D is a diagram showing an example of the operation screen of the merchandise inventory application.

In a case where the user (for example, the store manager) with the specific authority registers the user information, screen WD5a shown in FIG. 39A is displayed on touch panel TP2 (see, for example, step S1 of FIG. 9). If the log-on ID (that is, the user ID), the user name (that is, the name of the user), the managerial position of the corresponding user, and the authority corresponding to the managerial position are input and selected and an OK button is pushed, the registration of the user information is completed.

In a case where the user logs on to transaction equipment 100, screen WD5b shown in FIG. 39B is displayed on touch panel TP2 (see, for example, step S113 of FIG. 31B). If the log-on ID and password are input and the OK button is pushed, in a case where the log-on ID and password match, second CPU 31 permits the log-on of the user to transaction equipment 100.

On operation screen WD6 shown in FIG. 39C, an example of the screen when the merchandise registration application (specifically, the description is completed with reference to FIG. 8) is operated is displayed on touch panel TP2. If a barcode assigned to the merchandise delivered to the checkout counter is read by barcode reader 800 of the peripheral equipment, the read result (that is, “1234567890128”) of barcode reader 800, the merchandise name, and the price are displayed on touch panel TP2 so as to be browsed.

On operation screen WD7 shown in FIG. 39D, an example of the screen when the inventory application is operated is displayed on touch panel TP2. If a barcode assigned to a shelf of the corresponding merchandise within the store is read by barcode reader 800 of the peripheral equipment, the read result (that is, “1234567890128”) of barcode reader 800, the merchandise name, and the quantity are displayed on touch panel TP2 so as to be browsed. The salesperson determines whether or not the quantity of merchandises on the shelf which is calculated with salesperson′ eyes matches with the quantity displayed on touch panel TP2. If the quantities match with each other, a confirmation button on operation screen WD7 of the inventory application is pushed.

As stated above, in transaction processing system 1000 of the present exemplary embodiment, after the authentication between the transaction equipment and docking device 200 fails through the detachment of transaction equipment 100 from docking device 200, in a case where the user (for example, the store manager) with the specific authority does not log on to transaction equipment 100, transaction equipment 100 is set in the operation restriction state in which the operation for the specific application of the settlement application and the business application is restricted.

Thus, even when transaction equipment 100 as the single equipment uses at least one process of the merchandise registration application and the settlement application in a state where the transaction equipment is detached from docking device 200 to which at least one peripheral equipment is connected, it is possible to prepare a security countermeasure for the unauthorized operation with a simple operation without requiring a complicated setting operation if the specific user does not log on. In a case where portable transaction equipment 100 is operated while being detached from docking device 200, the business that uses information having high security such as personal information can be accessed by a specific restricted person, and persons who can access the business that uses information having low security are not unnecessarily restricted. Thus, it is possible to guarantee the continuity of the business in the store while ensuring the security, and thus, it is possible to prevent the convenience of the salesperson who conducts the business in the store from being degraded.

After the authentication between transaction equipment 100 and docking device 200 fails through the detachment of transaction equipment 100 from docking device 200, in a case where the user (for example, the store manager) with the specific authority logs on to transaction equipment 100, the transaction equipment is set in the operation permission state in which the operations for all the settlement application and the business application are permitted. Thus, for example, in a case where the user (for example, the store manager who is the business responsible person in the store) with the specific authority logs on, since transaction equipment 100 is set in the state in which the operations for all the applications are permitted, it is possible to smoothly perform the business in the store without delay in a case where troubles occur during the typical business. For example, since an increase in waiting time necessary for the customer to purchase the merchandise is relieved, an increase in sales in the store is expected, and thus, a rise in fee incomes of the acquirer or issuer can be similarly expected.

After the authentication between transaction equipment 100 and docking device 200 fails due to the detachment of transaction equipment 100 from docking device 200, in a case where the user information of the user (for example, the store manager) with the specific authority is not registered in transaction equipment 100, the transaction equipment is set in the operation restriction state in which the operation for the specific application of the settlement application and the business application is restricted.

Thus, even when transaction equipment 100 as the single equipment uses at least one process of the merchandise registration application and the settlement application in a state in which the transaction equipment is detached from docking device 200 to which at least one peripheral equipment is connected, it is possible to prepare a security countermeasure for the unauthorized operation with a simple operation without requiring a complicated setting operation if the specific user is not registered in transaction equipment 100. In a case where portable transaction equipment 100 is operated while being detached from docking device 200, the business that uses information having high security such as personal information can be accessed by a specific restricted person, and persons who can access the business that uses information having low security are not unnecessarily restricted. Thus, it is possible to guarantee the continuity of the business in the store while ensuring the security, and thus, it is possible to prevent the convenience of the salesperson who conducts the business in the store from being degraded.

After the authentication between transaction equipment 100 and docking device 200 fails due to the detachment of transaction equipment 100 from docking device 200, in a case where the user information of the user (for example, the store manager) with the specific authority is registered in transaction equipment 100, the transaction equipment is set in the operation permission state in which the operations for all the specific application of the settlement application and the business application are permitted. Thus, for example, in a case where the user information of the user (for example, the store manager who is the business responsible person in the store) with the specific authority is registered in transaction equipment 100, since transaction equipment 100 is set in the state in which the operations for all the applications are permitted, it is possible to smoothly perform the business in the store without delay in a case where troubles occur during the typical business. For example, since an increase in waiting time necessary for the customer to purchase the merchandise is relieved, an increase in sales in the store is expected, and thus, a rise in fee incomes of the acquirer or issuer can be similarly expected.

After the transaction equipment is set in the operation restriction state in which the operation for the specific application of the settlement application and the business application is restricted as the result in which the authentication between transaction equipment 100 and docking device 200 fails through the detachment of transaction equipment 100 from docking device 200, in a case where transaction equipment 100 is attached to the specific docking device connected to the specific peripheral equipment, the transaction equipment is set in the operation permission state in which the operations for all the settlement application and the business application are permitted from the operation restriction state.

Thus, for example, even after the operation for the specific application is restricted, in a case where the transaction equipment is attached to the specific docking device (for example, docking device 200) connected to the specific peripheral equipment, transaction equipment 100 is set in the state in which the operations for all the applications are permitted even in a state in which the user (for example, the store manager) with the specific authority does not log on. Accordingly, it is possible to prevent the unauthorized operation of the salesperson from being caused due to the physical deterrent effect through the attachment of the transaction equipment to stationary type docking device 200 and the conspicuous psychological deterrent effect, and thus, it is possible to smoothly perform the business of the store without delay by using transaction equipment 100 even in a case where troubles occur during the typical business. For example, since an increase in waiting time necessary for the customer to purchase the merchandise is relieved, an increase in sales in the store is expected, and thus, a rise in fee incomes of the acquirer or issuer can be similarly expected.

After the transaction equipment is set in the operation restriction state in which the operation for the specific application of the settlement application and the business application is restricted as the result in which the authentication between transaction equipment 100 and docking device 200 fails through the detachment of transaction equipment 100 from docking device 200, even in a case where transaction equipment 100 is attached to the specific docking device connected to the specific peripheral equipment, the transaction equipment maintains the setting of the operation restriction state. Accordingly, in a case where the user (for example, the store manager who is the business responsible person in the store) with the specific authority is not present, the use of the specific application (for example, the application using information having high security) is restricted, and thus, transaction equipment 100 can prevent the unauthorized operation of the salesperson from being caused due to the reduction in the physical deterrent effect through the detachment of the transaction equipment from stationary type docking device 200 and the reduction in the conspicuous psychological deterrent effect.

After the transaction equipment is set in the operation restriction state in which the operation for the specific application of the settlement application and the business application is restricted as the result in which the authentication between transaction equipment 100 and docking device 200 fails through the detachment of transaction equipment 100 from docking device 200, in a case where transaction equipment 100 is attached to most recently attached docking device 200, the transaction equipment is set in the operation permission state in which the operations for all the settlement application and the business application are permitted from the operation restriction state.

Thus, for example, even after the operation for the specific application is restricted, in a case where transaction equipment 100 is attached to most recently attached docking device 200, the operations for all the applications are permitted even in a state in which the user (for example, the store manager) with the specific authority does not log on. Thus, it is possible to prevent the unauthorized operation of the salesperson from being caused due to the physical deterrent effect through the attachment of the transaction equipment to stationary type docking device 200 and the conspicuous psychological deterrent effect, and thus, it is possible to smoothly perform the business of the store without delay by using transaction equipment 100 even in a case where troubles occur during the typical business. For example, since an increase in waiting time necessary for the customer to purchase the merchandise is relieved, an increase in sales in the store is expected, and thus, a rise in fee incomes of the acquirer or issuer can be similarly expected.

After the transaction equipment is set in the operation restriction state in which the operation for the specific application of the settlement application and the business application is restricted as the result in which the authentication between transaction equipment 100 and docking device 200 fails through the detachment of transaction equipment 100 from docking device 200, even in a case where transaction equipment 100 is attached to most recently attached docking device 200, the transaction equipment maintains the setting of the operation restriction state. Accordingly, in a case where the user (for example, the store manager who is the business responsible person in the store) with the specific authority is not present, the use of the specific application (for example, the application using information having high security) is restricted, and thus, transaction equipment 100 can prevent the unauthorized operation of the salesperson from being caused due to the reduction in the physical deterrent effect through the detachment of the transaction equipment from stationary type docking device 200 and the reduction in the conspicuous psychological deterrent effect.

### Third Exemplary Embodiment

### Connection Form Between Docking Device and Peripheral Equipment

Hereinafter, the connection form between docking device 200 and the peripheral equipment will be described. The connection form between docking device 200 and the peripheral equipment is not limited to the connection form shown in FIG. 1, and various connection forms are considered. Hereinafter, a combination of docking device 200 (cradle) with the peripheral equipment connected to docking device 200 is referred to as a cradle set (CS). The connection form between docking device 200 and the peripheral equipment may be referred to as a connection form of the cradle set, and is determined depending on attributes of the cradle set. The connection form of the cradle set is one of the attributes of the cradle set.

### Function Use Restriction on Cradle Set Depending on Transaction Equipment

For example, the user of transaction equipment 100 includes a store manager, a general staff, and a temporary salesperson who work in the store. In the present exemplary embodiment, whether or not to restrict the function of the cradle set that can be used by transaction equipment 100, that is, whether or not the transaction equipment has the function use restriction is determined depending on transaction equipment 100 used by the user. The cradle set (CS) indicates the combination of docking device 200 (cradle) with the peripheral equipment connected to docking device 200.

Cradle set CSX shown in FIG. 1 includes docking device 200, receipt printer 300, cash drawer 400, external display 500, customer display 550, PINPAD 600, sign pad 650, keyboard 700, mouse 750, and barcode reader 800. Cash drawer 400 of the present exemplary embodiment includes at least one of cash drawer 400A capable of storing a large-denomination cash which is equal to or greater than a first predetermined amount of money, cash drawer 400B capable of storing an intermediate-denomination cash which is equal to or greater than a second predetermined amount of money and is less than the first predetermined amount of money, and cash drawer 400C capable of storing a small-denomination cash which is less than the second predetermined amount of money. The second predetermined amount of money is smaller than the first predetermined amount of money.

Transaction equipment 100 can perform a transaction process in cooperation with cradle set CSX. For example, the transaction process includes processes of cash settlement, card settlement, returned-merchandise reception, delivery reception and merchandise registration. For example, an application related to the transaction process is executed by second CPU 31 and thus, the transaction process is performed.

Whether or not there is the function use restriction of transaction equipment 100 may be fixedly set at the time of the introduction of transaction equipment 100. For example, transaction equipment 100 may associate individual equipment management numbers (terminal IDs) of transaction equipment 100 with whether or not there is the function use restriction of transaction equipment 100 on cradle set CSX, and thus, association information may be retained in transaction equipment 100. Transaction equipment 100 may associate individual user information (for example, user ID) of transaction equipment 100 with whether or not there is the function use restriction of transaction equipment 100 on cradle set CSX, and thus, association information may be retained in transaction equipment 100.

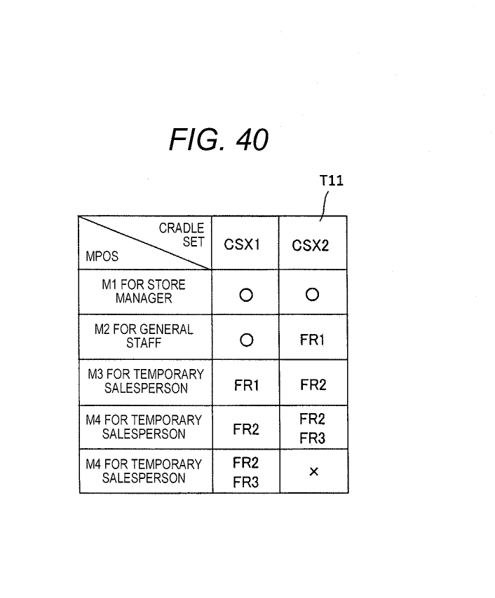

Whether or not there is the function use restriction of transaction equipment 100 may be set at the time of the use of transaction equipment 100. For example, transaction equipment 100 may associate whether or not the user logs on to transaction equipment 100 by using the user ID in order to use transaction equipment 100 with whether or not there is the function use restriction of transaction equipment 100 on cradle set CSX, and thus, association information may be retained in transaction equipment 100. That is, for example, even though the store manager and the temporary salesperson use the same transaction equipment 100, whether or not there is the function use restriction of transaction equipment 100 may be determined depending on whether or not the user logs on. For example, the association information is information retained in function use restriction table T11 shown in FIG. 40. The log-on may be performed through biometric authentication.

FIG. 40 is a schematic diagram showing an example of function use restriction table T11. Function use restriction table T11 retains information regarding the function use restriction of transaction equipment 100 on cradle set CSX for each transaction equipment 100. For example, function use restriction table T11 is retained in second flash ROM 32.

In the function use restriction table, “O” means that the use of all the functions of cradle set CSX is permitted (no use restriction), and “X” means that the use of all the functions of cradle set CSX is prohibited. “FR1” means that the use of a part (Function 1) of the functions of cradle set CSX is restricted, “FR2” means that the use of a part (Function 2) of the functions of cradle set CSX is restricted, and “FR3” means that the use of a part (Function 3) of the functions of cradle set CSX is restricted. The use restrictions of the functions may be combined.

The use restriction on Function 1 is the use restriction on a large-denomination cash settlement function, and restricts an upper limit of the usable amount of money in the cash settlement process or the returned-merchandise reception process. Through the use restriction on Function 1, the use of cash drawer 400A capable of storing the large-denomination cash which is equal to or greater than the first predetermined amount of money is restricted. In this case, the use of cash drawer 400B capable of storing the intermediate-denomination cash and cash drawer 400C capable of storing the small-denomination cash is not restricted. Similarly, the use of another peripheral equipment (for example, receipt printer 300) in the same cradle set is not restricted.

The use restriction on Function 2 is the use restriction on the cash settlement function which is equal to or greater than the intermediate amount of money, and restricts an upper limit of the usable amount of money in the cash settlement process or the returned-merchandise reception process. The use restriction on Function 2 regulates the handling of the cash unlike the use restriction on Function 1. Through the use restriction on Function 2, the use of cash drawer 400A and cash drawer 400B is restricted. In this case, the use of cash drawer 400C is not restricted. Similarly, the use of another peripheral equipment (for example, receipt printer 300) in the same cradle set is not restricted.

For example, through the use restriction on Function 3, the rewriting of information retained in a PLU table is restricted. Through the use restriction on Function 3, the reference of the PLU table is not restricted. Similarly, the use of another peripheral equipment (for example, receipt printer 300) in the same cradle set is not restricted.

In function use restriction table T11, the function use restriction on cradle set CSX is set to five transaction equipments 100. Five transaction equipments 100 are identified by identification information items M1, M2, M3, M4 and M5. One type of cradle set CSX is represented in function use restriction table T11. For example, identification information items M1 to M5 include an individual equipment management number or a manufacturing number of transaction equipment 100, a logical management number set in the store, a user ID, or whether or not the user logs on using the user ID. Identification information items M1 to M5 are retained in second flash ROM 32 of each transaction equipment 100, and are read if necessary.

Two cradle sets CSX are respectively expressed as CSX1 and CSX2. For example, it is assumed that CSX 1 and CSX 2 have the same connection form of the cradle set, but stores where the cradle sets are provided are different or the cradle sets are provided in different positions in the same store.

In transaction equipment M1 for a store manager, the use of all the functions in cradle sets CSX1 and CSX2 is set so as to be permitted. In transaction equipment M2 for a general staff, the use of all the functions in cradle set CSX1 is set so as to be permitted, and the use of Function 1 in cradle set CSX2 is set so as to be restricted. In transaction equipment M3 for a temporary salesperson, the use of Function 1 in cradle set CSX1 is set so as to be restricted, and the use of Function 2 in cradle set CSX2 is set so as to be restricted. In transaction equipment M4 for a temporary salesperson, the use of Function 2 in cradle set CSX1 is set so as to be restricted, and the use of Functions 2 and 3 in cradle set CSX2 is set so as to be restricted. In transaction equipment M5 for a temporary salesperson, the use of Functions 2 and 3 in cradle set CSX1 is set so as to be restricted, and the use of all the functions in cradle set CSX2 is set so as to be prohibited.

As described above, even in cradle sets CSX1 and CSX2 having the same connection form, the function use restriction may be differently set by the user who uses transaction equipment 100.

Transaction equipment 100 may retain only information regarding the function use restriction of own equipment in function use restriction table T11, or may retain the information regarding the function use restriction of another transaction equipment 100. For example, transaction equipment M1 for a store manager may retain only information (information in the first line of function use restriction table T11) regarding the function use restriction related to transaction equipment M1. Transaction equipment M1 for a store manager may retain the information regarding the function use restriction related to transaction equipment M1 and all or a part (information in multiple lines of function use restriction table T11) of information regarding the function use restriction related to transaction equipment M2 for a general staff and transaction equipments M3, M4 and M5 for a temporary salesperson.

Function use restriction table T11 may be retained by transaction equipment 100 until transaction equipment 100 is attached to docking device 200. For example, function use restriction table T11 may be generated by an external server, and may be obtained by transaction equipment 100 via the network. For example, function use restriction table T11 may be generated by setting the function use restriction in second CPU 31 depending on transaction equipment 100, and the generated table may be retained by second flash ROM 32.

Cooperation of Transaction Equipment with Docking Device

Hereinafter, the cooperation of transaction equipment 100 with docking device 200 will be described.

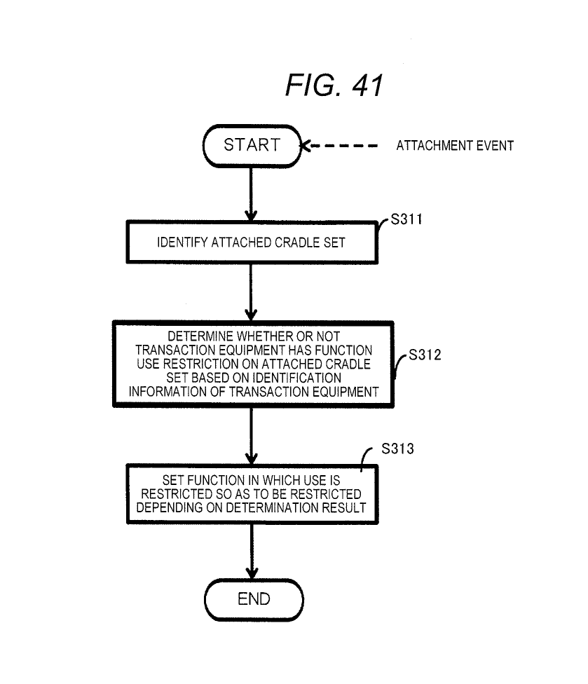

FIG. 41 is a flowchart showing an operation example of transaction equipment 100 when transaction equipment 100 is cooperated with docking device 200.

The process of FIG. 41 is started when docking device 200 detects the physical attachment (attachment event) of transaction equipment 100 to docking device 200. For example, device authentication controller 63 of docking device 200 detects that transaction equipment 100 is attached, and transmits an attachment detection signal to transaction equipment 100 through docking connector C1. Second CPU 31 of transaction equipment 100 obtains the attachment detection signal through docking device I/F 46, generates a software interrupt due to the attachment event, and starts the process of FIG. 41.

Initially, second CPU 31 identifies the cradle set to which transaction equipment 100 is attached (S311).

For example, in S311, second CPU 31 transmits an identification request of the cradle set to docking device 200 through docking device I/F 46 and docking connector C1. In docking device 200, CPU 51 with internal memory transmits an identification response including the identification information of cradle set CSX including docking device 200 to transaction equipment 100 through docking connector C1 and docking device I/F 46. In transaction equipment 100, second CPU 31 obtains the identification response from docking device 200, and identifies the cradle set to which transaction equipment 100 is attached.

The identification information of the cradle set includes, for example, an ID of the cradle set, a store ID where the cradle set is provided, a logical management number within the store, an individual equipment management number of docking device 200 included in cradle set CSX, a logical management number, or a manufacturing number.

In docking device 200, CPU 51 with internal memory detects the classification (any one of cash drawers 400A, 400B and 400C) of cash drawer 400 connected to docking device 200 through peripheral equipment I/F 53. For example, association information of the identification information (for example, individual equipment management number) of cash drawer 400 with the classification of the cash drawer is previously retained in the memory. In this case, CPU 51 with internal memory obtains information regarding the classification of the cash drawer by obtaining the identification information of cash drawer 400. For example, the information regarding the classification of the cash drawer is included in an identification response, and is sent to transaction equipment 100.

Subsequently, second CPU 31 determines whether or not there is the function use restriction on the attached (identified) cradle set by referring to function use restriction table T11 (S312). That is, second CPU 31 determines whether or not there is the function use restriction based on the identification information of transaction equipment 100.

In S312, second CPU 31 obtains the identification information of own equipment from second flash ROM 32. For example, in a case where the identification information of own equipment is M1 and the attached cradle set is CSX1, second CPU 31 determines that the use of all the functions is permitted without restricting the use of all the functions of cradle set CSX1. For example, in a case where the identification information of own equipment is M4 and the attached cradle set is CSX2, second CPU 31 determines that the use of Function 3 of the cradle set is restricted.

Second CPU 31 sets (performs the restriction setting) restriction information for restricting the use of the functions in which the use in the attached cradle set is restricted (S313). For example, the restriction information is retained in second flash ROM 32 of transaction equipment 100.

For example, in a case where the use of Function 1 is restricted, the restriction information is setting information (for example, communication connection flag=“OFF”) for prohibiting transaction equipment 100 from connecting the communication with cash drawer 400A.

For example, in a case where the use of Function 2 is restricted, the restriction information is setting information (for example, communication connection flag=“OFF”) for prohibiting transaction equipment 100 from connecting the communication with cash drawers 400A and 400B.

The communication connection is a logical connection using software. Thus, in a case where the use of Function 1 is restricted, even if cash drawer 400A is connected to docking device 200 through a cable, the communication connection of transaction equipment 100 with cash drawer 400A is prohibited.

For example, in a case where the use of Function 3 is restricted, the restriction information is setting information (for example, a rewrite permission flag=“OFF”) for prohibiting information retained in the PLU table from being written. If the rewrite permission flag is set to be OFF, a data reference process (READ process) on the external server is permitted, and a data update process (WRITE process) is prohibited. For example, the PLU table is stored in the external server connected to the network. The PLU table may be stored in docking device 200 or transaction equipment 100.

In a case where the use of the attached cradle set is permitted (“O” in FIG. 40), the communication connection of the attached cradle set with each peripheral equipment is permitted, and the use of all the functions of the cradle set is not restricted. In a case where the use of the attached cradle set is prohibited (“X” in FIG. 40), the communication connection of the attached cradle set with docking device 200 or each peripheral equipment is prohibited, and the use of all the functions of the cradle set is restricted.

In a case where the use of the cradle set is not prohibited (other than “X” in FIG. 40), the use of the function of the cradle set in which the use is restricted is permitted. For example, in a case where the communication connection is permitted, second CPU 31 sets the communication connection flag to be “ON”, and retains the set flag. For example, in a case where the update of the PLU table is permitted, second CPU 31 sets the rewrite permission flag to be “ON”, and retains the set flag. By setting the rewrite permission flag to be “ON”, the data reference process (READ process) of the PLU flag is permitted, and the data update process (WRITE process) is permitted. That is, the selling price of the merchandise can be updated.

Thus, for example, if transaction equipment 100 for a store manager is attached to cradle set CSX1 and second CPU 31 executes the settlement application or the merchandise registration, application, the use of all the functions of cradle set CSX1 is permitted. In this case, second CPU 31 performs the communication connection with cash drawers 400A, 400B and 400C, and can perform the settlement process using cash drawers 400A, 400B and 400C. In this case, second CPU 31 refers to and updates the PLU table, and can perform the merchandise registration process.

For example, if transaction equipment 100 having identification information M4 for a temporary salesperson is attached to cradle set CSX2 and second CPU 31 executes the settlement application or the merchandise registration application, the use of Function 2 and Function 3 of cradle set CSX2 is restricted. In this case, second CPU 31 prohibits the communication connection with cash drawers 400A and 400B, and is not able to perform the settlement process using cash drawers 400A and 400B. In this case, second CPU 31 can perform the merchandise registration process by referring to the PLU table, and is not able to perform the merchandise registration process by updating the PLU table.

Accordingly, in a case where transaction equipment 100 for a store manager is attached to cradle set CSX1, the user (store manager) can use cash drawers 400A, 400B and 400C. Meanwhile, in a case where transaction equipment 100 for a temporary salesperson is attached to cradle set CSX1, the user (temporary salesperson) restricts the use of cash drawer 400.

As stated above, transaction processing system 1000 can determine whether or not there is the use restriction on the specific function (for example, the settlement process using cash drawer 400A) on the cradle set depending on transaction equipment 100 possessed by the user. Thus, for example, the store manager with relatively high reliability may be permitted so as to handle the large amount of money, and the temporary salesperson having relatively low reliability may be prohibited or restricted so as not to handle cash.

In FIG. 41, an example in which the function use restriction on each cradle set is set to each transaction equipment 100 (user of transaction equipment 100) and it is determined whether or not there is the function use restriction is illustrated. Instead, the function use restriction on the cradle set may be set to each attribute (attribute of the user of the transaction equipment, for example, the transaction equipment for a store manager, a general staff, or a temporary salesperson) of transaction equipment 100, and it may be determined whether or not there is the function use restriction.

Transaction equipment 100 retains restriction information related to the use of the function of the cradle set in S313, and thus, it is possible to prevent data regarding the application from being transmitted to docking device 200 by the application executed by transaction equipment 100. Accordingly, it is possible to reduce unnecessary communication traffic between transaction equipment 100 and docking device 200.

According to transaction processing system 1000 of the present exemplary embodiment, it is possible to determine whether or not there is the function use restriction of transaction equipment 100 on cradle set CSX for each transaction equipment. Thus, in a case where transaction equipment 100 is cooperated with cradle set CSX, it is possible to reduce a decrease in business efficiency in the commercial transaction, and thus, it is possible to improve the safety of the commercial transaction. For example, even though the transaction equipment used by the specific salesperson (for example, the temporary salesperson) is permitted so as to cooperate with the cradle set provided in the store, the function of the cradle set that can be used by the transaction equipment is restricted. Thus, for example, it is possible to reduce a use error occurring in the cradle set due to a lack of knowledge or a lack of experience of the temporary salesperson. Accordingly, transaction processing system 1000 can reduce degradation in the safety in the commercial transaction, and can ensure the benefit of the store. Transaction processing system 1000 can ensure selling fees of the acquirer.

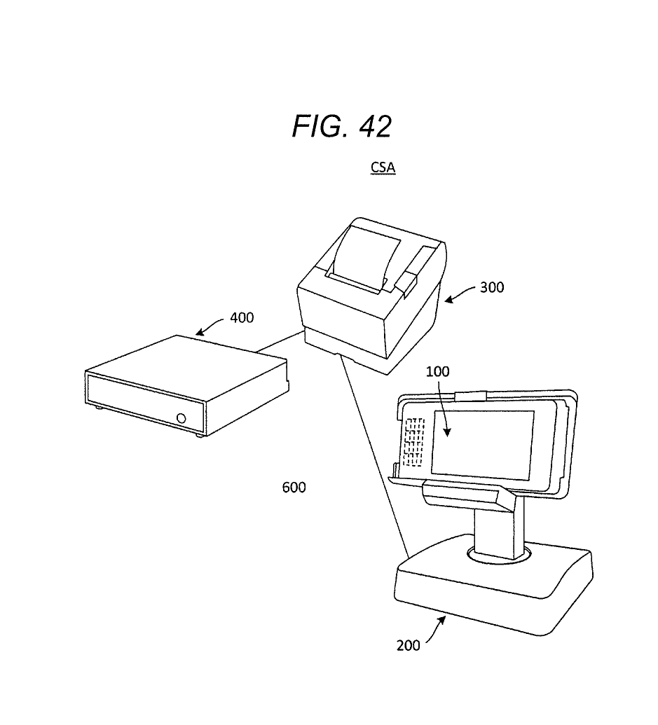

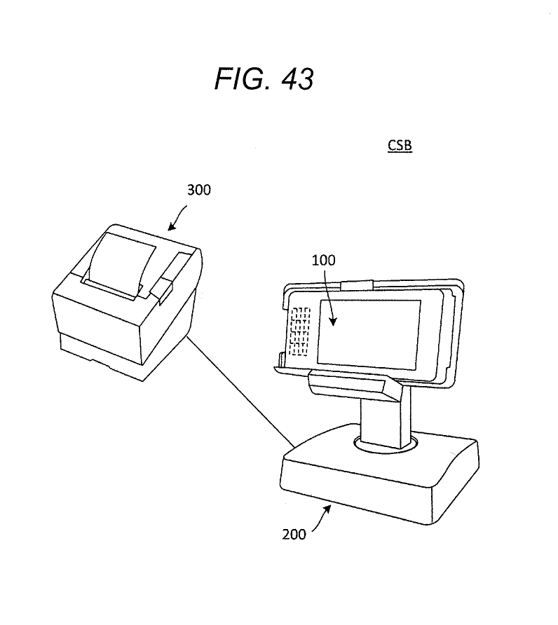

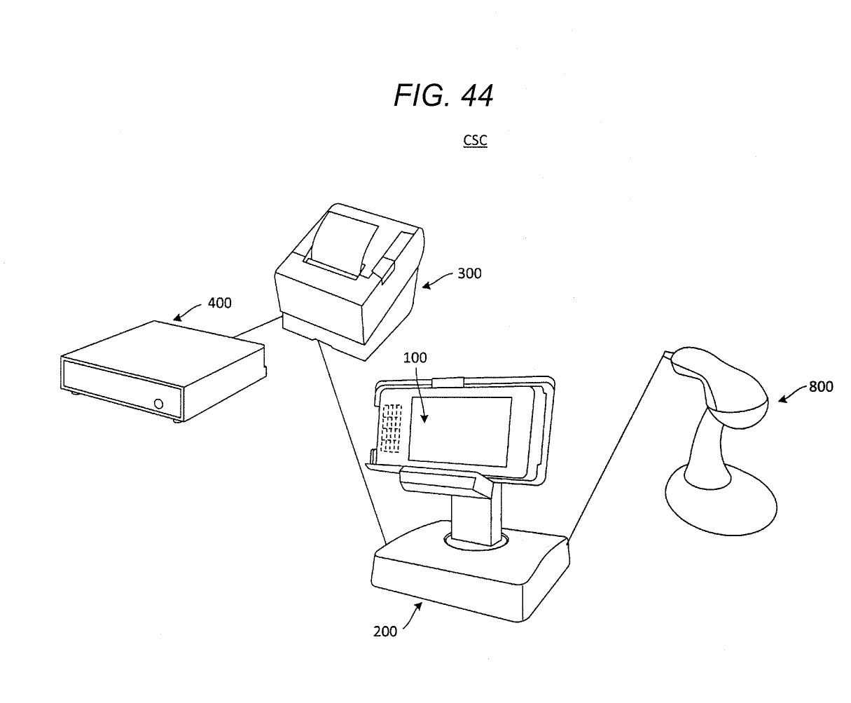

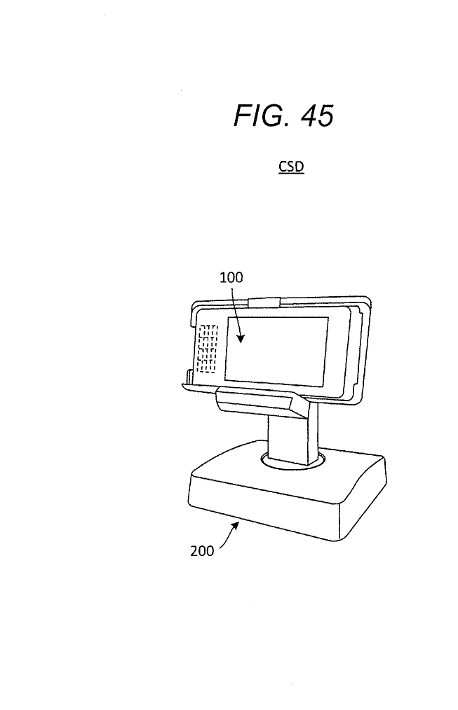

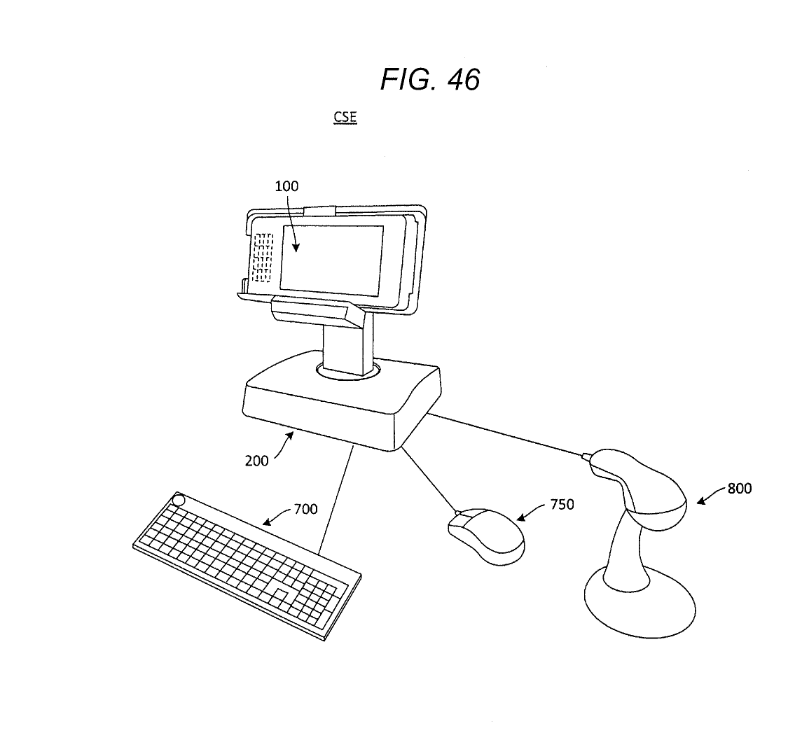

FIG. 42 is a schematic diagram showing the connection form of the cradle set CSA which is provided in, for example, the checkout counter and is capable of performing the cash settlement. FIG. 43 is a schematic diagram showing the connection form of cradle set CSB which is provided in, for example, the checkout counter and is capable of performing the card settlement. FIG. 44 is a schematic diagram showing the connection form of cradle set CSC which is provided in, for example, a service counter and is capable of performing the returned-merchandise acceptance. FIG. 45 is a schematic diagram showing the connection form of cradle set CSD which is provided in, for example, the service counter and is capable of performing the delivery reception. FIG. 46 is a schematic diagram showing the connection form of cradle set CSE which is provided in, for example, the checkout counter and is capable of performing the merchandise registration.

The processes of the cash settlement, the card settlement, the returned-merchandise reception, the delivery reception and the merchandise registration are examples of the transaction process. For example, the transaction process is performed by executing the application related to the transaction process by means of second CPU 31.

In cradle set CSA, at least receipt printer 300 and cash drawer 400 are connected to docking device 200. In cradle set CSA, external display 500 may be further connected to docking device 200.

In cradle set CSB, at least receipt printer 300 is connected to docking device 200. In cradle set CSB, PINPAD 600, sign pad 650 and external display 500 may be connected to docking device 200.

In cradle set CSC, at least barcode reader 800, receipt printer 300 and cash drawer 400 are connected to docking device 200. In cradle set CSC, PINPAD 600, sign pad 650, and external display 500 may be further connected to docking device 200.

The process of the returned-merchandise reception is a process of receiving the returned merchandise in which the merchandise registration process and the settlement process are completed. In the returned-merchandise reception, for example, cradle set CSC identifies a merchandise to be returned using barcode reader 800, cancels the merchandise registration and settlement, refunds the cash related to the settlement cancel using cash drawer 400, and outputs a receipt for proving that a returned-merchandise reception process is conducted using receipt printer 300.

Cash drawers 400 of cradle sets CSA and CSC include cash drawer 400A capable of storing the large amount of money or cash drawer 400B capable of storing the small amount of money.

In cradle set CSD, the peripheral equipment is not connected to docking device 200. This is because a delivery reception slip output in another system is used as a delivery slip in many cases. In cradle set CSD, receipt printer 300, external display 500, keyboard 700 and mouse 750 may be connected to docking device 200. This is because the delivery reception slip may be output by cradle set CSD.

In cradle set CSE, for example, keyboard 700, mouse 750, and barcode reader 800 are connected to docking device 200.

The connection form of the cradle set is determined before the cradle set is provided in the checkout or service counter. The device included in cradle sets CSA to CSE described above is an example, and another device may be connected to docking device 200. At least two of the cradle sets may be combined.

Communication Connection Authority of Transaction Equipment with Cradle Set

The user of transaction equipment 100 includes, for example, a store manager, a general staff, and a temporary salesperson who work in the store. In the present exemplary embodiment, the peripheral equipment capable that can perform the communication connection with transaction equipment 100, that is, the communication connection authority is classified according to transaction equipment 100 used by the user.

The communication connection authority of transaction equipment 100 may be fixedly set at the time of the introduction of transaction equipment 100. For example, transaction equipment 100 may associate the individual equipment management number (terminal ID) of transaction equipment 100 with the communication connection authority of transaction equipment 100 with the cradle set, and the association information may be retained in transaction equipment 100. Transaction equipment 100 may associate the user information (for example, the user ID) of transaction equipment 100 with the communication connection authority of transaction equipment 100 with the cradle set, and the association information may be retained in transaction equipment 100.

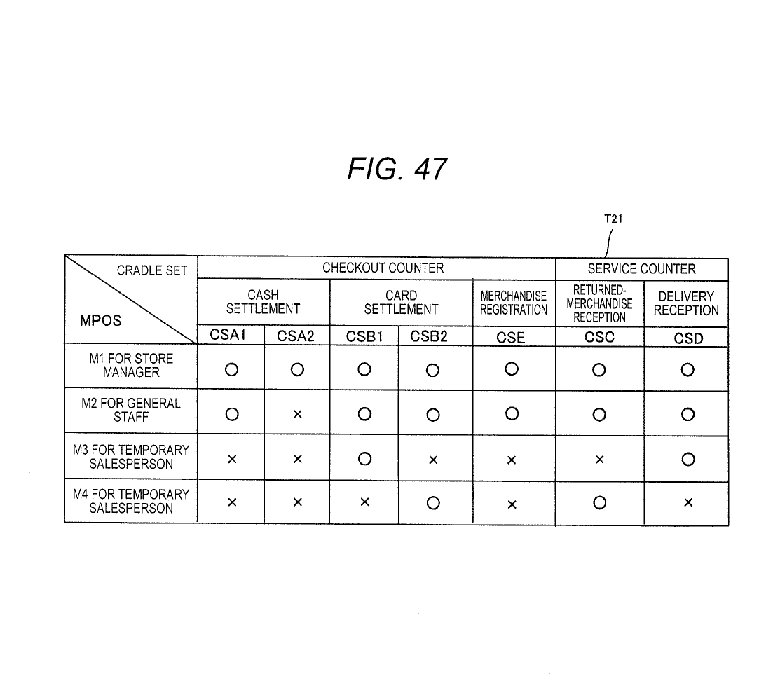

The communication connection authority of transaction equipment 100 may be set at the time of the use of transaction equipment 100. For example, transaction equipment 100 may associate whether or not the user logs on to transaction equipment 100 for using transaction equipment 100 using the user ID with the communication connection authority of transaction equipment 100 with the cradle set, and the association information may be retained in transaction equipment 100. That is, for example, in a case where the store manager and the temporary salesperson use same transaction equipment 100, the communication connection authority of transaction equipment 100 may be determined depending on whether or not the user logs on. For example, the association information is information retained in communication connection authority table T21 shown in FIG. 47. The log-on may be performed through biometric authentication.

FIG. 47 is a schematic diagram showing an example of communication connection authority table T21. Communication connection authority table T21 retains information regarding the communication connection authority of transaction equipment 100 with the cradle set for each transaction equipment 100. For example, communication connection authority table T21 is retained in second flash ROM 32. In FIG. 47, “O” means that the communication connection is set to be permitted, and “X” means that the communication connection is set to be prohibited.

In communication connection authority table T21, the communication connection authority with each cradle set is set four transaction equipments 100. Four transaction equipments 100 are identified by identification information items M1, M2, M3 and M4. In communication connection authority table T21, five types of cradle sets CSA, CSB, CSC, CSD and CSE are represented. For example, identification information items M1 to M4 include an individual equipment management number or a manufacturing number of transaction equipment 100, a logical management number set in the store, the user ID, or whether or not the user logs on using the user ID. Identification information items M1 to M4 are retained in second flash ROM 32 of each transaction equipment 100, and are read if necessary.

Two cradle sets CSA are respectively expressed as CSA1 and CSA2. Two cradle sets CSB are respectively expressed as CSB1 and CSB2. It is assumed that cradle sets CSA1 and CSA2, and cradle sets CSB1 and CSB2 have the same connection form of the cradle set, but the cradle sets are provided in different stores or are provided in different positions in the same store.

In transaction equipment M1 for a store manager, the communication connection with all cradle sets CSA to CSE is set so as to be permitted. In transaction equipment M2 for a general staff, the communication connection with cradle set CSA2 capable of performing the cash settlement is set so as to be prohibited, and the communication connection with another cradle set CSA2 is set so as to be permitted.

In transaction equipment M3 for a temporary salesperson, the communication connection with cradle sets CSA1 and CSA2 capable of performing the cash settlement, cradle set CSB2 capable of performing a part of the card settlement, cradle sets CSE capable of performing the merchandise registration, and cradle sets CSC capable of performing the returned-merchandise reception is set so as to be prohibited. In transaction equipment M3 for a temporary salesperson, the communication connection with cradle set CSB1 capable of performing the card settlement and cradle sets CSD capable of performing the delivery reception is set so as to be permitted.

In transaction equipment M4 for a temporary salesperson, the communication connection with cradle sets CSA1 and CSA2 capable of performing the cash settlement, cradle set CSB1 capable of performing a part of the card settlement, cradle sets CSE capable of performing the merchandise registration and cradle sets CSD capable of performing the delivery reception is set so as to be prohibited. In transaction equipment M4 for a temporary salesperson, the communication connection with cradle set CSB2 capable of performing a part of the card settlement and cradle sets CSC capable of performing the returned-merchandise reception is set so as to be permitted.

As stated above, even though cradle sets CSA1, CSA2, CSB1 and CSB2 have the same connection form, it is possible to set different communication connection authorities by the user who uses transaction equipment 100.

Transaction equipment 100 may retain only the communication connection authority of own equipment in communication connection authority table T21, or may retain information including information regarding a communication connection authority of another transaction equipment 100. For example, transaction equipment M1 for a store manager may retain only information (information in the first line of communication connection authority table T21) regarding the communication connection authority related to transaction equipment M1. Transaction equipment M1 for a store manager may retain all or a part (information items in multiple lines of communication connection authority table T21) of information items regarding the communication connection authorities related to transaction equipment M2 for a general staff and transaction equipments M3 and M4 for a temporary salesperson together with the information regarding the communication connection authority related to transaction equipment M1.

Communication connection authority table T21 may be retained in transaction equipment 100 until transaction equipment 100 is attached to docking device 200. For example, communication connection authority table T21 may be generated by the external server, and may be obtained by transaction equipment 100 via the network. For example, second CPU 31 may set the communication connection authority depending on transaction equipment 100, and communication connection authority table T21 may be generated and may be retained in second flash ROM 32.

Cooperation of Transaction Equipment with Docking Device

Hereinafter, the cooperation of transaction equipment 100 with docking device 200 will be described.

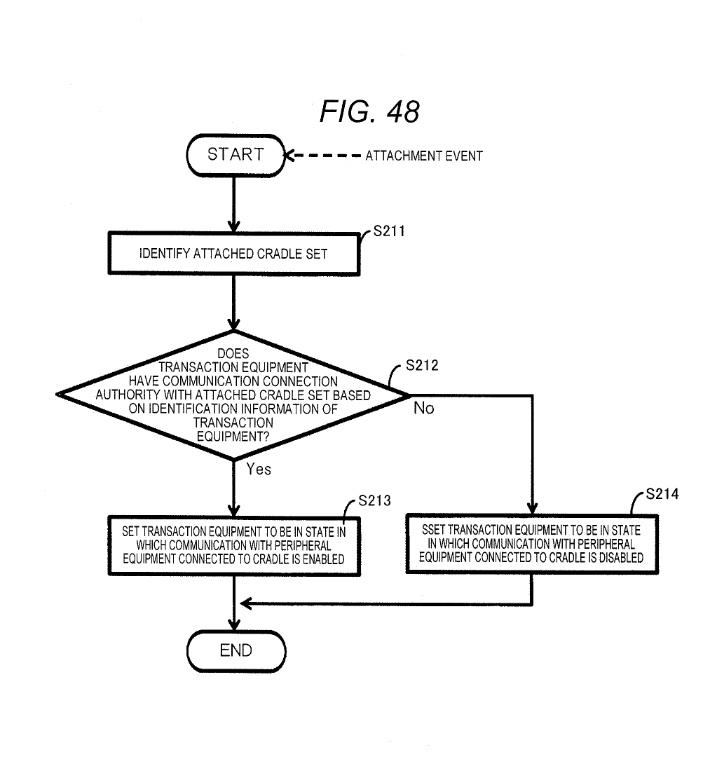

FIG. 48 is a flowchart showing an operation example of transaction equipment 100 when transaction equipment 100 is cooperated with docking device 200.

The process of FIG. 48 is started when docking device 200 detects the physical attachment (attachment event) of transaction equipment 100 to docking device 200. For example, device authentication controller 63 of docking device 200 detects that transaction equipment 100 is attached, and transmits the attachment detection signal to transaction equipment 100 through docking connector C1. Second CPU 31 of transaction equipment 100 obtains the attachment detection signal through docking device I/F 46, generates a software interrupt due to the attachment event, and starts the process of FIG. 48.

Initially, second CPU 31 identifies the cradle set to which transaction equipment 100 is attached (S211). For example, in S211, second CPU 31 transmits an identification request of the cradle set to docking device 200 through docking device I/F 46 and docking connector C1. In docking device 200, peripheral equipment I/F 53 determines whether or not each peripheral equipment is connected to a terminal as a connecting target.

If peripheral equipment I/F 53 detects that receipt printer 300 and cash drawer 400 are connected, CPU 51 with internal memory identifies that the cradle sets including docking device 200 are cradle sets CSA.

If peripheral equipment I/F 53 detects that receipt printer 300 is connected, CPU 51 with internal memory identifies that the cradle sets including docking device 200 are cradle sets CSB.

If peripheral equipment I/F 53 detects that barcode reader 800, receipt printer 300 and cash drawer 400 are connected, CPU 51 with internal memory identifies that the cradle sets including docking device 200 are cradle sets CSC.

If peripheral equipment I/F 53 does not detect that the peripheral equipment is connected, CPU 51 with internal memory identifies that the cradle sets including docking device 200 are cradle sets CSD.

If peripheral equipment I/F 53 detects that keyboard 700, mouse 750 and barcode reader 800 are connected, CPU 51 with internal memory identifies that the cradle sets including docking device 200 are cradle sets CSE.

CPU 51 with internal memory transmits an identification response including the identification result of the cradle set to transaction equipment 100 through docking connector C1 and docking device I/F 46. In transaction equipment 100, second CPU 31 obtains the identification response from docking device 200, and identifies the cradle set to which transaction equipment 100 is attached.

For example, whether the connection form is CSA1 or CSA2 of the same cradle sets CSA is identified based on the management number within the store in a case where the cradle sets are provided in the checkout counters in the same store, or is identified based on the store ID in a case where the cradle sets are provided in the checkout counters in different stores. The identification is performed by second CPU 31.

Subsequently, second CPU 31 determines whether or not the communication connection authority with the attached (identified) cradle set by referring to communication connection authority table T21 (S212). That is, second CPU 31 determines whether or not the transaction equipment has the communication connection authority based on the identification information of transaction equipment 100.

In S212, second CPU 31 obtains the identification information of own equipment from second flash ROM 32. For example, in a case where the identification information of own equipment is M1 and the attached cradle set is CSA1, second CPU 31 determines that the transaction equipment has the communication connection authority with cradle set CSA1. For example, in a case where the identification information of own equipment is M4 and the attached cradle set is CSB1, second CPU 31 determines that the transaction equipment does not have the communication connection authority with cradle set CSB1.

In a case where the transaction equipment has the communication connection authority with the attached cradle set, second CPU 31 sets the transaction equipment to be in a state in which the communication with the peripheral equipment connected to attached docking device 200 is enabled (S213). The communication enable state refers to a state in which transaction equipment 100 and docking device 200 to which transaction equipment 100 is attached are logically connected. For example, in a case where the transaction equipment and the docking device are logically connected, setting information (for example, communication connection flag=“ON”) for allowing transaction equipment 100 to functionally perform communication connection with the peripheral equipment by software is retained in second flash ROM 32 of transaction equipment 100.

For example, in a case where transaction equipment 100 is attached to cradle set CSA1 capable of performing the cash settlement, if second CPU 31 executes the settlement application, transaction equipment 100 and the cradle set cooperate, and the cash settlement can be performed by using the peripheral equipment (for example, cash drawer 400 or receipt printer 300).

In a case where the transaction equipment does not have the communication connection authority with the attached cradle set, second CPU 31 sets the transaction equipment to be in a communication disable state with the peripheral equipment connected to attached docking device 200 (S214). The communication disable state means that transaction equipment 100 and docking device 200 to which transaction equipment 100 is attached are not logically connected. For example, in a case where the transaction equipment and the docking device are not logically connected, setting information (for example, communication connection flag=“OFF”) for allowing transaction equipment 100 to functionally perform the communication connection with the peripheral equipment by software is retained in second flash ROM 32 of transaction equipment 100.

Accordingly, in a case where transaction equipment 100 for a store manager is attached to cradle set CSA1 capable of performing the cash settlement, the user (store manager) can use cash drawer 400. Meanwhile, in a case where transaction equipment 100 for a temporary salesperson is attached to cradle set CSA1 capable of performing the cash settlement, the user (temporary salesperson) is not able to use cash drawer 400.

As mentioned above, transaction processing system 1000 can determine whether the communication connection with the specific peripheral equipment (for example, cash drawer 400) is permitted or prohibited depending on transaction equipment 100 possessed by the user. Thus, for example, the store manager with relatively high reliability may be permitted so as to handle cash, and the temporary salesperson having relatively low reliability may be prohibited so as not to handle cash.

In FIG. 48, an example in which the communication connection authority with each cradle set is set to each transaction equipment 100 (user of transaction equipment 100) and it is determined whether or not the communication connection is permitted is illustrated. Instead, the communication connection authority with each cradle set may be set to each attribute (attribute of the user of the transaction equipment, for example, the transaction equipment for a store manager, a general staff, or a temporary salesperson) of transaction equipment 100, and it is determined whether or not the communication connection is permitted.

By retaining the setting information for allowing transaction equipment 100 to perform the communication connection with the peripheral equipment in S213, it is possible to prevent data regarding the application from being transmitted to docking device 200 by the application executed by transaction equipment 100. Accordingly, it is possible to reduce unnecessary communication traffic between transaction equipment 100 and docking device 200.

According to transaction processing system 1000 of the present exemplary embodiment, it is possible to determine whether or not the communication connection of transaction equipment 100 is permitted for each transaction equipment. Thus, in a case where transaction equipment 100 is cooperated with the peripheral equipment, it is possible to reduce a decrease in business efficiency in the commercial transaction, and thus, it is possible to improve the safety of the commercial transaction. For example, even though the transaction equipment used by the specific salesperson (for example, the temporary salesperson) is permitted so as to cooperate with the peripheral equipment provided in the store, the peripheral equipment that can cooperate by the transaction equipment is restricted. Thus, for example, it is possible to reduce a use error occurring in the peripheral equipment due to a lack of knowledge or a lack of experience of the temporary salesperson. Accordingly, transaction processing system 1000 can reduce degradation in the safety in the commercial transaction, and can ensure the benefit of the store. Transaction processing system 1000 can ensure selling fees of the acquirer.

### Fourth Exemplary Embodiment

In the third exemplary embodiment, it has been described that it is determined whether to not the communication connection with the peripheral equipment connected to docking device 200 to which transaction equipment 100 is connected is permitted depending on identification information of transaction equipment 100. In a fourth exemplary embodiment, it will be described that it is determined whether or not the communication connection of transaction equipment 100 attached to docking device 200 with the peripheral equipment connected to docking device 200 is permitted depending on the attribute of the cradle set including docking device 200.

In the fourth exemplary embodiment, the same configuration and operation as the configuration and operation described in the third exemplary embodiment will be assigned same reference numerals, and thus, the description thereof will be omitted or simplified. For example, the configuration of transaction processing system 1000, the attachment and detachment of transaction equipment 100 to and from docking device 200, the configuration of transaction equipment 100, the configuration of docking device 200, an example of the operation screen of the settlement application, an example of the operation screen of the merchandise registration application, and the connection form of the docking device and the peripheral equipment are the same as those in the third exemplary embodiment, and thus, the description thereof will be omitted.

Communication Connection Authority of Transaction Equipment with Cradle Set Depending on Attribute of Cradle Set

Similarly to the third exemplary embodiment, the cradle set includes, for example, cradle sets CSA, CSB, CSC, CSD and CSE, but is not limited thereto. In the fourth exemplary embodiment, the peripheral equipment capable of performing the communication connection with transaction equipment 100, that is, the communication connection authority is classified according to the attribute (for example, for cash settlement, card settlement, merchandise registration, returned-merchandise reception, or delivery reception) of the cradle set.

If transaction equipment 100 sets the communication connection authority of transaction equipment 100 with the peripheral equipment depending on only the cradle set, the following events occur. For example, if there is not communication connection authority in cradle set CSA, the communication connection with cradle set CSA is prohibited independently from transaction equipment 100, and cradle set CSA is not allowed to perform the communication connection with any of transaction equipment 100. In order to avoid this event, in the fourth exemplary embodiment, the communication connection authority of transaction equipment 100 with the peripheral equipment is set and is determined depending on the identification information of transaction equipment 100 and the attribute of the cradle set.

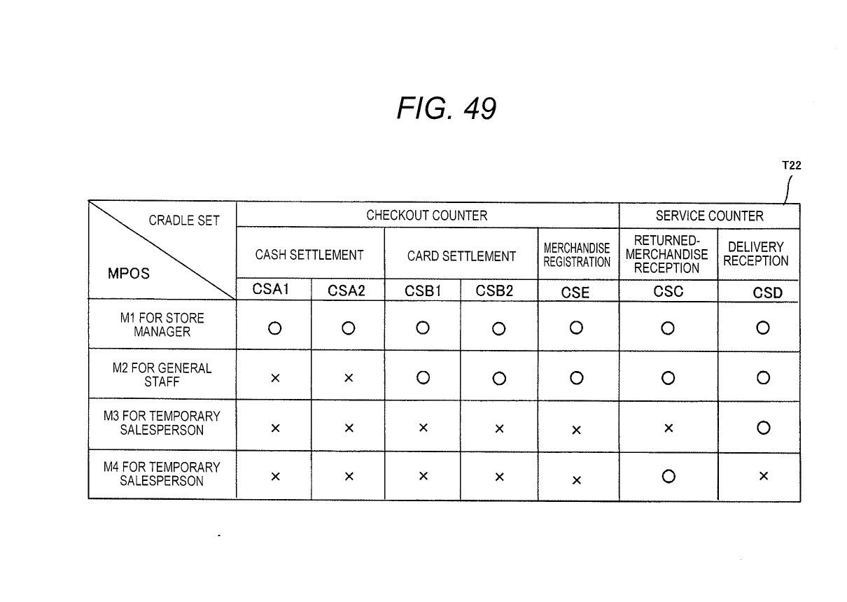

For example, the communication connection authority of transaction equipment 100 is set at the time of the introduction of transaction equipment 100. For example, transaction equipment 100 associates the identification information of transaction equipment 100 with the communication connection authority of transaction equipment 100 with the cradle set to each attribute of the cradle set, and the association information is retained in transaction equipment 100. For example, the association information is information retained in communication connection authority table T22 shown in FIG. 49.

FIG. 49 is a schematic diagram showing an example of communication connection authority table T22. Communication connection authority table T22 retains information regarding the communication connection authority of transaction equipment 100 with the cradle set for each attribute of the cradle set. For example, communication connection authority table T22 is retained in second flash ROM 32.

In communication connection authority table T22, the communication connection authority with each cradle set is set to four transaction equipments 100. Four transaction equipments 100 are respectively identified by identification information items M1, M2, M3 and M4. In communication connection authority table T22, five types of cradle sets CSA, CSB, CSC, CSD and CSE are represented.

Two cradle sets CSA are respectively expressed as CSA1 and CSA2. Two cradle sets CSB are respectively expressed as CSB1 and CSB2. For example, it is assumed that cradle sets CSA1 and CSA2, and cradle sets CSB1 and CSB2 have the same connection form of the cradle set, but are provided in different stores where the cradle sets are provided.

In transaction equipment M1 for a store manager, the communication connection authority with all cradle sets CSA to CSE is set so as to be permitted. In transaction equipment M2 for a general staff, the communication connection with cradle sets CSA1 and CSA2 capable of performing the cash settlement is set so as to be prohibited, and the communication connection with other cradle sets are set so as to be permitted.

In transaction equipment M3 for a temporary salesperson, the communication connection with cradle sets CSA1 and CSA2 capable of performing the cash settlement, cradle sets CSB1 and CSB2 capable of performing the card settlement, cradle sets CSE capable of performing the merchandise registration, and cradle sets CSC capable of the returned-merchandise reception are set so as to be prohibited. In transaction equipment M3 for a temporary salesperson, the communication connection with cradle sets CSD capable of performing the delivery reception is set so as to be permitted.

In transaction equipment M4 for a temporary salesperson, the communication connection with cradle sets CSA1 and CSA2 capable of performing the cash settlement, cradle sets CSB1 and CSB2 capable of performing the card settlement, cradle sets CSE capable of performing the merchandise registration, and cradle sets CSD capable of the delivery reception are set so as to be prohibited. In transaction equipment M4 for a temporary salesperson, the communication connection with cradle sets CSC capable of performing the returned-merchandise reception is set so as to be permitted.

That is, in the fourth exemplary embodiment, since the communication connection authority is set to each attribute of the cradle set, the permission or prohibition of the communication connection authority is similarly set to the same cradle sets without permitting or prohibiting the communication connection authority with only a part of cradle sets CSA. Accordingly, for example, it is possible to set the communication connection authority depending on the importance of handling the peripheral equipment included in the cradle set.

Similarly to the third exemplary embodiment, transaction equipment 100 may retain only information regarding the communication connection authority of own equipment in communication connection authority table T22, or may retain information including information regarding the communication connection authority of another transaction equipment 100. Similarly to the third exemplary embodiment, communication connection authority table T22 may be retained in transaction equipment 100 until transaction equipment 100 is attached to docking device 200.

Cooperation of Transaction Equipment with Docking Device

Hereinafter, the cooperation of transaction equipment 100 with docking device 200 will be described.

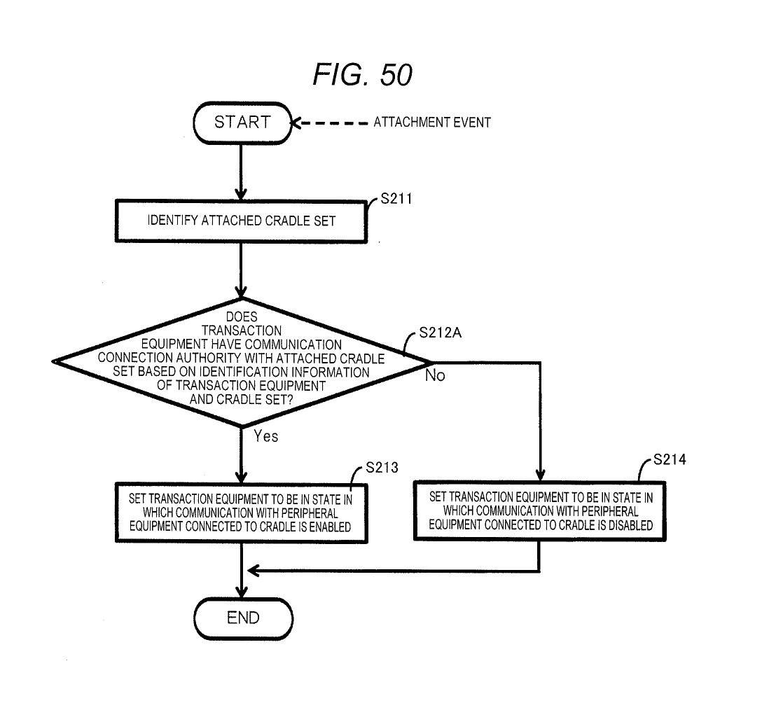

FIG. 50 is a flowchart showing an operation example of transaction equipment 100 when transaction equipment 100 is cooperated with docking device 200. In FIG. 50, the same processes as the processes of FIG. 48 will be assigned the same reference numerals, and the description thereof will be omitted or simplified.

Similarly to the third exemplary embodiment, the processes of FIG. 50 are started when docking device 200 detects the physical attachment (attachment event) of transaction equipment 100 to docking device 200.

Initially, transaction equipment 100 performs the process of S211.

Subsequently, second CPU 31 determines whether or not the transaction equipment has the communication connection authority with the attached (identified) cradle set by referring to communication connection authority table T22 (S212A). That is, second CPU 31 determines whether or not the transaction equipment has the communication connection authority based on the identification information of transaction equipment 100 and the attribute of the cradle set.

In S212A, second CPU 31 obtains the identification information of own equipment from second flash ROM 32. For example, in a case where the identification information of own equipment is M1 and the attached cradle set is CSA1, second CPU 31 determines that the transaction equipment has the communication connection authority with cradle set CSA1. For example, in a case where the identification information of own equipment is M4 and the attached cradle set is CSB1, second CPU 31 determines that the transaction equipment does not have the communication connection authority with cradle set CSB1.

After the process of S211A, transaction equipment 100 performs the processes of S213 and S214.

Accordingly, in a case where transaction equipment 100 for a store manager is attached cradle set CSA (for example, CSA1 or CSA2) capable of performing the cash settlement, the user (store manager) can use cash drawer 400. Meanwhile, in a case where transaction equipment 100 for a temporary salesperson is attached to cradle set CSA (for example, CSA1 or CSA2) capable of performing the cash settlement, the user (temporary salesperson) is not able to use cash drawer 400.

As stated above, transaction processing system 1000 can determine whether the communication connection with the specific peripheral equipment (for example, cash drawer 400) for each transaction equipment 100 is permitted or prohibited depending on the attribute of the peripheral equipment. Thus, for example, cash drawer 400 may be permitted so as to be used by a store manager with relatively high reliability, and the store manager may be permitted so as to handle the cash. Cash drawer 400 may be prohibited so as not to be used by a temporary salesperson with relatively low reliability, and the temporary salesperson may be prohibited so as not to handle cash.

According to transaction processing system 1000 of the present exemplary embodiment, it is possible to determine whether or not the communication connection of transaction equipment 100 for each transaction equipment is permitted depending on the attribute of the cradle set. Thus, in a case where transaction equipment 100 and the cradle set cooperate, it is possible to reduce a decrease in business efficiency in the commercial transaction, and thus, it is possible to improve the safety of the commercial transaction. For example, transaction processing system 1000 can ensure the benefit of the store by reducing an unauthorized use or a handling error of the specific peripheral equipment (for example, cash drawer 400) and reducing degradation in the safety in the commercial transaction. Transaction processing system 1000 can ensure the sales fees of the acquirer.

In the above-described exemplary embodiment, magnetic card reader 43a, contact IC card reader 43b and non-contact IC card reader/writer 43c of transaction equipment 100 may be connected to first CPU 21a in secured area SA.

It has been mainly described in the above-described exemplary embodiment that transaction equipment 100 previously retains communication connection authority tables T21 and T22, but communication connection authority tables T21 and T22 may be stored in an external server, and transaction equipment 100 may obtain the stored tables from the external server before the cooperation is performed. Transaction equipment 100 may transmit the identification information of transaction equipment 100 and the attribute information of the cradle set to the external server while storing communication connection authority tables T21 and T22 in the external server. The external server may determine whether or not the transaction equipment has the communication connection authority by referring to communication connection authority tables T21 and T22, and may transmit the determination result to transaction equipment 100, and the transaction equipment may determine whether or not the communication connection with the peripheral equipment is permitted based on the determination result.

In the above-described exemplary embodiment, transaction equipment 100 may determine whether or not transaction equipment 100 has the communication connection authority with the peripheral equipment depending on the attribute of transaction equipment 100.

In the above-described exemplary embodiment, transaction equipment 100 may determine whether or not transaction equipment 100 has the communication connection authority with the peripheral equipment depending on the attribute of the cradle set. Transaction equipment 100 may determine whether or not transaction equipment 100 has the communication connection authority with the peripheral equipment depending on the on or off state of the power supply of the peripheral equipment included in the cradle set instead of this setting or together with this setting.

In the above-described exemplary embodiment, in a case where transaction equipment 100 has the communication connection authority, transaction equipment 100 may retain setting information for allowing transaction equipment 100 to perform the communication connection with the peripheral equipment. The setting information may be retained in memory 51m of docking device 200, and the communication between transaction equipment 100 and the peripheral equipment may be prohibited in docking device 200.

In the above-described exemplary embodiment, the attribute information (for example, for a store manager, a general staff or a temporary salesperson) of transaction equipment 100 and the identification information (for example, M1 to M4) may be described in communication connection authority table T22, and the table may be hierarchically provided. That is, a mater table and a slave table may be provided. In this case, for example, the master table retains information regarding whether or not the transaction equipment has the communication connection authority with each cradle set corresponding to the attribute information of transaction equipment 100. For example, the slave table retains information regarding the correspondence between the attribute information of transaction equipment 100 and the identification information of the transaction equipment.

As described above, transaction processing system 1000 of the above-described exemplary embodiment includes portable transaction equipment 100, and docking device 200. Docking device 200 can be connected to the peripheral equipment used in the transaction process, and can be attached to and detached from transaction equipment 100. Transaction equipment 100 determines whether or not the communication connection with the peripheral equipment connected to docking device 200 to which transaction equipment 100 is attached is permitted based on the identification information of transaction equipment 100, performs the communication connection with the peripheral equipment in which the communication connection is permitted, and performs the transaction process.

Thus, transaction processing system 1000 can improve the business efficiency by permitting the transaction equipment used by the specific user (for example, the store manager) so as to use the peripheral equipment connected to the docking device to which the transaction equipment is attached. Transaction processing system 1000 can prevent the business efficiency from being decreased by prohibiting the transaction equipment used by the specific user (for example, the temporary salesperson) so as not to use the peripheral equipment connected to the docking device to which the transaction equipment is attached. Accordingly, transaction processing system 1000 can improve the safety at the time of the transaction process in a case where the portable transaction equipment and the peripheral equipment cooperate.

Transaction equipment 100 may determine whether or not the communication connection with the peripheral equipment connected to docking device 200 to which transaction equipment 100 is attached is permitted based on the user attribute of transaction equipment 100.

Thus, by considering the user attribute of the transaction equipment such as the store manager, the general staff, or the temporary salesperson, it is possible to improve the safety by determining whether or not the communication connection is permitted depending on the experience or responsibility of the user and improving the convenience when the transaction equipment and the peripheral equipment cooperate.

Transaction equipment 100 may determine whether or not the communication connection with the peripheral equipment connected to docking device 200 to which transaction equipment 100 is attached is permitted based on the identification information of transaction equipment 100 and the attribute of the cradle set to which transaction equipment 100 is attached. The cradle set indicates the combination of docking device 200 with the peripheral equipment connected to docking device 200.

Thus, transaction processing system 1000 can improve the business efficiency by permitting the specific transaction equipment (for example, the transaction equipment for a store manager) attached to the docking device to which the peripheral equipment is attached so as to use the specific peripheral equipment (for example, the cash drawer). Transaction processing system 1000 can prevent the business efficiency from being decreased by prohibiting the specific transaction equipment (for example, the transaction equipment for a temporary salesperson) attached to the docking device to which the peripheral equipment is attached so as not to use the specific peripheral equipment (for example, the cash drawer). Accordingly, transaction processing system 1000 can improve the safety at the time of the transaction process in a case where the portable transaction equipment and the peripheral equipment cooperate.

Transaction equipment 100 may obtain information which is generated based on the identification information of transaction equipment 100 and is related to whether or not the communication connection for permitting or prohibiting the communication connection with the peripheral equipment connected to docking device 200 is permitted. Transaction equipment 100 may obtain information regarding the attribute of the cradle set to which transaction equipment 100 is attached. Transaction equipment 100 may determine whether or not the communication connection with the peripheral equipment connected to docking device 200 to which transaction equipment 100 is attached is permitted based on the obtained information regarding whether or not the communication connection is permitted and the information regarding the attribute of the cradle set.

Thus, transaction processing system 1000 can easily determine whether or not the communication connection is permitted by referring to the information regarding whether or not the communication connection is permitted, which is previously generated in consideration of the identification information of the transaction equipment.

The information regarding whether or not the communication connection is permitted may be generated based on the attribute information of the cradle set and the identification information of transaction equipment 100.

Thus, transaction processing system 1000 can easily determine whether or not the communication connection is permitted by referring to the information regarding whether or not the communication connection is permitted, which is previously generated in consideration of the identification information of the transaction equipment and the attribute of the cradle set.

Transaction equipment 100 may determine whether or not the communication connection with the peripheral equipment connected to docking device 200 to which transaction equipment 100 is attached is permitted based on the on or off of the power supply of the peripheral equipment connected to docking device 200.

Thus, transaction processing system 1000 can determine whether or not the communication connection is permitted in consideration of whether or not the peripheral equipment is in a state in which the activation is possible. Accordingly, a possibility that the peripheral equipment will be actually used becomes high in a case where it is determined that the communication connection is possible.

Transaction equipment 100 of the above-described exemplary embodiment includes a connector, a determinator, and a transaction processor. The connector is a component for connecting the transaction equipment to the docking device capable of being connected to the peripheral equipment used in the transaction process. The determinator determines whether or not the communication connection with the peripheral equipment connected to docking device 200 connected to the connector is permitted based on the identification information of transaction equipment 100. The transaction processor performs the communication connection with the peripheral equipment in which the communication connection is permitted, and performs the transaction process. The transaction processor is, for example, second CPU 31. The connector is, for example, docking device I/F 46. The determinator is, for example, second CPU 31.

Thus, transaction equipment 100 can improve the business efficiency by permitting the transaction equipment used by the specific user (for example, the store manager) so as to use the peripheral equipment connected to the docking device to which the transaction equipment is attached. Transaction equipment 100 can prevent the business efficiency from being decreased by prohibiting the transaction equipment used by the specific user (for example, the temporary salesperson) so as not to use the peripheral equipment connected to the docking device to which the transaction equipment is attached. Accordingly, transaction equipment 100 can improve the safety at the time of the transaction process in a case where the portable transaction equipment and the peripheral equipment cooperate.

The transaction processing method of the above-described exemplary embodiment is a transaction processing method in transaction equipment 100, and identifies the connection of the transaction equipment to docking device 200 capable of being connected to the peripheral equipment used in the transaction process. It is determined whether or not the communication connection with the peripheral equipment connected to docking device 200 to which transaction equipment 100 is connected is permitted based on the identification information of transaction equipment 100. In a case where the communication connection with the peripheral equipment is permitted, the transaction process is performed using the peripheral equipment in which the communication connection is permitted.

Thus, transaction equipment 100 can improve the business efficiency by permitting the transaction equipment used by the specific user (for example, the store manager) so as to sue the peripheral equipment connected to the docking device to which the transaction equipment is attached. Transaction equipment 100 can prevent the business efficiency from being decreased by prohibiting the transaction equipment used by the specific user (for example, the temporary salesperson) so as not to use the peripheral equipment connected to the docking device to which the transaction equipment is attached. Accordingly, transaction equipment 100 can improve the safety at the time of the transaction process in a case where the portable transaction equipment and the peripheral equipment cooperate.

### Fifth Exemplary Embodiment

It has been assumed in the third exemplary embodiment that one type of cradle set is used. It is assumed in a fifth exemplary embodiment that multiple types of cradle sets are used.

In the present exemplary embodiment, the same configuration and operation as the configuration and operation described in the third exemplary embodiment will be assigned same reference numerals, and thus, the description thereof will be omitted or simplified. For example, the configuration of transaction processing system 1000, the attachment and detachment of transaction equipment 100 to and from docking device 200, the configuration of transaction equipment 100, the configuration of docking device 200, an example of the operation screen of the settlement application, and an example of the operation screen of the merchandise registration application are the same as those in the third exemplary embodiment, and thus, the description thereof will be omitted.

### Attribute of Cradle Set

The attribute of the cradle set will be described. For example, the attribute of the cradle set corresponds to the purpose (for example, for cash settlement, card settlement, merchandise registration, returned-merchandise reception, or delivery reception) of use of the cradle set. The connection form of the cradle set is determined, in other words, the connection form of docking device 200 with the peripheral equipment in the cradle set is determined depending on the attribute of the cradle set. The function capable of being provided by the cradle set is determined depending on the attribute of the cradle set.

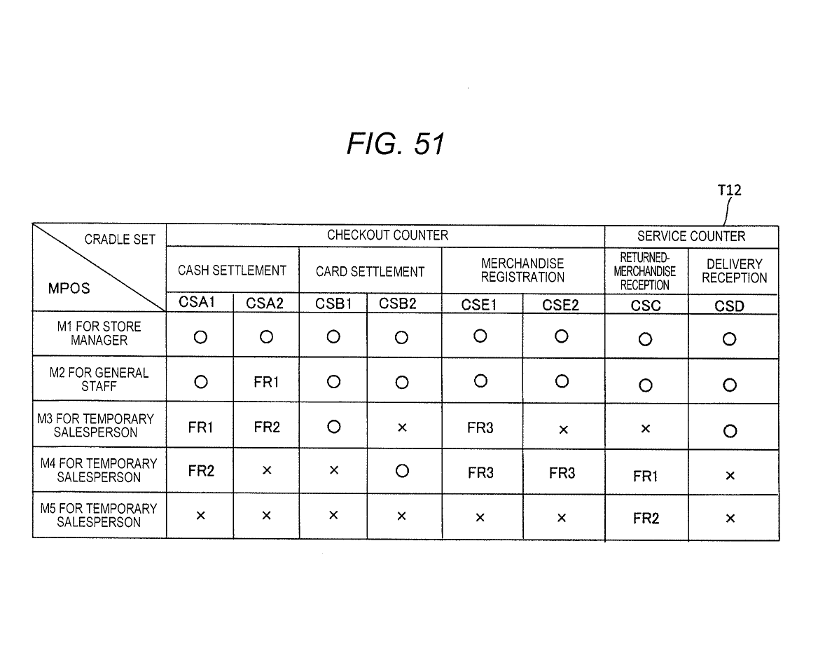

Similarly to the third exemplary embodiment, the function use restriction of transaction equipment 100 may be fixedly set at the time of the introduction of transaction equipment 100, or may be set at the time of the use of transaction equipment 100. The method of retaining the association information is the same as the method in the third exemplary embodiment. The association information of the present exemplary embodiment is retained in, for example, function use restriction table T12 shown in FIG. 51.

FIG. 51 is a schematic diagram showing an example of function use restriction table T12. Function use restriction table T12 retains information regarding the function use restriction of transaction equipment 100 with cradle sets CSA to CSE for each transaction equipment 100. Function use restriction table T12 is retained in, for example, second flash ROM 32.

In function use restriction table T12, the function use restriction on each cradle set is set to five transaction equipments 100. Similarly to the third exemplary embodiment, five transaction equipments 100 are respectively identified by identification information items M1, M2, M3, M4 and M5. In function use restriction table T11, five types of cradle sets CSA, CSB, CSC, CSD and CSE are represented.

Two cradle sets CSA are respectively expressed as CSA1 and CSA2. Two cradle sets CSB are respectively expressed as CSB1 and CSB2. Two cradle sets CSE are respectively expressed as CSE1 and CSE2. For example, it is assumed that cradle sets CSA1 and CSA2, cradle sets CSB1 and CSB2 and cradle sets CSE1 and CSE2 have the same connection form of the cradle set, but are provided in different stores where the cradle sets are provided or are provided in different places in the same store.

In transaction equipment M1 for a store manager, the use of all the functions in all cradle sets CSA1, CSA2, CSB1, CSB2, CSE1, CSE2, CSC and CSD is set so as to be permitted.

In transaction equipment M2 for a general staff, the use of all the functions in all cradle sets CSA1, CSB1, CSB2, CSE1, CSE2, CSC and CSD is set so as to be permitted, and the use of Function 1 in cradle set CSA2 is set so as to be restricted.

In transaction equipment M3 for a temporary salesperson, the use of all the functions in cradle sets CSB1 and CSD is set so as to be permitted, and the use of Function 1 in cradle set CSA1, Function 2 in cradle set CSA2 and Function 3 in cradle set CSE1 is set so as to be restricted, and the use of all the functions in cradle sets CSB2, CSE2 and CSC is set so as to be prohibited.

In transaction equipment M4 for a temporary salesperson, the use of all the functions in cradle set CSB2 is set so as to be permitted, the use of Function 1 in cradle sets CSC, Function 2 in cradle set CSA1 and Function 3 in cradle sets CSE1 and CSE2 is set so as to be restricted, and the use of all the functions in cradle sets CSA2, CSB1 and CSD is set so as to be prohibited.

In transaction equipment M5 for a temporary salesperson, the use of Function 2 in cradle sets CSC is set so as to be restricted, and the use of all the functions in cradle sets CSA1, CSA2, CSB1, CSB2, CSE1, CSE2 and CSD is set so as to be prohibited.

As stated above, even through cradle sets CSA1 and CSA2, cradle sets CSB1 and CSB2, and cradle sets CSE1 and CSE2 have the same connection form, it is possible to set the function use restriction so as to be different by the user who uses transaction equipment 100.

Similarly to the third exemplary embodiment, transaction equipment 100 may retain only information regarding the function use restriction of own equipment in function use restriction table T12, or may retain information including information regarding the function use restriction of another transaction equipment 100.

Function use restriction table T12 may be retained in transaction equipment 100 until transaction equipment 100 is attached to docking device 200. For example, function use restriction table T12 may be generated by an external server, and may be obtained by transaction equipment 100 via the network. For example, second CPU 31 may set the function use restriction depending on transaction equipment 100, and function use restriction table T12 may be generated and may be retained in second flash ROM 32.

Cooperation of Transaction Equipment with Docking Device

Hereinafter, the cooperation of transaction equipment 100 with docking device 200 will be described.

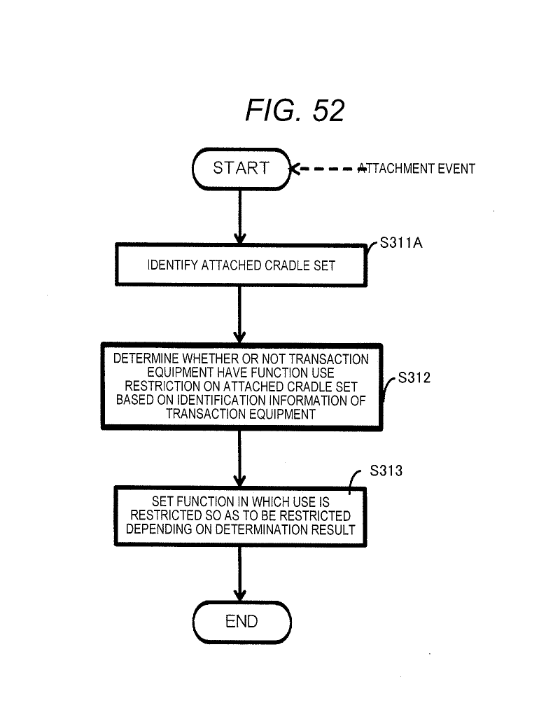

FIG. 52 is a flowchart showing an operation example of transaction equipment 100 when transaction equipment 100 is cooperated with docking device 200. In FIG. 52, the same processes as the processes of FIG. 45 will be assigned the same reference numerals, and thus, the description thereof will be omitted or simplified.

Similarly to the third exemplary embodiment, the processes of FIG. 52 are started when docking device 200 detects the physical attachment (attachment event) of transaction equipment 100 to docking device 200.

Initially, second CPU 31 identifies the cradle set to which transaction equipment 100 is attached (S311A).

For example, in S311A, second CPU 31 transmits an identification request for the cradle set to docking device 200 through docking device I/F 46 and docking connector C1. In docking device 200, peripheral equipment I/F 53 determines whether or not each peripheral equipment is connected to a terminal as a connecting target.

If peripheral equipment I/F 53 detects that receipt printer 300 and cash drawer 400 are connected, CPU 51 with internal memory identifies that the cradle set including docking device 200 is cradle set CSA.

If peripheral equipment I/F 53 detects that receipt printer 300 is connected, CPU 51 with internal memory identifies that the cradle set including docking device 200 is cradle set CSB.

If peripheral equipment I/F 53 detects that barcode reader 800, receipt printer 300 and cash drawer 400 are connected, CPU 51 with internal memory identifies that the cradle set including docking device 200 is cradle set CSC.

In a case where peripheral equipment I/F 53 does not detect the connection with the peripheral equipment, CPU 51 with internal memory identifies that the cradle set including docking device 200 is cradle set CSD.

If peripheral equipment I/F 53 detects that keyboard 700, mouse 750 and barcode 800 are connected, CPU 51 with internal memory identifies that the cradle set including docking device 200 is cradle set CSE.

CPU 51 with internal memory transmits an identification response including the identification result of the cradle set to transaction equipment 100 through docking connector C1 and docking device I/F 46. In transaction equipment 100, second CPU 31 obtains the identification response from docking device 200, and identifies the cradle set to which transaction equipment 100 is attached.

Whether the connecting target is CSA1 or CSA 2 of cradle sets CSA having the same connection form is identified based on the identification information of the cradle set. The same is true of identification of cradle sets CSB1, CSB2, CSE1 and CSE 2. The identification is performed by second CPU 31.

Similarly to the third exemplary embodiment, in docking device 200, CPU 51 with internal memory detects the classification of cash drawer 400 connected to docking device 200 through peripheral equipment I/F 53. Information regarding the classification of the cash drawer is included in, for example, the identification response, and is transmitted to transaction equipment 100.

After the process of S311A, transaction equipment 100 performs the processes of S312 and S313 using function use restriction table T12 instead of function use restriction table T11.

Similarly to the third exemplary embodiment, the function use restriction on cradle sets CSA to CSE may be set to not each transaction equipment 100 (the user of transaction equipment 100) but each attribute of transaction equipment 100, and the function use restriction may be determined.

According to transaction processing system 1000 of the present exemplary embodiment, it is possible to determine whether or the function use restriction of transaction equipment 100 with a plurality of cradle sets CSA to CSE for each transaction equipment. Thus, in a case where transaction equipment 100 and any one of the plurality of cradle sets CSA to CSE cooperate, it is possible to improve the safety of the commercial transaction by reducing a decrease in business efficiency in the commercial transaction. For example, even though the transaction equipment used by the specific salesperson (for example, the temporary salesperson) is permitted so as to cooperate with the cradle set provided in the store, the function of the cradle set capable of being used by transaction equipment is restricted. Thus, for example, it is possible to reduce a use error occurring in the cradle set due to a lack of knowledge or a lack of experience of the temporary salesperson. Accordingly, transaction processing system 1000 can reduce degradation in the safety in the commercial transaction, and can ensure the benefit of the store. Transaction processing system 1000 can ensure selling fees of the acquirer.

### Sixth Exemplary Embodiment

In the third and fifth exemplary embodiments, it has been described that it is determined whether or not there is the function use restriction on the cradle set to which transaction equipment 100 is connected depending on the identification information of transaction equipment 100. In a sixth exemplary embodiment, it will be described that it is determined whether or not transaction equipment 100 attached to the cradle set has the function use restriction on the cradle set depending on the attribute of the cradle set.

In the present exemplary embodiment, the same configuration and operation as the configuration and operation described in the third or fifth exemplary embodiment will be assigned same reference numerals, and thus, the description thereof will be omitted or simplified. For example, the configuration of transaction processing system 1000, the attachment and detachment of transaction equipment 100 to and from docking device 200, the configuration of transaction equipment 100, the configuration of docking device 200, an example of the operation screen of the settlement application, and an example of the operation screen of the merchandise registration application are the same as those in the third exemplary embodiment, and thus, the description thereof will be omitted.

### Function Use Restriction of Transaction Equipment on Cradle Set Depending on Attribute of Cradle Set

Similarly to the fifth exemplary embodiment, the cradle set includes, for example, cradle sets CSA, CSB, CSC, CSD and CSE, and is not limited thereto. In the present exemplary embodiment, whether or not to restrict the function of the cradle set capable of being used by transaction equipment 100, that is, whether or not there is the function use restriction is determined depending on the attribute (for example, for cash settlement, card settlement, merchandise registration, returned-merchandise reception or delivery reception) of the cradle set.

If transaction equipment 100 sets the function use restriction of transaction equipment 100 on the peripheral equipment depending on only the cradle set, the following events occur. For example, if the use of Function 1 is restricted in cradle set CSA, the use of cash drawer 400A of cradle set CSA is prohibited independently from transaction equipment 100, and cash drawer 400A of cradle set CSA is not able to be used by any of transaction equipment 100. In order to avoid such an event, in the present exemplary embodiment, the function use restriction of transaction equipment 100 on the peripheral equipment is set and is determined depending on the identification information of transaction equipment 100 and the attribute of the cradle set.

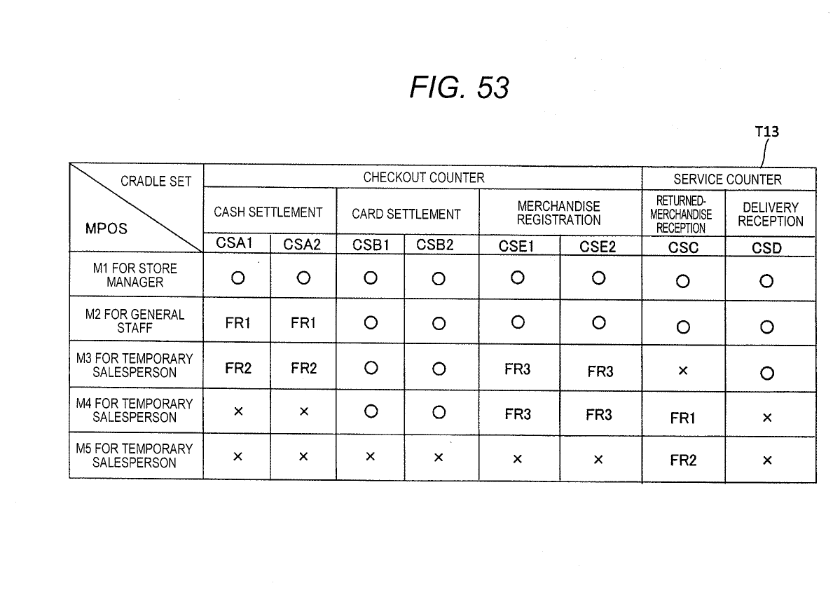

For example, the function use restriction of transaction equipment 100 is set when transaction equipment 100 is introduced or is used. For example, transaction equipment 100 associates the identification information of transaction equipment 100 with the function use restriction of transaction equipment 100 on the cradle set for each attribute of the cradle set, and the association information is retained in transaction equipment 100. For example, the above-described association information is information retained in function use restriction table T13 shown in FIG. 53.

FIG. 53 is a schematic diagram showing an example of function use restriction table T13. Function use restriction table T13 retains information regarding the function use restriction of transaction equipment 100 on the cradle set for each attribute of the cradle set. For example, function use restriction table T13 is retained in second flash ROM 32.

In function use restriction table T13, the same description as that of function use restriction table T12 of the fifth exemplary embodiment will be omitted or simplified.

In transaction equipment M1 for a store manager, the use of all the functions in all cradle sets CSA1, CSA2, CSB1, CSB2, CSE1, CSE2, CSC and CSD is set so as to be permitted.

In transaction equipment M2 for a general staff, the use of all the functions in cradle sets CSB1, CSB2, CSE1, CSE2, CSC and CSD is set so as to be permitted, and the use of Function 1 in cradle sets CSA1 and CSA2 is set so as to be restricted.

In transaction equipment M3 for a temporary salesperson, the use of all the functions in cradle sets CSB1, CSB2 and CSD is set so as to be permitted, the use of Function 2 in cradle sets CSA1 and CSA2 and Function 3 in cradle sets CSE1 and CSE2 is set so as to be restricted, and the use of all the functions in cradle set CSC is set so as to be prohibited.

In transaction equipment M4 for a temporary salesperson, the use of all the functions in cradle sets CSB1 and CSB2 is set so as to be permitted, the use of Function 1 in cradle set CSC and Function 3 in cradle set CSE1 and CSE2 is set so as to be restricted, and the use of all the functions in cradle sets CSA1, CSA2 and CSD is set so as to be prohibited.

In transaction equipment M5 for a temporary salesperson, the use of Function 2 in cradle set CSC is set so as to be restricted, and the use of all the functions in cradle sets CSA1, CSA2, CSB1, CSB2, CSE1, CSE2 and CSD is set so as to be prohibited.

That is, for example, in the present exemplary embodiment, since the function use restriction is set to each attribute of the cradle set, if the cradle sets are the same, the function use restriction is similarly set without restricting the function use restriction on a part of cradle set CSA. Accordingly, for example, it is possible to set the function use restriction depending on the importance of handling the functions of the cradle set.

Similarly to the third and fifth exemplary embodiments, transaction equipment 100 may retain only information regarding the function use restriction of own equipment in function use restriction table T13, or may retain information including information regarding the function use restriction of another transaction equipment 100. Similarly to the third and fifth exemplary embodiments, function use restriction table T13 may be retained in transaction equipment 100 until transaction equipment 100 is attached to docking device 200.

Cooperation of Transaction Equipment with Docking Device

Hereinafter, the cooperation of transaction equipment 100 with docking device 200 will be described.

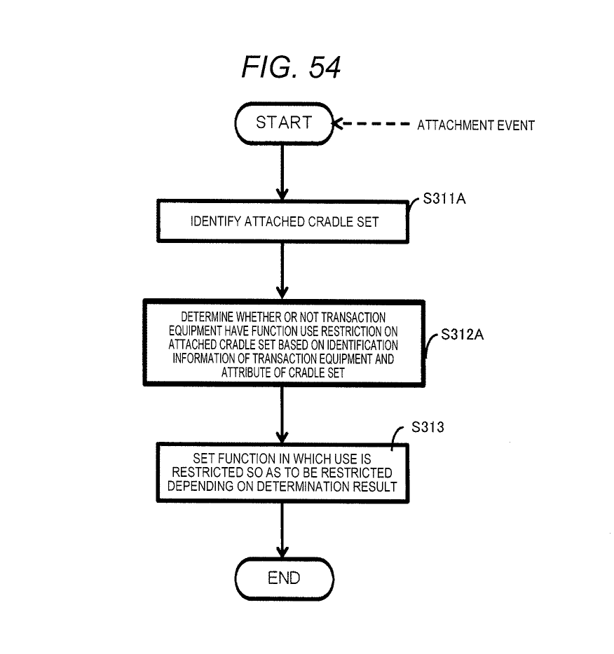

FIG. 54 is a flowchart showing an operation example of transaction equipment 100 when transaction equipment 100 is cooperated with docking device 200. In FIG. 54, the same processes as the processes of FIG. 45 or 52 will be assigned the same reference numerals, and the description thereof will be omitted or simplified.

Similarly to the third and fifth exemplary embodiments, the processes of FIG. 54 are started when docking device 200 detects the physical attachment (attachment event) of transaction equipment 100 to docking device 200.

Initially, transaction equipment 100 performs the process of S311A.

After the process of S311A, second CPU 31 determines whether or not there is the function use restriction on the attached (identified) cradle set by referring to function use restriction table T13 (S312A). That is, second CPU 31 determines whether or not there is the function use restriction based on the identification information of transaction equipment 100 and the attribute of the cradle set.

In S312A, second CPU 31 obtains the identification information of own equipment from second flash ROM 32. For example, in a case where the identification information of own equipment is M1 and the attached cradle set is CSA1, second CPU 31 determines that the transaction equipment does not have the function use restriction on cradle set CSA1. For example, in a case where the identification information of own equipment is M4 and the attached cradle set is CSE1, second CPU 31 determines that Function 3 in cradle set CSE1 is restricted.

After the process of S312A, transaction equipment 100 performs the processes of S313.

Accordingly, in a case where transaction equipment 100 for a store manager is attached to cradle set CSA capable of being performed the cash settlement (for example, CSA1 or CSA2), even though cash drawer 400 of cradle set CSA is any one of cash drawers 400A to 400C, the user (store manager) can use cash drawer 400. In the same case, the user (general staff) of transaction equipment 100 for a general staff can use cash drawers 400B and 400C of cradle set CSA, but is not able to use cash drawer 400A. In the same case, the user (temporary salesperson) of transaction equipment 100 having identification information M3 for a temporary salesperson can use cash drawer 400C of cradle set CSA, but is not able to use cash drawers 400A and 400B. In the same case, the user (temporary salesperson) of transaction equipment 100 having identification information items M4 and M5 for a temporary salesperson is not able to use cash drawer 400 even though cash drawer 400 of cradle set CSA is any one of cash drawers 400A to 400C.

As stated above, transaction processing system 1000 can determine whether or not there is the use restriction on the specific function (for example, a large-denomination cash settlement using cash drawer 400A) of the cradle set or a degree of use restriction for each transaction equipment 100 depending on the attribute of the cradle set. Thus, for example, cash drawer 400A may be permitted so as to be used by the store manager with relatively high reliability, and the store manager may be permitted so as to handle the large-denomination cash. Cash drawer 400 may be restricted or prohibited so as not to be used by a temporary salesperson with relatively low reliability, and the temporary salesperson may be restricted or prohibited so as not to handle cash.

According to transaction processing system 1000 of the present exemplary embodiment, it is possible to determine whether or not transaction equipment 100 has the function use restriction on the cradle set for each transaction equipment depending on the attribute of the cradle set. Thus, in a case where transaction equipment 100 and the cradle set cooperate, it is possible to reduce a decrease in business efficiency in the commercial transaction, and thus, it is possible to improve the safety of the commercial transaction. For example, transaction processing system 1000 can ensure the benefit of the store by reducing an unauthorized use or a handling error of the specific function in the cradle set and reducing degradation in the safety in the commercial transaction. Transaction processing system 1000 can ensure the sales fees of the acquirer.

In the above-described exemplary embodiment, magnetic card reader 43a, contact IC card reader 43b and non-contact IC card reader/writer 43c of transaction equipment 100 may be connected to first CPU 21a in secured area SA.

In the above-described exemplary embodiment, transaction equipment 100 may previously retain function use restriction tables T11 to T13, but function use restriction tables T11 to T13 may be stored in the external server and may be obtained by transaction equipment 100 from the external server before the cooperation is performed. Transaction equipment 100 may transmit the identification information of transaction equipment 100 and the attribute information of the cradle set to the external server while storing function use restriction tables T11 to T13 in the external server. The external server may determine whether or not there is the function use restriction by referring to function use restriction tables T11 to T13, and may transmit the determination result to transaction equipment 100, and the transaction equipment may determine whether or not the use of the function of the cradle set is restricted based on the determination result.

In the above-described exemplary embodiment, transaction equipment 100 may set and determine whether or not transaction equipment 100 has the function use restriction on the cradle set depending on the attribute of transaction equipment 100.

In the above-described exemplary embodiment, transaction equipment 100 may determine whether or not transaction equipment 100 has the function use restriction on the cradle set depending on the attribute of the cradle set. Transaction equipment 100 may determine whether or not transaction equipment 100 has the function use restriction on the cradle set depending on the on or off state of the power supply of the peripheral equipment and docking device 200 included in the cradle set instead of such setting or determination or together with such setting or determination. For example, in a case where the power supply of cash drawer 400A included in the cradle set is turned off, the use of cash drawer 400 may be restricted.

In the above-described embodiment, transaction equipment 100 may set and retain the restriction information. The restriction information is set by docking device 200, and is may be retained in memory 51m of docking device 200, and docking device 200 may restrict the use of the function of transaction equipment 100 on the cradle set.

In the above-described exemplary embodiment, the attribute information (for example, for a store manager, a general staff, or a temporary salesperson) and the identification information (for example, M1 to M5) of transaction equipment 100 may be described in function use restriction table T11 to T13, but each table may be hierarchically provided. That is, a master table and a slave table may be provided. In this case, for example, the master table retains information regarding whether or not there is the function use restriction on each cradle set corresponding to the attribute information of transaction equipment 100. For example, the slave table retains information regarding the correspondence between the attribute information of transaction equipment 100 and the identification information of the transaction equipment.

In the above-described exemplary embodiment, the attribute information (for example, for cash settlement, card settlement, merchandise registration, returned-merchandise reception or delivery reception) and the identification information (for example, CSA1 and CSA2) of the cradle set may be described in function use restriction tables T11 to T13, but each table may be hierarchically provided. That is, a master table and a slave table may be provided. In this case, for example, the master table retains information regarding whether or not there is the function use restriction in the attribute of each cradle set corresponding to the identification information of transaction equipment 100. For example, the slave table retains information regarding the correspondence between the attribute information of the cradle set and the identification information of the cradle set.

In each table, a hierarchy related to transaction equipment 100 and a hierarchy related to the cradle set may be combined.

It has been described in the above-described exemplary embodiment that Function 1 to Function 3 are used as the functions in the cradle set, but other functions may be used, and the use of the other functions may be restricted. The functions may be hierarchically restricted.

As mentioned above, transaction processing system 1000 of the above-described exemplary embodiment includes portable transaction equipment 100, and docking device 200 which is capable of being connected to the peripheral equipment used in the transaction process and is capable of being attached and detached to transaction equipment 100. Transaction equipment 100 determines whether or not there is the use restriction on the function of the cradle set including docking device 200 to which transaction equipment 100 is attached and the peripheral equipment connected to docking device 200 based on the identification information of transaction equipment 100. Transaction equipment 100 performs the transaction process using the function of the cradle set in which the use is not restricted.

Accordingly, the transaction equipment used by the specific user (for example, the store manager) is not restricted to use the function of the cradle set to which the transaction equipment is attached, and thus, transaction processing system 1000 can improve the business efficiency. Transaction processing system 1000 can prevent the business efficiency from being decreased by restricting the transaction equipment used by the specific user (for example, the temporary salesperson) to use the function of the cradle set to which the transaction equipment is attached. Accordingly, transaction processing system 1000 can improve the safety at the time of the transaction process in a case where the portable transaction equipment and the cradle set (the peripheral equipment) cooperate.

Transaction equipment 100 may determine whether or not there is the use restriction on the function of the cradle set to which transaction equipment 100 is attached is permitted based on the user attribute of transaction equipment 100.

Thus, by considering the user attribute of transaction equipment 100 such as the store manager, the general staff, or the temporary salesperson, it is possible to improve the safety by determining whether or not there is the function use restriction depending on the experience or responsibility of the user and improving the convenience when transaction equipment 100 and the cradle set cooperate.

Transaction equipment 100 may determine whether or not there is the use restriction on the function of the cradle set to which transaction equipment 100 is attached based on the identification information of transaction equipment 100 and the attribute of the cradle set.

The use of the cradle set having specific function (for example, a large-denomination settlement or a PLU table update) by the specific transaction equipment (for example, the transaction equipment for a store manager) is not restricted, and thus, transaction processing system 1000 can improve the business efficiency. The use of the cradle set having specific function (for example, a large-denomination settlement or a PLU table update) by the specific transaction equipment (for example, the transaction equipment for a temporary salesperson) can be restricted, and thus, transaction processing system 1000 can prevent the business efficiency from being decreased. Accordingly, transaction processing system 1000 can improve the safety at the time of the transaction process in a case where the portable transaction equipment and the cradle set cooperate.

Transaction equipment 100 may obtain function use restriction information which is generated based on the identification information of transaction equipment 100 and restricts the use of the function of the cradle set, and may obtain attribute information of the cradle set to which transaction equipment 100 is attached. Transaction equipment 100 may determine whether or not there is the use restriction on the function of the cradle set to which transaction equipment 100 is attached based on the attribute information of the cradle set and the obtained function use restriction information.

Accordingly, transaction processing system 1000 can easily determine whether or not there is the function use restriction by referring to the function use restriction information which is previously generated in consideration of the identification information of the transaction equipment.

The function use restriction information may be generated based on the attribute information of the cradle set and the identification information of transaction equipment 100.

Accordingly, transaction processing system 1000 can easily determine whether or not there is the function use restriction by referring to the function use restriction information which is previously generated in consideration of the identification information of transaction equipment 100 and the attribute of the cradle set.

Transaction equipment 100 may determine whether or not there is the use restriction on the function of the cradle set to which transaction equipment 100 is attached based on the on or off of the power supply of docking device 200 to which transaction equipment 100 is attached or the peripheral equipment connected to docking device 200.

Accordingly, transaction processing system 1000 can determine whether or not there is the function use restriction in consideration of whether or not the function of the cradle set is executable. Therefore, in a case where it is determined that the transaction equipment does not have the function use restriction, a possibility that this function will be actually used becomes high.

Transaction equipment 100 of the above-described exemplary embodiment includes a connector, a determinator, and a transaction processor. The connector is a component for connecting the transaction equipment to docking device 200 capable of being connected to the peripheral equipment used in the transaction process. The determinator determines whether or not there is the use restriction on the function of the cradle set including docking device 200 connected to the connector and the peripheral equipment connected to docking device 200 based on the identification information of transaction equipment 100. The transaction processor performs the transaction process using the function of the cradle set in which the use is not restricted. The transaction processor is, for example, second CPU 31. The connector is, for example, docking device I/F 46. The determinator is, for example, second CPU 31.

Accordingly, the use of the function of the cradle set to which the transaction equipment is attached by the transaction equipment used by the specific user (for example, the store manager) is not restricted, and thus, transaction equipment 100 can improve the business efficiency. The use of the function of the cradle set to which the transaction equipment is attached by the transaction equipment used by the specific user (for example, the store manager) can be restricted, and thus, transaction equipment 100 can prevent the business efficiency from being decreased. Accordingly, transaction equipment 100 can improve the safety at the time of the transaction process in a case where the portable transaction equipment and the cradle set (the peripheral equipment) cooperate.

The transaction processing method of the above-described exemplary embodiment is a transaction processing method in transaction equipment 100 that performs the transaction process. In the transaction processing method, the transaction process is performed using the function of the cradle set in which the use is not restricted by identifying the connection of the transaction equipment to docking device 200 capable of being connected to the peripheral equipment used in the transaction process and determining whether or not there is the use restriction on the function of the cradle set including docking device 200 connected to transaction equipment 100 and the peripheral equipment connected to docking device 200 based on the identification information of transaction equipment 100.

Accordingly, the use of the function of the cradle set to which the transaction equipment is attached by the specific user (for example, the store manager) is not restricted, and thus, transaction equipment 100 can improve the business efficiency. The use of the function of the cradle set to which the transaction equipment is attached by the specific user (for example, the temporary salesperson) can be restricted, and thus, transaction equipment 100 can prevent the business efficiency from being decreased. Therefore, transaction equipment 100 can improve the safety at the time of the transaction process in a case where the portable transaction equipment and the cradle set (the peripheral equipment) cooperate.

### Seventh Exemplary Embodiment

In a seventh exemplary embodiment, the same configuration and operation as the configuration and operation described in the previous exemplary embodiment will be assigned same reference numerals, and thus, the description thereof will be omitted or simplified. For example, the configuration of transaction processing system 1000, the attachment and detachment of transaction equipment 100 to and from docking device 200, the configuration of transaction equipment 100, the configuration of docking device 200, an example of the operation screen of the settlement application, an example of the operation screen of the merchandise registration application, and the connection form between the docking device and the peripheral equipment are the same as those in the previous exemplary embodiment, and thus, the description thereof will be omitted.

### Communication Connection Authority Depending on Transaction Equipment

The user of transaction equipment 100 includes, for example, a store manager, a general staff, and a temporary salesperson who work in the store. In the preset exemplary embodiment, the cradle set with which transaction equipment 100 performs the communication connection, that is, the communication connection authority is classified according to the attribute information and the individual equipment identification information of transaction equipment 100 used by the user.

For example, the attribute information of transaction equipment 100 includes information regarding an employment position (for example, a store manager, a general staff, and a temporary salesperson) of the user, information regarding a use situation (for example, checkout counter or service counter) of transaction equipment 100, and information regarding the state of transaction equipment 100. The information regarding the state of transaction equipment 100 includes, for example, information regarding user registration, and information regarding log-on using the registered user information. The information regarding user registration includes, for example, a user ID. The attribute information of transaction equipment 100 does not include the individual equipment identification information of transaction equipment 100.

The communication connection authority of transaction equipment 100 may be fixedly set at the time of the introduction of transaction equipment 100. For example, transaction equipment 100 may associate the attribute information (for example, the user is the store manager or is a person in charge of the checkout counter) of transaction equipment 100 and the individual equipment identification information (a terminal ID) (for example, #00R or #00S) with the communication connection authority of transaction equipment 100 with the cradle set, and the association information may be retained in transaction equipment 100.

The communication connection authority of transaction equipment 100 may be set at the time of the use of transaction equipment 100. For example, transaction equipment 100 may associate whether or not the predetermined user (for example, the store manager) is registered in transaction equipment 100 with the communication connection authority of transaction equipment 100 with the cradle set, and the association information may be retained in transaction equipment 100. For example, transaction equipment 100 may associate whether or not the predetermined user (for example, the store manager) of which information is registered in transaction equipment 100 logs on with the communication connection authority of transaction equipment 100 with the cradle set, and the association information may be retained in transaction equipment 100.

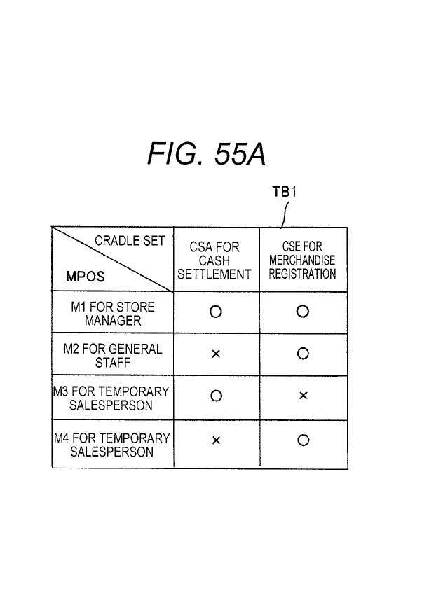

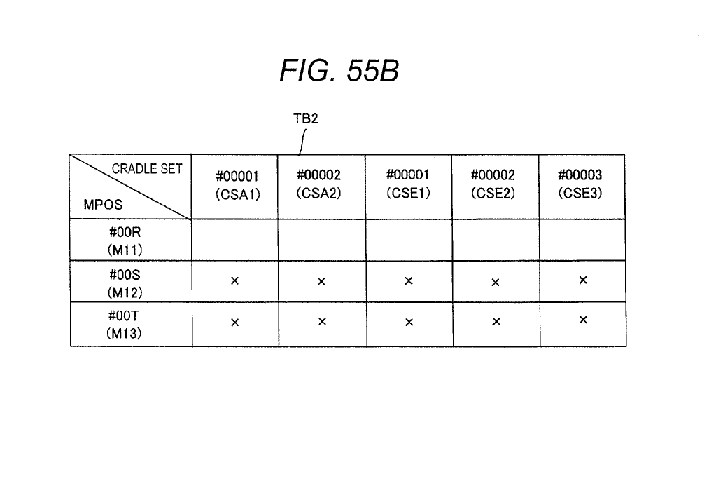

That is, for example, even though the store manager and the temporary salesperson use the same transaction equipment 100, transaction equipment 100 may determine the communication connection authority of transaction equipment 100 depending on whether or not the user is registered or the user logs on. The above-described association information is, for example, information retained in attribute table TB1 and individual equipment table TB2 shown in FIGS. 55A and 55B. The log-on may be performed through biometric authentication.

FIGS. 55A and 55B are schematic diagrams showing examples of attribute table TB1 and individual equipment table TB2.

Attribute table TB1 retains information regarding the communication connection authority of transaction equipment 100 with the cradle set for each attribute information of transaction equipment 100. Attribute table TB1 is retained in, for example, second flash ROM 32. In FIG. 55A, “O” means that the communication connector is set so as to be permitted, and “X” means that the communication connection is set so as to be prohibited. The communication connection authority retained in attribute table TB1 is a default authority.

In attribute table TB1, the communication connection authority for each cradle set is set to four types of transaction equipments 100. Four types of transaction equipments 100 are identified by attribute information items M1, M2, M3 and M4 of the transaction equipment. Attribute information items M1 to M4 are information items for distinguishing between the employment positions. Attribute information items M1 to M4 are retained in second flash ROM 32 of each transaction equipment 100, and are read if necessary. In attribute table TB1, two types of cradle sets CSA and CSE are represented, but information regarding another cradle set and information regarding whether or not the communication connection with another cradle set is permitted may be included.

In FIG. 55A, in transaction equipment 100 for a store manager (M1), the communication connection with cradle sets CSA and CSE is set so as to be permitted. In transaction equipment 100 for a general staff (M2), the communication connection with cradle set CSA capable of performing the cash settlement is set so as to be prohibited, and the communication connection with the cradle set capable of performing the merchandise registration is set so as to be permitted.

In transaction equipment 100 for settlement (M3) of a temporary salesperson, the communication connection with cradle set CSA capable of performing the cash settlement is set so as to be permitted, and the communication connection with the cradle set capable of performing the merchandise registration is set so as to be prohibited. In transaction equipment 100 for checkout counter (for merchandise registration) (M4) of a temporary salesperson, the communication connection with cradle set CSA capable of performing the cash settlement is set so as to be prohibited, and the communication connection with the cradle set capable of performing the merchandise registration is set so as to be permitted.

Individual equipment table TB2 retains information regarding the communication connection authority of transaction equipment 100 with the cradle set for each individual equipment identification information (here, #00R, #00S, or #00T) of transaction equipment 100 having predetermined attribute information (here, information indicating the store manager). Individual equipment table TB2 is retained in, for example, second flash ROM 32.

For example, individual equipment table TB2 is provided for each attribute information of transaction equipment 100. Accordingly, the description of the tables other than individual equipment table TB2 for a store manager is omitted, but individual equipment table TB2 for a store manager, an individual equipment table for a general staff, and an individual equipment table for a temporary salesperson are retained in, for example, second flash ROM 32.

In FIG. 55B, “ ” (blank) means that the communication connection authority is the same as the default authority, that is, the communication connection authority in the same attribute of transaction equipment 100 in attribute table TB1. “O” means that the communication connection is preferentially set so as to be permitted, and “X” means that the communication connection is preferentially set so as to be prohibited.

For example, information regarding the communication connection authority of transaction equipment 100 having individual equipment identification information of #00R with cradle set CSA1 is a blank. In this case, attribute table TB1 is referred to, and the communication connection authority (here, permission setting) of transaction equipment 100 for a store manager with cradle set CSA is adopted.

For example, information regarding the communication connection authority of transaction equipment 100 having individual equipment identification information of #00S with cradle set CSA1 is “X”. In this case, a prohibition setting of individual equipment table TB2 is adopted irrespective of the communication connection authority (here, permission setting) of transaction equipment 100 for a store manager with cradle set CSA in attribute table TB1. That is, the communication connection authority of individual equipment table TB2 is preferred to the communication connection authority of attribute table TB1.

In individual equipment table TB2, the communication connection authority with each cradle set is set to three transaction equipments 100 for a store manager. Three transaction equipments 100 are identified by individual equipment identification information items M11, M12 and M13 of the transaction equipment. Individual equipment identification information items M11 to M13 are, for example, individual equipment management number and a manufacturing number of transaction equipment 100, and a logical management number set in the store. In FIG. 55B, individual equipment identification information M11 is #00R, individual equipment identification information M12 is #00S, and individual equipment identification information M13 is #00T. Identification information items M11 to M13 are retained in second flash ROM 32 of each transaction equipment 100, and are read if necessary. The first half “M1” of individual equipment identification information items M11, M12 and M13 shortly represents that the attribute information is for a store manager.

The transaction equipment for a store manager having individual equipment identification information of #00R is also referred to as “transaction equipment 100R”. The transaction equipment for a store manager having individual equipment identification information of #00S is also referred to as “transaction equipment 100S”. The transaction equipment for a store manager having individual equipment identification information of #00T is also referred to as “transaction equipment 100T”.

In individual equipment table TB2, five cradle sets CSA1, CSA2, CSE1, CSE2 and CSE3 are represented. Cradle sets CSA1 and CSA2 are cradle sets CSA having the same connection form, and cradle sets CSE1 to CSE3 are cradle sets CSE having the same connection form. For example, it is assumed that a case where a plurality of cradle sets having the same connection form means that the cradle sets are provided in different stores or the cradle sets are provided in different places in the same store. In FIG. 55B, information regarding another cradle set and information regarding whether or not the communication connection with another cradle set is permitted may be included.

The first half “CSA” of cradle set CSA1 shortly represents that the attribute information of the cradle set, and the second half “1” shortly represents set identification information.

In FIG. 55B, in transaction equipment 100R, since the communication connection with cradle sets CSA1, CSA2, CSE1, CSE2 and CSE3 is a blank, the default authority is reflected, and is set so as to be permitted. In transaction equipments 100S and 100T, the communication connection with cradle sets CSA1 and CSA2 capable of performing the cash settlement and cradle sets CSE1 to CSE3 capable of performing the merchandise registration is set so as to be prohibited.

As stated above, in transaction equipments 100 having the same attribute, different communication connection authorities with the cradle sets may be set.

Individual equipment table TB2 shown in FIG. 55B represents setting information of the communication connection authority at an arbitrary timing (for example, time t1). The setting information of the communication connection authority of individual equipment table TB2 may be changed when a predetermined trigger (for example, repair of transaction equipment 100, a change of the employment position, and a process by proxy due to user absence) occurs. For example, the repair may be performed in a case where contact failure of an input device of second touch-input detector 34a of transaction equipment 100, or damage of a display device such as internal display 34b occurs. The change of the communication connection authority of individual equipment table TB2 will be described in detail.

Transaction equipment 100 may retain only information regarding the communication connection authority of own equipment in attribute table TB1 and individual equipment table TB2, or may retain information including information regarding the communication connection authority of another transaction equipment 100. For example, transaction equipment 100R may retain only information (information in the first line of attribute table TB1) regarding the communication connection authority related to transaction equipment 100R. Transaction equipment 100R for a store manager may retain a part or all of information items regarding the communication connection authorities (information items in multiple lines of attribute table TB1) related to transaction equipments 100S and 100T for another store manager, transaction equipment 100 for a general staff (M2), and transaction equipments 100 for a temporary salesperson (M3 and M4) together with information regarding the communication connection authority related to transaction equipment 100R.

Attribute table TB1 and individual equipment table TB2 may retained in transaction equipment 100 until transaction equipment 100 is attached to docking device 200. For example, attribute table TB1 and individual equipment table TB2 may be generated by an external server, and may be obtained by transaction equipment 100 via the network. For example, second CPU 31 may set the communication connection authority depending on transaction equipment 100, and attribute table TB1 and individual equipment table TB2 may be generated and may be retained in second flash ROM 32. Transaction equipment 100 may generate any one of attribute table TB1 and individual equipment table TB2, and transaction equipment 100 may obtain the other table from the outside.

In the present exemplary embodiment, since the information regarding the communication connection authority is retained for the attribute information and the individual equipment identification information of transaction equipment 100, the communication connection authorities of predetermined transaction equipment 100 with the cradle sets may not be the same, as shown in FIG. 55B. For example, the communication connection authority of transaction equipment 100R with any one of the cradle sets may be set so as to be prohibited. The communication connection authorities of transaction equipments 100S and 100T with any one of the cradle sets, as the default authority may be set so as to be permitted.

Cooperation of Transaction Equipment with Cradle Set

Hereinafter, the cooperation of transaction equipment 100 with the cradle set will be described.

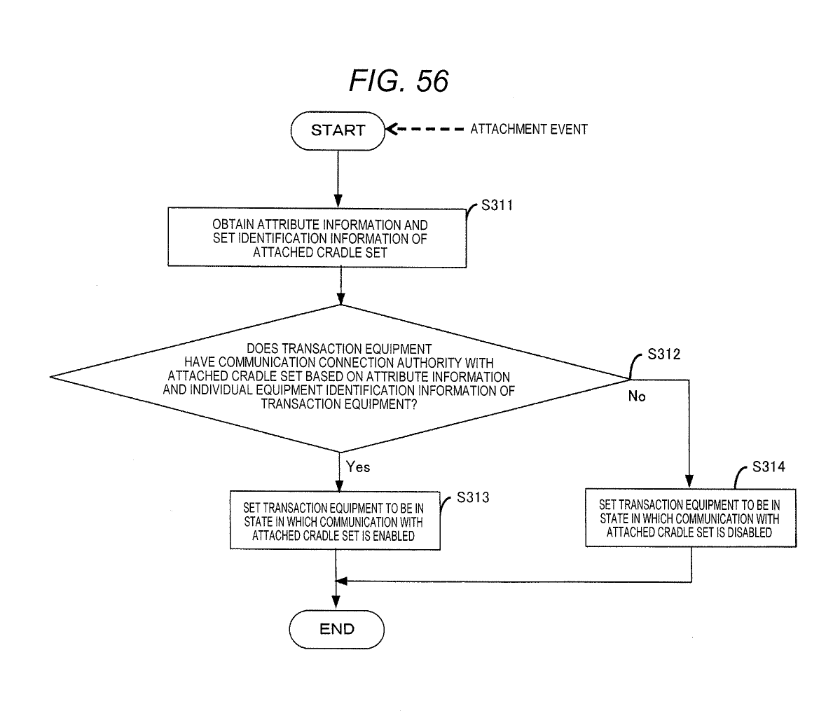

FIG. 56 is a flowchart showing an operation example of transaction equipment 100 when transaction equipment 100 and the cradle set cooperate.

The processes of FIG. 56 are started when docking device 200 detects the physical attachment (attachment event) of transaction equipment 100 to docking device 200. For example, device authentication controller 63 of docking device 200 detects that transaction equipment 100 is attached, and transmits the attachment detection signal to transaction equipment 100 through docking connector C1. Second CPU 31 of transaction equipment 100 obtains the attachment detection signal through docking device I/F 46, generates a software interrupt due to the attachment event, and starts the processes of FIG. 56.

Initially, second CPU 31 obtains the attribute information and the set identification information of the cradle set to which transaction equipment 100 is attached (S411). For example, in S411, second CPU 31 transmits the identification request for the cradle set to docking device 200 through docking device I/F 46 and docking connector C1. In docking device 200, peripheral equipment I/F 53 determines whether or not each peripheral equipment is connected to a terminal as a connecting target.

The attribute information of the cradle set includes, for example, information regarding the connection form of the cradle set, and information regarding the state of the cradle set. The information regarding the state of the cradle set includes information regarding the on or off of the power supply of the cradle set, and information regarding the on or off of wireless connection of each equipment included in the cradle set. Whether or not transaction equipment 100 is connected to docking device 200 is not included in the information regarding the state of the cradle set. Here, the information regarding the connection form of the cradle set is used as the attribute information of the cradle set. For example, even though the cradle sets have the same attribute, the set identification information items of the cradle sets are different cradle set IDs for each set, and are individual equipment identification information items of the cradle sets.

If peripheral equipment I/F 53 detects that receipt printer 300 and cash drawer 400 are connected, CPU 51 with internal memory identifies that the attribute information of the cradle set including docking device 200 is cradle set CSA.

If peripheral equipment I/F 53 detects that receipt printer 300 is connected, CPU 51 with internal memory identifies that the attribute information of the cradle set including docking device 200 is cradle set CSB.

If peripheral equipment I/F 53 detects that barcode reader 800, receipt printer 300 and cash drawer 400 are connected, CPU 51 with internal memory identifies that the attribute information of the cradle set including docking device 200 is cradle set CSC.

In a case where peripheral equipment I/F 53 does not detect the connection of the peripheral equipment, CPU 51 with internal memory identifies that the attribute information of the cradle set including docking device 200 is cradle set CSD.

If peripheral equipment I/F 53 detects that keyboard 700, mouse 750 and barcode reader 800 are connected, CPU 51 with internal memory identifies that the attribute information of the cradle set including docking device 200 is cradle set CSE.

The set identification information of the cradle set is retained in memory 51m. CPU 51 with internal memory obtains the set identification information of the cradle set from memory 51m. For example, in a case where the set identification information items are cradle set IDs and are checkout counters provided in the same store, the set identification information may be distinguished based on the management number within the store, or in a case where the set identification information items are checkout counters provided in different stores, the set identification information items may be distinguished based on the store ID.

CPU 51 with internal memory transmits the attribute information and set identification information of the cradle set to transaction equipment 100 through docking connector C1 and docking device I/F 46. In transaction equipment 100, second CPU 31 obtains the attribute information and the set identification information of the cradle set from docking device 200, and identifies the attribute information and the set identification information of the cradle set to which transaction equipment 100 is attached.

Subsequently, second CPU 31 determines whether or not the transaction equipment has the communication connection authority with the attached (identified) cradle set referring to attribute table TB1 and individual equipment table TB2 (S412). That is, second CPU 31 determines whether or not the transaction equipment has the communication connection authority based on the attribute information and the individual equipment information of transaction equipment 100.

In S412, second CPU 31 obtains the attribute information and the individual equipment information of own equipment from second flash ROM 32. For example, in a case where the attribute information of own equipment is M1, individual equipment identification information is #00R, the attribute information of the attached cradle set is CSA, and the set identification information is #00001 (CSA1), second CPU 31 determines that the transaction equipment has the communication connection authority with cradle set CSA1. For example, in a case where the attribute information of own equipment is M1, individual equipment identification information is #00S, the attribute information of the attached cradle set is CSE, and the set identification information is #00101 (CSE1), second CPU 31 determines that the transaction equipment does not have the communication connection authority with cradle set CSE1.

In a case where the transaction equipment has the communication connection authority with the attached cradle set, second CPU 31 sets the transaction equipment to be in a state in which the communication with the attached cradle set is enabled (S413). The communication enable state indicates a state in which transaction equipment 100 and the cradle set to which transaction equipment 100 is attached are logically connected. For example, in a case where the transaction equipment and the cradle set are logically connected, setting information (for example, communication connection flag=“ON”) for allowing transaction equipment 100 to functionally perform the communication connection with the cradle set by software is retained in second flash ROM 32 of transaction equipment 100.

For example, in a case where transaction equipment 100 is attached to cradle set CSA1 capable of performing the cash settlement, if second CPU 31 executes the settlement application, transaction equipment 100 and cradle set CSA1 cooperate, and thus, it is possible to perform the cash settlement using the peripheral equipment (for example, cash drawer 400 and receipt printer 300).

In a case where the transaction equipment does not have the communication connection authority with the attached cradle set, second CPU 31 sets the transaction equipment in a state in which the communication with the attached cradle set is disabled (S414). The communication disable state indicates that transaction equipment 100 and docking device 200 to which transaction equipment 100 is attached are not logically connected. For example, in a case where the transaction equipment and the cradle set are not logically connected, setting information (for example, communication connection flag=“OFF”) for allowing transaction equipment 100 to functionally perform the communication connection with the cradle set by software is retained in second flash ROM 32 of transaction equipment 100.

Accordingly, in a case where transaction equipment 100R is attached to cradle set CSA1 capable of performing the cash settlement, the user (store manager) can use cash drawer 400. Meanwhile, in a case where transaction equipment 100R is attached to cradle set CSE1 capable of performing the merchandise registration, the user (store manager) is not able to use cash drawer 400.

As mentioned above, transaction processing system 1000 can determine whether the communication connection with the specific peripheral equipment (for example, cash drawer 400) is permitted or prohibited depending on the attribute information and the individual equipment identification information of transaction equipment 100 possessed by the user. Thus, for example, the store manager with relatively high reliability may be permitted so as to handle cash, and the temporary salesperson with relatively low reliability may be prohibited so as not to handle cash.

The setting information for allowing transaction equipment 100 to perform the communication connection with the cradle set is retained in S413, and thus, it is possible to prevent data regarding the application from being transmitted to docking device 200 through the application executed by transaction equipment 100. Accordingly, it is possible to reduce unnecessary communication traffic between transaction equipment 100 and docking device 200.

### Change of Table

In individual equipment table TB2, in a case where a predetermined trigger occurs by disabling the use of transaction equipment 100, it is possible to change the communication connection authority. For example, in a case where transaction equipment 100 is being repaired, it is preferable that a person in charge of repair is not allowed to access important information (for example, information related to settlement) of transaction equipment 100 in view of security.

Thus, for example, when arbitrary transaction equipment 100 is repaired, information retained in individual equipment table TB2 is rewritten by maintenance terminal. Transaction equipment 100 to be repaired retains rewritten information regarding the communication connection authority. The maintenance terminal includes maintenance PC (Personal Computer) 900, or maintenance server 950, to be described below.

The maintenance terminal is connected to transaction equipment 100 to be repaired in a wireless or wired manner. For example, connection using a wired LAN (Local Area Network), connection using a wireless LAN, or USB (Universal Serial Bus) connection is considered as the connection method.

Here, it is assumed that transaction equipment 100R is a repairing target and transaction equipment 100S is used as substitute equipment of transaction equipment 100R while transaction equipment 100R is being repaired. Transaction equipment 100R is stored in, for example, a backyard or a warehouse (backyard) before this transaction equipment is used as the substitute equipment.

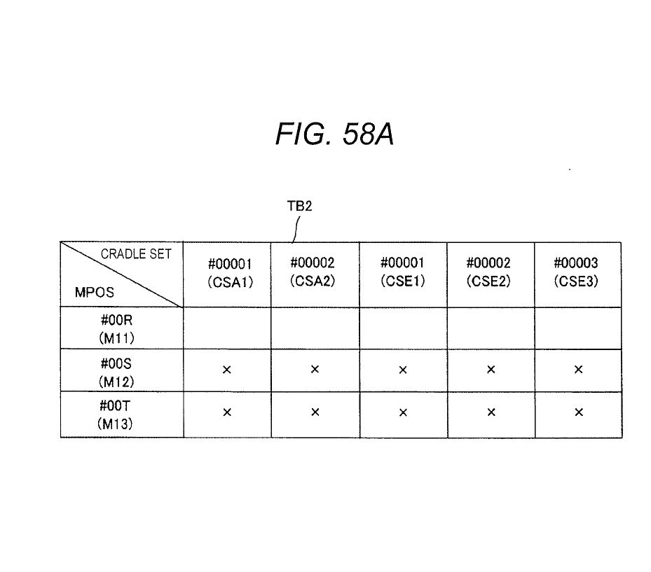

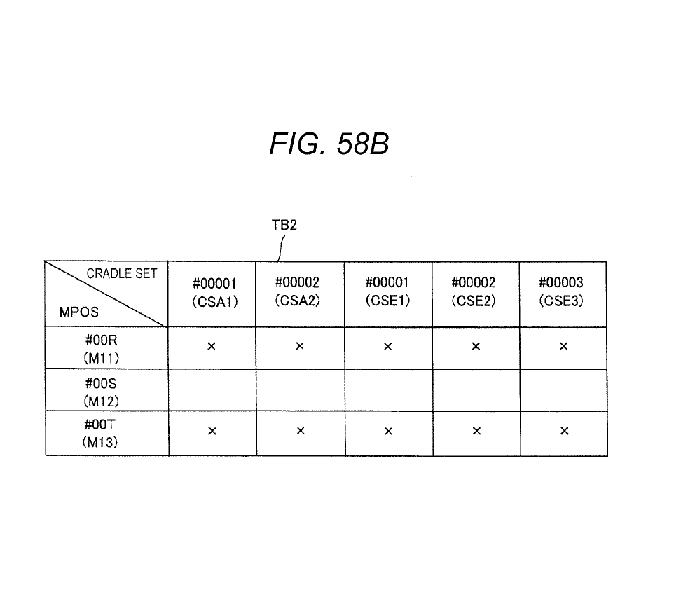

In an initial state (time t0), each transaction equipment 100 retains attribute table TB1 that has the communication connection authority shown in FIG. 55A and individual equipment table TB2 that has the communication connection authority shown in FIG. 55B in second flash ROM 32. That is, in the initial state, the information regarding the communication connection authority shown in FIG. 58A is set.

If it is necessary to repair transaction equipment 100R, the user takes transaction equipment 100S out of the backyard, as the substitute equipment of transaction equipment 100R. Transaction equipment 100 is operated according to the following first operation example or second operation example. First Operation Example when Predetermined Trigger Occurs

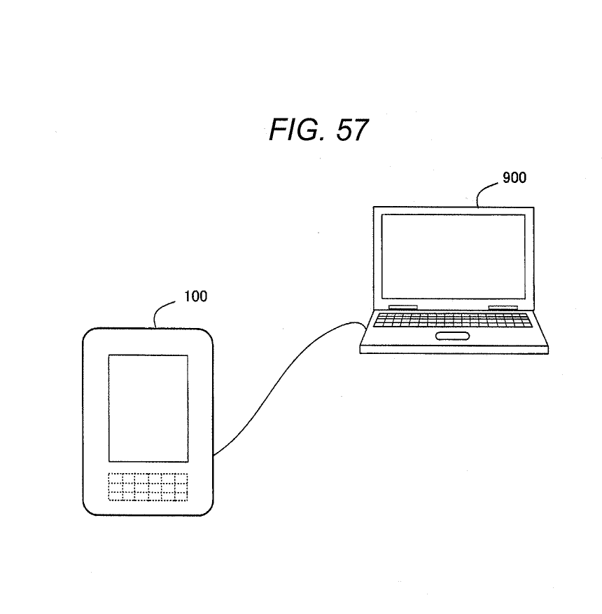

A first operation example of transaction processing system 1000 when a predetermined trigger (repair) occurs will be described. Here, as shown in FIG. 57, an example in which transaction equipment 100 to be repaired and maintenance PC 900 are connected through the USB connection will be described.

The user (here, the store manager) connects transaction equipment 100R to maintenance PC 900 through the USB connection when the user sends transaction equipment 100R for repair (time t1). Maintenance PC 900 receives an input operation from the user, and transmits a write command based on the input operation to transaction equipment 100R connected through the USB connection. Transaction equipment 100R receives the write command, and second CPU 31 sets the information regarding the communication connection authority of transaction equipment 100S with each cradle set to be “ ” (blank) in individual equipment table TB2.

Thus, in individual equipment table TB2, two lines including a line in which the information regarding the communication connection authority related to transaction equipment 100R is described and a line in which the information regarding the communication connection authority related to transaction equipment 100S is described are blanks. Here, since the information of attribute table TB1 is preferred, both transaction equipments 100S and 100R are permitted so as to perform the communication connection. In a state in which both transaction equipments 100R and 100S are permitted so as to perform the communication connection, transaction equipment 100S is attached to docking device 200, and tests whether or not the communication connection with the cradle set is enabled. In a case where transaction equipment 100S is allowed to perform the communication connection with the cradle set, second CPU 31 sets the communication connection authority of transaction equipment 100R with each cradle set so as to be prohibited in individual equipment table TB2.

Accordingly, as shown in FIG. 58B, the communication connection authority related to transaction equipment 100R is described as “X”, and the information regarding the communication connection authority related to transaction equipment 100S is described as “ ” (blank).

Therefore, for example, even in a case where a third party in charge of repair maliciously operates transaction equipment 100R, it is possible to reduce a possibility that the information will leak from transaction equipment 100R, and thus, it is possible to improve the safety of transaction equipment 100R.

Similarly to transaction equipment 100R, in transaction equipment 100S, second CPU 31 sets the communication connection authority of transaction equipment 100S with each cradle set to be “ ” (blank) and sets the information regarding the communication connection authority of transaction equipment 100R with each cradle set to be “X” (prohibition) in individual equipment table TB2. When individual equipment table TB2 is written, transaction equipment 100S is also connected to maintenance PC 900 through the USB connection.

Thus, at time t1, transaction equipment 100R can prohibit the communication connection of transaction equipment 100R with each cradle set based on the information items of attribute table TB1 and individual equipment table TB2 retained in own equipment. Transaction equipment 100S can permit the communication connection of transaction equipment 100S with each cradle set based on the information items of attribute table TB1 and individual equipment table TB2 possessed by own equipment.

Accordingly, even in a case where transaction equipment 100R for a store manager is sent for repair, since transaction equipment 100S for another store manager can be used as substitute equipment with the same communication connection authority as that of transaction equipment 100R, it is possible to improve the convenience of the user who uses transaction equipment 100R.

If the repair of transaction equipment 100R is completed (time t2), the user connects transaction equipment 100R to maintenance PC 900 through the USB connection. Maintenance PC 900 receives an input operation from the user, and transmits the write command based on the input operation to transaction equipment 100R connected through the USB connection. Transaction equipment 100R receives the write command, and second CPU 31 sets the information regarding the communication connection of transaction equipment 100R with each cradle set to be “ ” (blank) in individual equipment table TB2.

Accordingly, two lines including a line in which the information regarding the communication connection authority related to transaction equipment 100R is described and a line in which the information regarding the communication connection authority related to transaction equipment 100S is described are blanks in individual equipment table TB2. Here, since the information of attribute table TB1 is preferred, and transaction equipments 100S and 100R are permitted so as to perform the communication connection.

In a state in which both transaction equipments 100R and 100S are permitted so as to perform the communication connection, transaction equipment 100R tests whether or not the communication connection with the cradle set is enabled. In a case where transaction equipment 100R is allowed to perform the communication connection with the cradle set, second CPU 31 sets the communication connection authority of transaction equipment 100S with each cradle set so as to be prohibited in individual equipment table TB2.

Accordingly, as shown in FIG. 58A, the communication connection authority related to transaction equipment 100S is described as “X”, and the information regarding the communication connection authority related to transaction equipment 100R is described as “ ” (blank).

Transaction equipment 100S ends the role of the substitute equipment, and is stored in the backyard. Accordingly, for example, in a case where transaction equipment 100R is returned, it is possible to reduce a possibility that the information will leak from transaction equipment 100S stored in the backyard, and thus, it is possible to improve the safety of transaction equipment 100S.

Similarly to transaction equipment 100R, in transaction equipment 100S, second CPU 31 sets the information regarding the communication connection authority of transaction equipment 100R with each cradle set to be “ ” (blank) and sets the information regarding the communication connection authority of transaction equipment 100S with each cradle set to be “X” (prohibition) in individual equipment table TB2. When individual equipment table TB2 is rewritten, transaction equipment 100S is connected to maintenance PC 900 through the USB connection.

Thus, at time t2, transaction equipment 100R can permit the communication connection of transaction equipment 100R with each cradle set based on the information items of attribute table TB1 and individual equipment table TB2 retained in own equipment. Transaction equipment 100S can prohibit the communication connection of transaction equipment 100S with each cradle set based on the information items of attribute table TB1 and individual equipment table TB2 retained in own equipment.

Second Operation Example when Predetermined Trigger Occurs

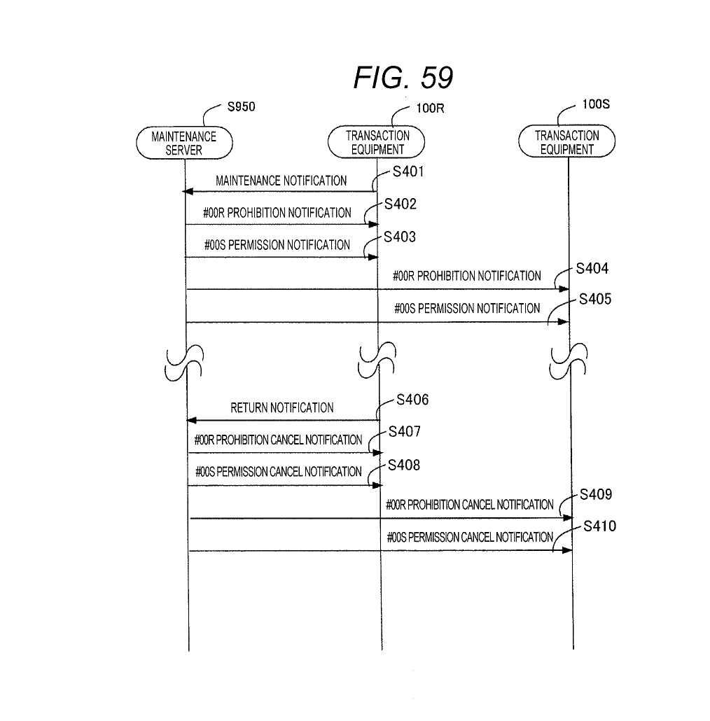

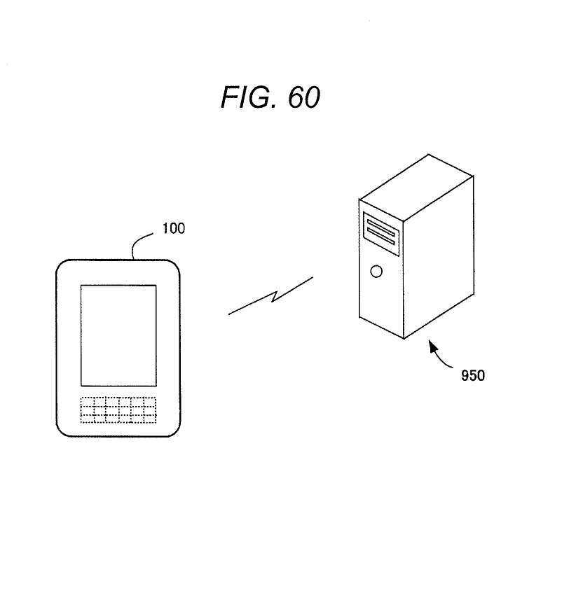

FIG. 59 is a sequence diagram showing a second operation example of transaction processing system 1000 when a predetermined trigger (repair) occurs. Here, an example in which transaction equipment 100 to be repaired and maintenance server 950 are wirelessly connected as shown in FIG. 60 will be described.

When the user (here, the store manager) sends transaction equipment 100R for repair, transaction equipment 100R is wirelessly connected to maintenance server 950. In transaction equipment 100R, second touch-input detector 34a receives the input operation from the user, and any one of the communicators transmits a repair notification to maintenance server 950 (S401). The repair notification includes, for example, the individual equipment identification information of transaction equipment 100R (transmission source (repairing target)), and the individual equipment identification information of transaction equipment 100S as the substitute equipment.

Maintenance server 950 rewrites the information regarding the communication connection authority retained in individual equipment table TB2 of transaction equipment 100R based on the repair notification of transaction equipment 100R. Here, maintenance server 950 transmits a prohibition notification of transaction equipment 100R and a permission notification of transaction equipment 100S to transaction equipment 100R (S402 and S403).

The prohibition notification of transaction equipment 100R includes an instruction to set the information regarding the communication connection authority of transaction equipment 100R with each cradle set to be “X” (prohibition). The permission note of transaction equipment 100S includes an instruction to set the information regarding the communication connection authority of transaction equipment 100S to each cradle set to be “ ” (blank).

In transaction equipment 100R, any one of the communicators receives the prohibition notification of transaction equipment 100R from maintenance server 950 and the permission notification of transaction equipment 100S. Second CPU 31 sets the information regarding the communication connection authority of transaction equipment 100R with each cradle set to be “X” (prohibition) and sets the information regarding the communication connection authority of transaction equipment 100S with each cradle set to be “ ” (blank) in individual equipment table TAB2 retained in own equipment based on the prohibition notification and the permission notification.

Similarly, maintenance server 950 rewrites the information regarding the communication connection authority retained in individual equipment table TB2 of transaction equipment 100S based on the repair notification of transaction equipment 100R. Here, maintenance server 950 transmits the prohibition notification of transaction equipment 100R and the permission notification of transaction equipment 100S to transaction equipment 100S (S404 and S405).

In transaction equipment 100S, any one of the communicators receives the permission notification of transaction equipment 100S and the prohibition notification of transaction equipment 100R from maintenance server 950. Second CPU 31 sets the information regarding the communication connection authority of transaction equipment 100R with each cradle set to be “X” (prohibition) and sets the information regarding the communication connection authority of transaction equipment 100S with each cradle set to be “ ” (blank) in individual equipment table TB2 retained in own equipment based on the prohibition notification and the permission notification.

Thus, the communication connection of transaction equipment 100R with each cradle set is prohibited, and the communication connection of transaction equipment 100S with each cradle set is permitted (see FIG. 58B).

Accordingly, for example, even in a case where a third party in charge of repair maliciously operates transaction equipment 100R, it is possible to reduce a possibility that the information will leak from transaction equipment 100R, and thus, it is possible to improve the safety of transaction equipment 100R.

Even in a case where transaction equipment 100R for a store manager is sent for repair, since transaction equipment 100S for another store manager can be used as the substitute equipment with the same communication connection authority as that of transaction equipment 100R, it is possible to improve the convenience of the user who uses transaction equipment 100R.

If the repair of transaction equipment 100R is completed, transaction equipment 100R is wirelessly connected to maintenance server 950. In transaction equipment 100R, second touch-input detector 34a receives the input operation from the user, and any one of the communicators transmits a return notification to maintenance server 950 (S406). For example, the return notification includes the individual equipment identification information of transaction equipment 100R as a transmission source (repairing target), and the individual equipment identification information of transaction equipment 100S as the substitute equipment.

Maintenance server 950 rewrites the information regarding the communication connection authority retained in individual equipment table TB2 of transaction equipment 100R based on the return notification of transaction equipment 100R. Here, maintenance server 950 transmits a permission cancel notification of transaction equipment 100S and a prohibition cancel notification of transaction equipment 100R to transaction equipment 100R (S407 and S408).

The prohibit cancel notification of transaction equipment 100R includes an instruction to return the information to the original state (“ ” (blank)) by cancelling the information regarding the communication connection authority of transaction equipment 100R with each cradle set. The permission cancel notification of transaction equipment 100S includes an instruction to return the information to the original state (“X” (prohibition)) by cancelling the information regarding the communication connection authority of transaction equipment 100S with each cradle set.

In transaction equipment 100R, any one of the communicators receives the prohibition cancel notification of transaction equipment 100R and the permission cancel notification of transaction equipment 100S from maintenance server 950. Second CPU 31 sets the information regarding the communication connection authority of transaction equipment 100R with each cradle set to be “ ” (blank) and sets the information regarding the communication connection authority of transaction equipment 100S with each cradle set to be “X” (prohibition) in individual equipment table TB2 retained in own equipment based on the prohibition cancel notification and the permission cancel notification.

Similarly, maintenance server 950 rewrites the information regarding the communication connection authority retained in individual equipment table TB2 of transaction equipment 100S based on the return notification of transaction equipment 100R. Here, maintenance server 950 transmits the prohibition cancel notification of transaction equipment 100R and the permission cancel notification of transaction equipment 100S to transaction equipment 100S (S409 and S410).

In transaction equipment 100S, any one of the communicators receives the prohibition cancel notification of transaction equipment 100R and the permission cancel notification of transaction equipment 100S from maintenance server 950. Second CPU 31 sets the information regarding the communication connection authority of transaction equipment 100R with each cradle set to be “ ” (blank) and sets the information regarding the communication connection authority of transaction equipment 100S with each cradle set to be “X” (prohibition) in individual equipment table TB2 retained in own equipment based on the prohibition notification and the permission notification.

Accordingly, the prohibition of the communication connection of transaction equipment 100R with each cradle set is cancelled, and the permission of the communication connection of transaction equipment 100S with each cradle set is cancelled (see FIG. 58B).

Accordingly, for example, in a case where transaction equipment 100R is returned, it is possible to reduce a possibility that the information will leak from transaction equipment 100S stored in the backyard, and thus, it is possible to improve the safety of transaction equipment 100S.

As described above, according to the first operation example and the second operation example, even in a case where arbitrary transaction equipment 100 is disabled due to the repair, it is possible to improve the convenience of transaction equipment 100, and thus, it is possible to improve the safety of transaction equipment 100. In a case where transaction equipment 100 as the repairing target is returned, transaction equipment 100 as the repairing target can cooperate with the cradle set again, and thus, it is possible to improve the convenience by ensuring the safety of transaction equipment 100.

For example, even though the transaction equipments have the attribute of the same store manager, transaction equipment 100 capable of being normally operated is permitted so as to cooperate with the cradle set, and the information of individual equipment table TB2 is updated such that transaction equipment 100 capable of being normally operated (for example, the repairing target) is prohibited so as not to cooperate with the cradle set. Thus, even though transaction equipments 100 have the same attribute, it is possible to determine whether or not the communication connection with the cradle set is permitted.

According to transaction processing system 1000 of the present exemplary embodiment, it is possible to determine whether or not the communication connection of transaction equipment 100 is permitted from each attribute and individual equipment of transaction equipment 100.

Accordingly, in a case where transaction equipment 100 and the cradle set cooperate, it is possible to reduce the reduction in business efficiency in the commercial transaction, and thus, it is possible to improve the safety of the commercial transaction.

In a case where a predetermined trigger occurs by disabling arbitrary transaction equipment 100, another transaction equipment 100 having the same attribute as that of disabled transaction equipment 100 can be used as the substitute equipment. Even though another transaction equipment 100 is used as the substitute equipment, individual equipment table TB2 retained in each transaction equipment 100 is rewritten, and thus, it is possible to safely use transaction equipment 100. As a result, it is possible to improve the convenience of the user. For example, the communication connection authority of transaction equipment 100 as the repairing target is copied onto the communication connection authority of transaction equipment 100 as the substitute equipment during the repair. The communication connection authority of transaction equipment 100 as the repairing target and the communication connection authority of transaction equipment 100 as the substitute equipment are returned to the state (time t0) in which the repair is not performed at the time of the return after the repair is completed.

Even though transaction equipment 100 used by the specific salesperson (for example, the temporary salesperson) is permitted so as to cooperate with the cradle set provided in the store, the cradle set capable of cooperating with transaction equipment 100 is restricted. Thus, for example, it is possible to reduce a use error occurring in the cradle set due to a lack of knowledge or a lack of experience of the temporary salesperson. Accordingly, transaction processing system 1000 can reduce degradation in the safety in the commercial transaction, and can ensure the benefit of the store. Transaction processing system 1000 can ensure selling fees of the acquirer.

Unlike the case where the communication connection authority is set using only the individual equipment identification information, transaction equipment 100 can prevent the setting of the communication connection authority from being complicated by distinguishably registering the information regarding the communication connection authority between attribute table TB1 and individual equipment table TB2. In a case where a predetermined trigger occurs, transaction equipment 100 can easily change the setting of the communication connection authority by changing the information of individual equipment table TB2 as the slave table without changing the information of attribute table TB1 as the master table. As stated above, transaction equipment 100 can suppress the occurrence of a human error by reducing the complication related to the setting of the communication connection authority.

### Eighth Exemplary Embodiment

It has been described in the seventh exemplary embodiment that the communication connection with the cradle set to which transaction equipment 100 is connected is permitted depending on the attribute information and the individual equipment identification information of transaction equipment 100. In an eighth exemplary embodiment, it will be described that the communication connection of transaction equipment 100 attached to docking device 200 included in the cradle set with the cradle set is permitted depending on the attribute information and the set identification information of the cradle set.

In the present exemplary embodiment, the same configuration and operation as the configuration and operation described in the seventh exemplary embodiment will be assigned same reference numerals, and thus, the description thereof will be omitted or simplified. For example, the configuration of transaction processing system 1000, the attachment and detachment of transaction equipment 100 to and from docking device 200, the configuration of transaction equipment 100, the configuration of docking device 200, an example of the operation screen of the settlement application, an example of the operation screen of the merchandise registration application, and the connection form between the docking device and the peripheral equipment are the same as those in the seventh exemplary embodiment, and thus, the description thereof will be omitted. The change of the table and the operation example of transaction processing system 1000 when a predetermined trigger (repair) occurs are the same as those in the seventh exemplary embodiment, and thus, the description thereof will be omitted.

### Communication Connection Authority Depending on Cradle Set

Similarly to the seventh exemplary embodiment, the cradle set includes, for example, cradle sets CSA, CSB, CSC, CSD and CSE, but is not limited thereto. In the present exemplary embodiment, the cradle set capable of performing the communication connection with transaction equipment 100, that is, the communication connection authority is classified according to the attribute information (for example, for cash settlement, card settlement, merchandise registration, returned-merchandise reception, or delivery reception) and the set identification information (the individual equipment identification information for identifying the cradle set) of the cradle set.

If transaction equipment 100 sets the communication connection authority of transaction equipment 100 with the cradle set depending on only the attribute information and the set identification information of the cradle set, the following events occur. For example, if the transaction equipment does not have the communication connection authority in a case where the cradle set is CSA and the set identification number is #00001 (cradle set CSA1), the communication connection with the cradle set CSA1 is prohibited irrespective of transaction equipment 100, and cradle set CSA1 is not allowed to perform the communication connection with any of transaction equipment 100. In order to avoid such an event, in the present exemplary embodiment, the communication connection authority of transaction equipment 100 with the cradle set is set and is determined depending on the attribute information and the individual equipment identification information of transaction equipment 100 together with the attribute information and the set identification information of the cradle set.

For example, the communication connection authority of transaction equipment 100 is set at the time of the introduction of transaction equipment 100. For example, transaction equipment 100 associates the attribute information and the individual equipment identification information of transaction equipment 100 with the communication connection authority of transaction equipment 100 with the cradle set for each attribute information (for example, the connection form of the cradle set for the cash settlement) and set identification information (for example, #00001 or #00101) of the cradle set, and the association information is retained in transaction equipment 100. The above-described association information is, for example, information retained in individual equipment table TB2 and attribute table TB1.

Attribute table TB1 of the present exemplary embodiment may be the same as attribute table TB1 shown in FIG. 55A. Individual equipment table TB2 of the present exemplary embodiment may be the same as individual equipment table TB2 shown in FIG. 55B. The same description as that of attribute table TB1 and individual equipment table TB2 in the seventh exemplary embodiment will not be omitted.

Attribute table TB1 retains the information regarding the communication connection authority of transaction equipment 100 with the cradle set for each attribute information of the cradle set. Individual equipment table TB2 retains the information regarding the communication connection authority of transaction equipment 100 with the cradle set for each set identification information and attribute information (information indicating the store manager in FIG. 55B) of the cradle set.

In the present exemplary embodiment, since the information regarding the communication connection authority is retained for set identification information and attribute information of the cradle set, the communication connection authority of predetermined transaction equipment 100 with the cradle set may not be the same, as shown in FIG. 55B. For example, the communication connection authority of transaction equipment 100R with any one of the cradle sets may be set so as to be prohibited. The communication connection authority of transaction equipments 100S and 100T with any one of the cradle sets may be set so as to be permitted as the default authority.

Cooperation of Transaction Equipment with Cradle Set

Hereinafter, the cooperation of transaction equipment 100 with the cradle set will be described.

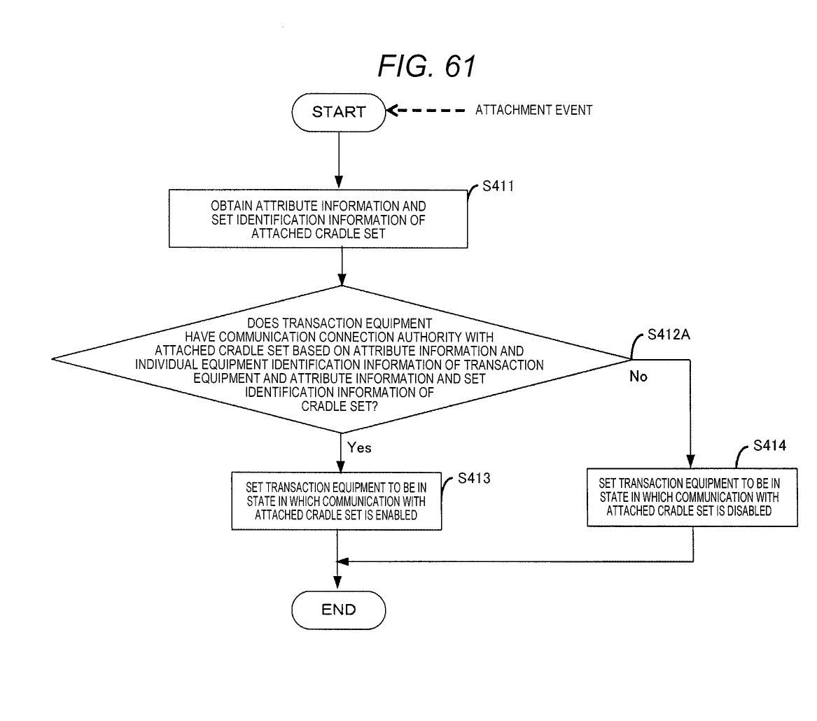

FIG. 61 is a flowchart showing an operation example of transaction equipment 100 when transaction equipment 100 and the cradle set cooperate. In FIG. 61, the same processes as those of FIG. 56 will be assigned the same reference numerals, and the description thereof will be omitted or simplified.

Similarly to the seventh exemplary embodiment, the processes of FIG. 61 are started when docking device 200 detects the physical attachment (attachment event) of transaction equipment 100 to docking device 200.

Initially, transaction equipment 100 performs the process of S411.

Subsequently, second CPU 31 determines whether or not the transaction equipment has the communication connection authority with the attached (identified) cradle set by referring to attribute table TB1 and individual equipment table TB2 (S412A). That is, second CPU 31 determines whether or not the transaction equipment has the communication connection authority based on the attribute information and the individual equipment information of transaction equipment 100 and the attribute information and the set identification information of the cradle set.

In S412A, second CPU 31 obtains the attribute information and the individual equipment identification information of own equipment from second flash ROM 32. For example, in a case where the attribute information of own equipment is M1, the individual equipment identification information is #00R, the attribute information of the attached cradle set is CSA and the set identification information is #00001 (CSA1), second CPU 31 determines that the transaction equipment has the communication connection authority with cradle set CSA1. For example, in a case where the attribute information of own equipment is M1, the individual equipment identification information is #00S, the attribute information of the attached cradle set is CSE and the set identification information is #00101 (CSE1), second CPU 31 determines that the transaction equipment does not have the communication connection authority with cradle set CSE 1.

After the process of S412A, transaction equipment 100 performs the processes of S413 and S414.

Accordingly, in a case where transaction equipment 100R is attached to cradle set CSA1 capable of performing the cash settlement, the store manger as the user can use cash drawer 400. Meanwhile, in a case where transaction equipment 100S is attached to cradle set CSA1 capable of performing the cash settlement, the store manager as the user is not able to use cash drawer 400.

As stated above, transaction processing system 1000 can determine whether the communication connection with the peripheral equipment (for example, cash drawer 400) included in the specific cradle set is permitted or prohibited for each attribute information and individual equipment identification information of transaction equipment 100 depending on the attribute information and the set identification information of the cradle set. Thus, for example, transaction equipment 100 for a predetermined store manager is permitted so as to use cash drawer 400. Transaction equipment 100 for another store manager may be prohibited so as not to use cash drawer 400.

According to transaction processing system 1000 of the present exemplary embodiment, it is possible to determine whether or not the communication connection authority of transaction equipment 100 is permitted for each attribute information and set identification information of transaction equipment 100 depending on the attribute information and the set identification information of the cradle set. Accordingly, in a case where transaction equipment 100 is cooperated with the cradle set, it is possible to reduce a decrease in business efficiency in the commercial transaction, and thus, it is possible to improve the safety of the commercial transaction. For example, transaction processing system 1000 can ensure the benefit of the store by reducing an unauthorized use or a handling error of the specific peripheral equipment (for example, cash drawer 400) and reducing degradation in the safety in the commercial transaction. Transaction processing system 1000 can ensure the sales fees of the acquirer.

### Ninth Exemplary Embodiment

It has been described in the seventh exemplary embodiment and the eighth exemplary embodiment that the communication connection with all the peripheral equipments included in the cradle set is permitted or prohibited by transaction equipment 100. In a ninth exemplary embodiment, it will be described that the communication connection with a part of the peripheral equipments or docking device 200 included in the cradle set is permitted or prohibited by transaction equipment 100. That is, an example in which the use of at least a part of the functions of the cradle set is permitted or prohibited by transaction equipment 100 will be described.

In the ninth exemplary embodiment, the same description as that in the seventh exemplary embodiment or the eighth exemplary embodiment will be omitted or simplified.

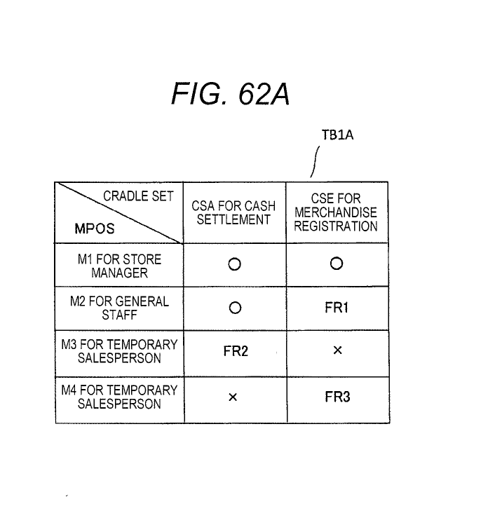

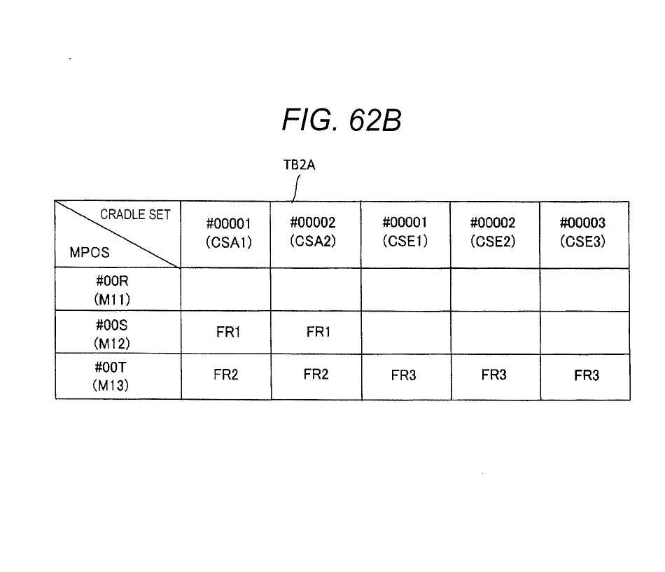

FIGS. 62A and 62B are schematic diagrams showing examples of attribute table TB1A and individual equipment table TB2A. The same description as that of attribute table TB1 or individual equipment table TB2 in the seventh exemplary embodiment and the eighth exemplary embodiment will be omitted or simplified.

Attribute table TB1A retains information regarding the function use restriction of transaction equipment 100 on the function of the cradle set for each attribute information of transaction equipment 100. Attribute table TB1A is retained in, for example, second flash ROM 32. The information regarding the function use restriction retained in attribute table TB1A is a default authority. In attribute table TB1A, the function use restriction on two types of cradle sets CSA and CSE is described.

Individual equipment table TB2A retains information regarding the function use restriction of transaction equipment 100 on the function of the cradle set for each individual equipment identification information of transaction equipment 100 having predetermined attribute information. Individual equipment table TB2A is retained in, for example, second flash ROM 32.

For example, individual equipment table TB2A is provided for each attribute information of transaction equipment 100. Accordingly, the description of the tables other than individual equipment table TB2A for a store manager will be omitted, but individual equipment table TB2A for a store manager, individual equipment table for a general staff and an individual equipment table for a temporary salesperson are retained in, for example, second flash ROM 32.

In attribute table TB1A and individual equipment table TB2A, “O” means that the use of all the functions of the cradle set is permitted (there is not use restriction), and “X” means that the use of all the functions of the cradle set is prohibited. “FR1” means that the use of a partial function (Function 1) of the cradle set is restricted, “FR2” means that the use of a partial function (Function 2) of the cradle set is restricted, and “FR3” means that the use of a partial function (Function 3) of the cradle set is restricted. The use restrictions of all the functions may be combined.

The function of the cradle set includes, for example, a card settlement function, a cash settlement function, a merchandise registration (checkout counter) function, a returned-merchandise reception function, a stock inquiry function, and a maintenance function. The maintenance function includes, for example, a user registration, change and deletion function, a software install and uninstall function, a terminal update function, and a terminal setting function. Function 1, Function 2 and Function 3 include at least one of the functions of the above-described cradle set. For example, as the result of the function use restriction on Function 1, Function 2 or Function 3, it is considered that the use of the card settlement function, the merchandise registration function, the returned-merchandise reception function, the stock inquiry function, and the terminal update function of the maintenance function is permitted and the use of other functions is prohibited.

Cash drawer 400 includes a cash drawer (a large-amount-of-money cash drawer) capable of storing the large amount of money, and a cash drawer (a small-amount-of-money cash drawer) capable of storing the small amount of money. For example, as the result of the function use restriction on Function 1, Function 2 or Function 3, it is considered that the use of both the large-amount-of-money cash drawer and the small-amount-of-money cash drawer is restricted, or the use of the large-amount-of-money cash drawer is restricted and the use of the small-amount-of-money cash drawer is not restricted.

In FIG. 62A, in transaction equipment 100 for a store manager (M1), the use of all the functions of cradle sets CSA and CSE is set so as to be permitted. In transaction equipment 100 for a general staff (M2), the use of the function of cradle set CSA capable of performing the cash settlement is set so as to be permitted, and the use of Function 1 of cradle set CSE capable of performing the merchandise registration is set so as to be restricted.

In transaction equipment 100 for settlement (M3) of a temporary salesperson, the use of Function 2 of cradle set CSA capable of performing the cash settlement is set so as to be restricted, and the use of all the functions of the cradle set capable of performing the merchandise registration is set so as to be prohibited. In transaction equipment 100 for checkout counter (merchandise registration) (M4) of a temporary salesperson, the use of all the functions of cradle set CSA capable of performing the cash settlement is set so as to be prohibited, and the use of Function 3 of cradle set CSE capable of performing the merchandise registration is set so as to be restricted.

Individual equipment table TB2A retains the information regarding the function use restriction of transaction equipment 100 on the function of the cradle set for each individual equipment identification information (here, #00R, #00S, or #00T) of transaction equipment 100 having predetermined attribute information (here, information indicating the store manager). Individual equipment table TB2A is retained in, for example, second flash ROM 32.

For example, individual equipment table TB2A is provided for each attribute information of transaction equipment 100. Accordingly, the description of the tables other than individual equipment table TB2A for a store manager is omitted, but individual equipment table TB2A for a store manager, an individual equipment table for a general staff, and an individual equipment table for a temporary salesperson are retained in, for example, second flash ROM 32.

In FIG. 62B, “ ” (blank) means that the function use restriction is the same as the default authority, that is, the information regarding the function use restriction in the same attribute of transaction equipment 100 in attribute table TB1A. “O” means that the communication connection is preferentially set so as to be permitted, “X” means that the communication connection is preferentially set so as to be prohibited, “FR1” means that Function 1 is preferentially set so as to be restricted, “FR2” means that Function 2 is preferentially set so as to be restricted, and “FR3” means that Function 3 is preferentially set so as to be restricted. The communication connection authority retained in attribute table TB1A is the default authority.

For example, the information regarding the communication connection authority of transaction equipment 100S with cradle set CSA1 is “FR1”. In this case, Function 1 of individual equipment table TB2A is set so as to be restricted irrespective of the communication connection authority (here, permission setting) of transaction equipment 100 for a store manager with cradle set CSA in attribute table TB1A. That is, the information regarding the function use restriction of individual equipment table TB2A is preferred to the information regarding the function use restriction of attribute table TB1A. In FIG. 62B, in transaction equipment 100R, since the information regarding the function use restriction on cradle sets CSA1, CSA2, CSE1, CSE2 and CSE3 is a blank, the default authority is reflected, and is set so as to be permitted. In transaction equipment 100S, the use of Function 1 of cradle sets CSA1 and CSA2 is set so as to be restricted, and the use of all the functions of cradle sets CSE1 to CSE3 is set so as to be permitted. In transaction equipment 100T, the use of Function 2 of cradle sets CSA1 and CSA2 is set so as to be restricted, and the use of Function 3 of cradle sets CSE1 to CSE3 is set so as to be restricted.

As stated above, even though transaction equipments 100 have the same attribute, it is possible to set the use restriction on the function of the cradle set to be different.

Similarly to the seventh exemplary embodiment, individual equipment table TB2A shown in FIG. 62B represents the information regarding the function use restriction at arbitrary timing (for example, time t0). The information regarding the function use restriction of individual equipment table TB2A may be changed when the predetermined trigger (for example, the repair of transaction equipment 100) occurs. The detail of the change of the information regarding the function use restriction of individual equipment table TB2A is the same as that in the seventh exemplary embodiment, and the description thereof will be omitted.

According to transaction processing system 1000 of the present exemplary embodiment, it is possible to determine whether or not the function use restriction of transaction equipment 100 on the cradle set for each attribute and individual equipment of transaction equipment 100. Thus, in a case where transaction equipment 100 and the cradle set cooperate, it is possible to reduce the reduction in business efficiency in the commercial transaction, and thus, it is possible to improve the safety of the commercial transaction.

In a case where a predetermined trigger occurs by disabling arbitrary transaction equipment 100, another transaction equipment 100 having the same attribute as that of disabled transaction equipment 100 can be used as the substitute equipment. Even though another transaction equipment 100 is used as the substitute equipment, individual equipment table TB2A retained in each transaction equipment 100 is rewritten, and thus, it is possible to safely use transaction equipment 100. As a result, it is possible to improve the convenience of the user. For example, the communication connection authority of transaction equipment 100 as the repairing target is copied onto the information regarding the use function restriction of transaction equipment 100 as the substitute equipment during the repair. The communication connection authority of transaction equipment 100 as the repairing target and the information regarding the function use restriction of transaction equipment 100 as the substitute equipment are returned to the state (time t0) in which the repair is not performed at the time of the return after the repair is completed.

Even though transaction equipment 100 used by the specific salesperson (for example, the temporary salesperson) is permitted so as to cooperate with the cradle set provided in the store, the function of the cradle set capable of being used by transaction equipment 100 is restricted. Thus, for example, it is possible to reduce a use error occurring in the cradle set due to a lack of knowledge or a lack of experience of the temporary salesperson. Accordingly, transaction processing system 1000 can reduce degradation in the safety in the commercial transaction, and can ensure the benefit of the store. Transaction processing system 1000 can ensure selling fees of the acquirer.

Unlike the case where the function use restriction is set using only the individual equipment identification information, transaction equipment 100 can prevent the setting of the communication connection restriction from being complicated by distinguishably registering the information regarding the use function restriction between attribute table TB1A and individual equipment table TB2A. In a case where a predetermined trigger occurs, transaction equipment 100 can easily change the setting of the use function restriction by changing the information of individual equipment table TB2A as the slave table without changing the information of attribute table TB1A as the master table. As stated above, transaction equipment 100 can suppress the occurrence of a human error by reducing the complication related to the setting of the communication connection restriction.

Similarly to the relationship between the seventh exemplary embodiment and the eighth exemplary embodiment, the use restriction on the function of the cradle set based on the attribute information and the individual equipment identification information of transaction equipment 100 may be applied to the use restriction on the function of the cradle set based on the attribute information and the set identification information of the cradle set and the attribute information and the individual equipment identification information of transaction equipment 100. In this case, it is possible to obtain the same effects as that of the eighth exemplary embodiment in consideration of the use restriction on the function of the cradle set.

### Other Exemplary Embodiments

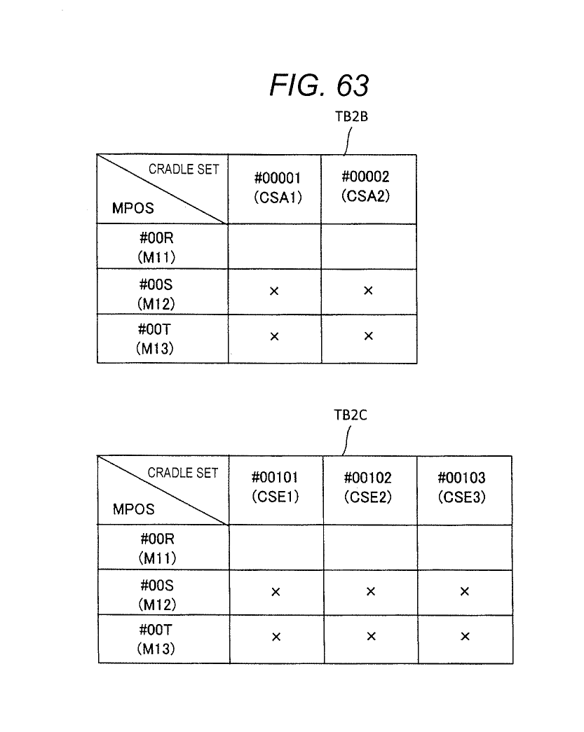

It has been described in the seventh and eighth exemplary embodiments that the communication connection authority of transaction equipment 100 related to one attribute information item with the cradle set related to the plurality of attribute information items are represented in individual equipment table TB2. Instead of individual equipment table TB2, as represented in individual equipment tables TB2B and T2C of FIG. 63, the communication connection authority of transaction equipment 100 related to one attribute information item with the cradle set related to one attribute information item may be provided for each attribute of the cradle set. The same applies in the ninth exemplary embodiment.

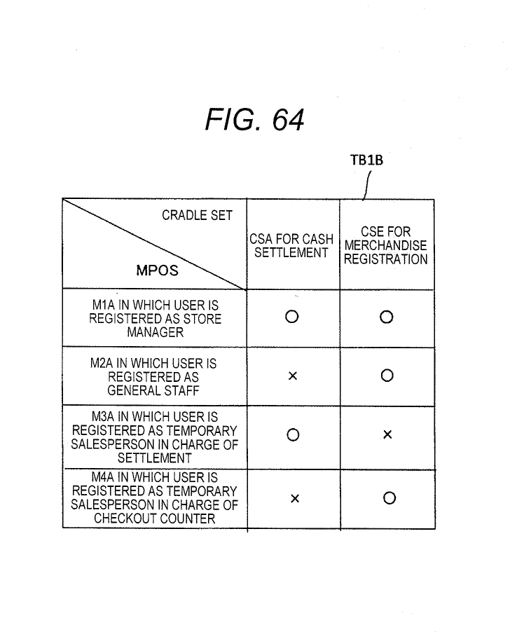

It has been described in the seventh and eighth exemplary embodiments that the information regarding the employment position of the user is used as one of the attribute information items of transaction equipment 100 in attribute table TB1. As shown in FIG. 64, information regarding the user registration may be used as one of the attribute information items of transaction equipment 100 in attribute table TB1B. The same applies in the ninth exemplary embodiment.

For example, referring to attribute table TB1B and individual equipment table TB2 shown in FIG. 55B, transaction equipment (M1A1) which is transaction equipment (M1A) having information regarding user registration as the store manager and has individual equipment identification information of #00R has the communication connection authority with cradle set CSA1. Transaction equipment (M1A1) which is transaction equipment (M1A) having information regarding user registration as the store manager and has individual equipment identification information of #00S does not have the communication connection authority with cradle set CSA1.

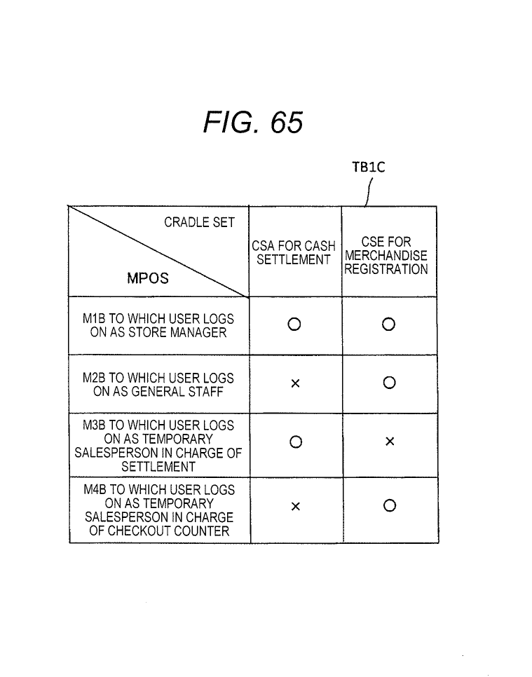

As shown in FIG. 65, information indicating that the user logs on using the registration information of the user may be used as one of the attribute information items of transaction equipment 100 in attribute table TB1C. The same applies in the ninth exemplary embodiment.

For example, referring to attribute table TB and individual equipment table TB2 shown in FIG. 55B, transaction equipment (M1B1) which is transaction equipment (M1B) to which the user logs on as the store manager and has individual equipment identification information of #00R has the communication connection authority with cradle set CSA1. Transaction equipment (M1B1) which is transaction equipment (M1B) to which the user logs on as the store manager and has individual equipment identification information of #00S does not have the communication connection authority with cradle set CSA1.

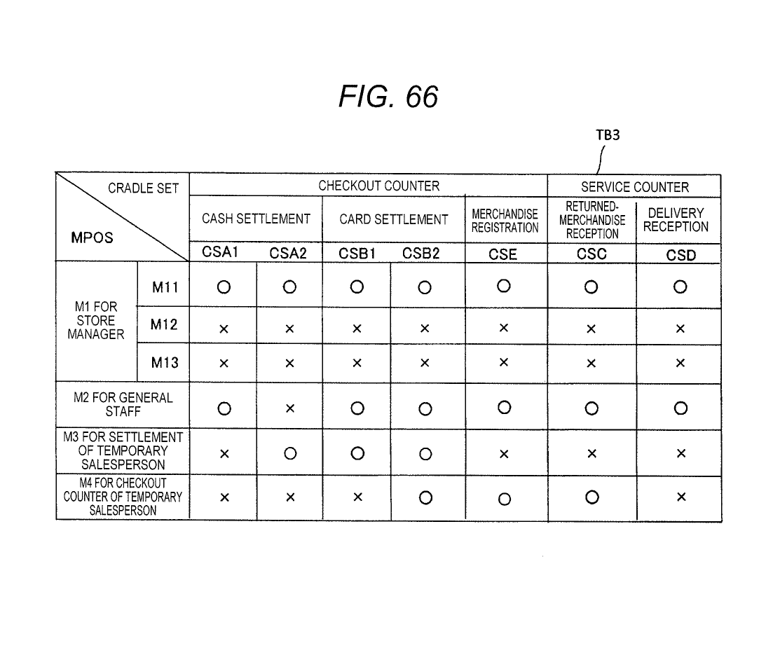

It has been described in the seventh and eighth exemplary embodiments that it is determined whether or not the transaction equipment has the communication connection authority based on the information of attribute table TB1 and individual equipment table TB2. It may be determined whether or not the transaction equipment has the communication connection authority based on the attribute information and the individual equipment identification information of transaction equipment 100 and the attribute information and the set identification information of the cradle set by using one communication connection authority table TB3 shown in FIG. 66 without using attribute table TB1 and individual equipment table TB2. That is, the tables may not be distinguished using the attribute information, the individual equipment identification information or the set identification information. The same applies in the ninth exemplary embodiment.

It has been described in the seventh and eighth exemplary embodiment that the information regarding the connection form of the cradle set is used as one of the attribute information items of the cradle set in attribute table TB1. Information regarding the on or off of the power supply of the cradle set may be used as the attribute information of the cradle set in attribute table TB1. For example, the information regarding of the on or off of the power supply of the cradle set includes information indicating whether or not all the power supplies of the equipments included in the cradle set are turned on or at least one power supply of the equipments is turned off. That is, it may be determined whether or not the communication connection of transaction equipment 100 with the cradle set is permitted based on the attribute information and the individual equipment identification information of transaction equipment 100 and the information regarding the on or off of the power supply of the cradle set and the set identification information of the cradle set. The same applies in the ninth exemplary embodiment.

In the seventh and eighth exemplary embodiments, the communication connection authority of one transaction equipment 100 for a store manager with each cradle set is permitted in individual equipment table TB2. The communication connection authority of the plurality of transaction equipments 100 for a store manager with each cradle set may be permitted in individual equipment table TB2. The same applies in the ninth exemplary embodiment.

In the seventh exemplary embodiment, magnetic card reader 43a, contact IC card reader 43b and non-contact IC card reader/writer 43c of transaction equipment 100 may be connected to first CPU 21a in secured area SA.

It has been mainly described in the seventh and eighth exemplary embodiments that transaction equipment 100 previously retains attribute table TB1 and individual equipment table TB2. Attribute table TB1 and individual equipment table TB2 may be stored in an external server, and transaction equipment 100 may obtain the stored tables from the external server before the cooperation is performed. Transaction equipment 100 may transmit the attribute information and the individual equipment identification information of transaction equipment 100 and the attribute information and the set identification information of the cradle set to the external server while storing attribute table TB1 and individual equipment table TB2 in the external server. The external server may determine whether or not the transaction equipment has the communication connection authority by referring to attribute table TB1 and individual equipment table TB2, and may transmit the determination result to transaction equipment 100, and transaction equipment 100 may determine whether or not the communication connection with the cradle set is permitted based on the determination result. The same applies in the ninth exemplary embodiment.

In the above-described exemplary embodiment, in a case where transaction equipment 100 has the communication connection authority, transaction equipment 100 may retain setting information for allowing transaction equipment 100 to perform the communication connection with the cradle set. The setting information may be retained in memory 51m of docking device 200, and the communication between transaction equipment 100 and the cradle set may be prohibited in docking device 200.

As described above, transaction processing system 1000 of the above-described exemplary embodiment includes portable transaction equipment 100, and docking device 200. Docking device 200 can be connected to the peripheral equipment used in the transaction process, and can be attached to and detached from transaction equipment 100. Transaction equipment 100 determines whether or not the communication connection with the cradle set including docking device 200 to which transaction equipment 100 is attached and the peripheral equipment connected to the docking device is permitted based on the attribute information and the identification information of transaction equipment 100. Transaction equipment 100 performs the communication connection with the cradle set in which the communication connection is permitted, and performs the transaction process.

Thus, transaction processing system 1000 can divide the communication connection authority with the cradle set to which transaction equipment 100 between the plurality of transaction equipments 100 having the same attribute (for example, the store manager). For example, first transaction equipment 100 for a store manager can be permitted so as to use the cradle set to which transaction equipment 100 is attached, and thus, it is possible to improve the business efficiency. Transaction processing system 1000 can prohibit second transaction equipment 100 for a store manager so as not to use the cradle set to which transaction equipment 100 is attached, and thus, it is possible to suppress the reduction in business efficiency. Accordingly, transaction processing system 1000 can improve the safety at the time of the transaction process in a case where portable transaction equipment 100 and the peripheral equipment (the cradle set) cooperate.

Transaction equipment 100 may determine whether or not the communication connection with the cradle set is permitted based on the attribute information and the set identification information of the cradle set.

Thus, transaction processing system 1000 can divide the communication connection authority with the cradle set to which transaction equipment 100 is attached between the plurality of transaction equipments 100 having the same attribute (for example, the cradle set for cash statement). For example, it is possible to improve the business efficiency by permitting transaction equipment 100 attached to a first cradle set for cash settlement so as to use the cradle set. It is possible to prevent the business efficiency from being decreased by prohibiting the transaction equipment connected to a second cradle set for cash settlement so as not to use the cradle set. Accordingly, transaction processing system 1000 can improve the safety at the time of the transaction process in a case where portable transaction equipment 100 and the peripheral equipment cooperate.

Transaction equipment 100 may determine whether or not there is the use restriction on the function of the cradle set based on the attribute information and the individual equipment identification information of transaction equipment 100, and may perform the transaction process using the function of the cradle set in which the use is not restricted.

Thus, transaction processing system 1000 can determine whether or not there is the use restriction on the function of the cradle set to which transaction equipment 100 is attached between the plurality of transaction equipments 100 having the same attribute (for example, the store manager). For example, first transaction equipment 100 for a store manager is not restricted so as to use the function of the cradle set to which transaction equipment 100 is attached, and thus, it is possible to improve the business efficiency. Transaction processing system 1000 can prevent the business efficiency from being decreased by restricting second transaction equipment 100 for a store manager so as not to use the function of the cradle set to which transaction equipment 100 is attached. Accordingly, transaction processing system 1000 can improve the safety at the time of the transaction process in a case where portable transaction equipment 100 and the peripheral equipment cooperate.

Transaction equipment 100 may determine whether or not there is the use restriction on the function of the cradle set based on the set identification information and the attribute information of the cradle set.

Accordingly, transaction processing system 1000 can determine whether or not there is the function use restriction on the cradle set to which transaction equipment 100 is attached between the plurality of transaction equipments 100 having the same attribute (for example, the cradle set for cash settlement). For example, it is possible to improve the business efficiency by permitting transaction equipment 100 attached to a first cradle set for cash settlement so as to use the cradle set. It is possible to prevent the business efficiency from being decreased by restricting transaction equipment 100 attached to a second cradle set for cash settlement so as not to use the function of the cradle set. Accordingly, transaction processing system 1000 can improve the safety at the time of the transaction process in a case where portable transaction equipment 100 and the peripheral equipment cooperate.

For example, the attribute information of transaction equipment 100 includes information regarding the registration of the user in transaction equipment 100 according to a predetermined employment position or responsible business, and information regarding the log-on of the user. The employment position includes, for example, a store manager, a general staff, and a temporary salesperson. The responsible business includes, for example, a checkout counter business, and an inventory business.

The attribute information of the cradle set may include information of the on or off of the power supply of docking device 200 or the peripheral equipment included in the cradle set.

Transaction processing system 1000 may includes a management device communicating with transaction equipment 100. Transaction equipment 100 may include first transaction equipment and second transaction equipment that have the same attribute information. The first transaction equipment may retain first communication connection permission and prohibition information for permitting or prohibiting first transaction equipment so as to perform or so as not to perform the communication connection with the cradle set. The first transaction equipment may determine whether or not the communication connection with the cradle set is permitted based on the first communication connection permission and prohibition information. The second transaction equipment may retain second communication connection permission and prohibition information for permitting or prohibiting second transaction equipment so as to perform or so as not to perform the communication connection with the cradle set. The second transaction equipment may determine whether or not the communication connection with the cradle set is permitted based on the second communication connection permission and prohibition information. The management device may set information for prohibiting the first transaction equipment so as not to perform the communication connection with the cradle set to the first communication connection permission and prohibition information and the second communication connection permission and prohibition information and may set information for permitting the second transaction equipment so as to perform the communication connection with the cradle set to the first communication connection permission and prohibition information and the second communication connection permission and prohibition information, based on a use stop request of the first transaction equipment. The management device may set information for cancelling the prohibition of the communication connection of the first transaction equipment with the cradle set to the first communication connection permission and prohibition information and the second communication connection permission and prohibition information and may set information for cancelling the permission of the communication connection of the second transaction equipment with the cradle set to the first communication connection permission and prohibition information and the second communication connection permission and prohibition information, based on a use return request of the first transaction equipment.

The management device is, for example, maintenance server 950. The first transaction equipment is, for example, transaction equipment 100R. The second transaction equipment is, for example, transaction equipment 100S. The first communication connection permission and prohibition information is, for example, information retained in attribute table TB1. The second communication connection permission and prohibition information is, for example, information retained in individual equipment table TB2. The use stop request is, for example, the repair notification. The use return request is, for example, the return notification.

Accordingly, for example, even in a case where first transaction equipment for a store manager is not allowed to be normally operated, second transaction equipment for a store manager can be used as substitute equipment, and thus, it is possible to improve the convenience of the user who uses transaction equipment 100. In a case where the first transaction equipment for a store manager which is not allowed to be normally operated is allowed to be normally operated, the communication connection authority of the second transaction equipment for a store manager operated as the substitute equipment is returned to the original state, and thus, it is possible to reduce a possibility that the information will leak from the second transaction equipment for a store manager.

Transaction equipment 100 of the above-described exemplary embodiment includes a connector, a determinator, and a transaction processor. The connector is a component for connecting the transaction equipment to the docking device capable of being connected to the peripheral equipment used in the transaction process. The determinator determines whether or not the communication connection with the cradle set including docking device 200 connected to the connector and the peripheral equipment connected to docking device 200 is permitted based on the attribute information and the individual equipment identification information of transaction equipment 100. The transaction processor performs the communication connection with the cradle set in which the communication connection is permitted, and performs the transaction process. The transaction processor is, for example, second CPU 31. The connector is, for example, docking device I/F 46. The determinator is, for example, second CPU 31.

Thus, it is possible to divide the communication connection authority with the cradle set to which transaction equipment 100 is attached between the plurality of transaction equipments 100 having the same attribute. For example, it is possible to improve the business efficiency by permitting first transaction equipment 100 for a store manager so as to use the cradle set to which transaction equipment 100 is attached. It is possible to prevent the business efficiency from being decreased by prohibiting second transaction equipment 100 for a store manager so as not to use the cradle set to which transaction equipment 100 is attached. Accordingly, transaction equipment 100 can improve the safety at the time of the transaction process in a case where portable transaction equipment 100 and the peripheral equipment cooperate.

In the transaction processing method of the above-described exemplary embodiment, the transaction process is performed using the function of the cradle set in which the use is not restricted by identifying the connection of the transaction equipment to the docking device capable of being connected to the peripheral equipment used in the transaction process, determining whether or not the communication connection with the cradle set including the docking device connected to transaction equipment 100 and the peripheral equipment connected to the docking device is permitted based on the attribute information and the individual equipment identification information of transaction equipment 100, and performing the communication connection with the cradle set in which the communication connection is permitted.

Thus, it is possible to divide the communication connection authority with the cradle set to which transaction equipment 100 is attached between the plurality of transaction equipments 100 having the same attribute. For example, it is possible to improve the business efficiency by permitting first transaction equipment 100 for a store manager so as to use the cradle set to which transaction equipment 100 is attached. It is possible to prevent the business efficiency from being decreased by prohibiting second transaction equipment 100 for a store manager so as not to use the cradle set which transaction equipment 100 is attached. Accordingly, transaction equipment 100 can improve the safety at the time of the transaction process in a case where portable transaction equipment 100 and the peripheral equipment cooperate.

While the exemplary embodiments of the transaction processing system according to the present invention have been described with reference to the accompanying drawings, the present disclosure is not limited to the exemplary embodiments. It will be apparent to those skilled in the art that various changes, modifications, substitutions, additions, deletions and their equivalents may be made without departing from the claims, and would fall within the technical scope of the present disclosure.

There is provided transaction equipment or a transaction processing method in the transaction equipment including: an application controller that controls the execution of a predetermined application, and checks whether or not the transaction equipment is connected to a docking device connected to at least one peripheral equipment used in the application. The application controller may set the transaction equipment in an operation restriction state in which an operation is restricted in a case where the connection check fails.

The application controller may set the transaction equipment in a locked state in which the operation is not able to be performed in the case where the connection check fails.

The application controller may change the state of the transaction equipment to an unlocked state in which the operation is able to be performed by an input of a predetermined password.

The application controller may restrict at least a part of functions of the transaction equipment in the case where the connection check fails.

There is provided transaction equipment or a transaction processing method in the transaction equipment including: an application controller that controls the execution of a predetermined application, and checks whether or not the transaction equipment is connected to a docking device connected to at least one peripheral equipment used in the application. The application controller may set the transaction equipment in an operation restriction state in which an operation is restricted in a case where the connection check fails and the detachment of the transaction equipment from the docking device is not performed according to a predetermined procedure.

The application controller may set the transaction equipment in a locked state in which the operation is not able to be performed in the case where the connection check fails and the detachment of the transaction equipment from the docking device is not performed according to a predetermined procedure.

The application controller may change the state of the transaction equipment to an unlocked state in which the operation is able to be performed by an input of a predetermined password.

The application controller may restrict at least a part of functions of the transaction equipment in the case where the connection check fails and the detachment of the transaction equipment from the docking device is not performed according to a predetermined procedure.

The application controller may cause predetermined information stored in the transaction equipment so as not to be read in the case where the connection check fails and the detachment of the transaction equipment from the docking device is not performed according to a predetermined procedure.

There is provided transaction equipment or a transaction processing method in the transaction equipment including: an application controller that controls the execution of a predetermined application, and checks whether or not transaction equipment is connected to a docking device connected to at least one peripheral equipment used in the application. The application controller may determine whether or not the detachment of the transaction equipment from the docking device is performed according to a predetermined procedure when the connection check fails, and changes the setting of the transaction equipment between a predetermined procedure case where the detachment is performed according to the predetermined procedure and an abnormality procedure case where the detachment is not performed according to the predetermined procedure.

The application controller may set passwords for changing the state of the transaction equipment to an unlocked state in which an operation is able to be performed so as to be different between the predetermined procedure case and the abnormality procedure case.

The application controller may set operations for changing the state of the transaction equipment to an unlocked state in which an operation is able to be performed so as to be different between the predetermined procedure case and the abnormality procedure case.

The application controller may set restricted functions of the transaction equipment so as to be different between the predetermined procedure case and the abnormality procedure case.

There is provided transaction equipment or a transaction processing method in the transaction equipment including: an application controller that is able to execute at least one of a settlement application and a business application; and an authentication controller that performs communication connection and authentication with respect to a docking device connected to at least one peripheral equipment used in the settlement application or the business application. The application controller may set the transaction equipment in a first operation restriction state in which an operation with respect to specific application of the settlement application and the business application is restricted in a case where a user with a specific authority does not log on to the transaction equipment after the authentication of the authentication controller fails due to the detachment of the transaction equipment from the docking device.

The application controller may set the transaction equipment in a first operation permission state in which an operation with respect to both the settlement application and the business application is permitted in a case where a user with a specific authority logs on to the transaction equipment after the authentication of the authentication controller fails due to the detachment of the transaction equipment from the docking device.

There is provided transaction equipment or a transaction processing method in the transaction equipment including: an application controller that is able to execute at least one of a settlement application and a business application; and an authentication controller that performs communication connection and authentication with respect to a docking device connected to at least one peripheral equipment used in the settlement application or the business application. The application controller may set the transaction equipment in a second operation restriction state in which an operation with respect to a specific application of the settlement application and the business application is restricted in a case where user information of a user with a specific authority is not registered in the transaction equipment after the authentication of the authentication controller fails due to the detachment of the transaction equipment from the docking device.

The application controller may set the transaction equipment in a second operation permission state in which an operation with respect to both the settlement application and the business application is permitted in a case where user information of a user with a specific authority is registered in the transaction equipment after the authentication of the authentication controller fails due to the detachment of the transaction equipment from the docking device.

There is provided transaction equipment or a transaction processing method in the transaction equipment including: an application controller that is able to execute at least one of a settlement application and a business application; and an authentication controller that performs communication connection and authentication with respect to a docking device connected to at least one peripheral equipment used in the settlement application or the business application. The application controller may set the transaction equipment in a third operation restriction state in which an operation with respect to a specific application of the settlement application and the business application is restricted, and may set the transaction equipment in a third operation permission state in which an operation with respect to both the settlement application and the business application is permitted from the third operation restriction state in a case where the transaction equipment is attached to a specific docking device to which specific peripheral equipment is connected.

The application controller may set the transaction equipment in a third operation restriction state in which an operation with respect to a specific application of the settlement application and the business application is restricted, and may maintain the setting of the third operation restriction state in a case where the transaction equipment is attached to a specific docking device to which specific peripheral equipment is connected.

There is provided transaction equipment or a transaction processing method in the transaction equipment including: an application controller that is able to execute at least one of a settlement application and a business application; and an authentication controller that performs communication connection and authentication with respect to a docking device connected to at least one peripheral equipment used in the settlement application or the business application. The application controller may set the transaction equipment in a fourth operation restriction state in which an operation with respect to a specific application of the settlement application and the business application is restricted, and may set the transaction equipment in a fourth operation permission state in which an operation with respect to both the settlement application and the business application is permitted from the fourth operation restriction state in a case where the transaction equipment is attached to the most recently attached docking device.

The application controller may set the transaction equipment in a fourth operation restriction state in which an operation with respect to a specific application of the settlement application and the business application is restricted, and may perform the setting of the fourth operation restriction state in a case where the transaction equipment is attached to the most recently attached docking device.

There is provided a transaction processing system including: portable transaction equipment; and a docking device which is capable of being connected to peripheral equipment used in a transaction process and is capable of being attached to and detached from the transaction equipment. The transaction equipment may determine whether or not communication connection with peripheral equipment connected to a docking device to which the transaction equipment is attached is permitted based on identification information of the transaction equipment, may perform the communication connection with the peripheral equipment in which the communication connection is permitted, and may perform the transaction process.

The transaction equipment may determine whether or not the communication connection with peripheral equipment connected to a docking device to which the transaction equipment is attached is permitted based on a user attribute of the transaction equipment.

The transaction equipment may determine whether or not communication connection with peripheral equipment connected to a docking device to which the transaction equipment is attached is permitted based on identification information of the transaction equipment, and an attribute of a cradle set indicating the combination of the docking device to which the transaction equipment is attached and peripheral equipment connected to the docking device.

The transaction equipment may obtain communication connection permission and prohibition information which is generated based on identification information of the transaction equipment and permits or prohibits communication connection with peripheral equipment connected to the docking device, may obtain attribute information of the cradle set indicating the combination of the docking device to which the transaction equipment is attached and the peripheral equipment connected to the docking device, and may determine whether or not the communication connection with the peripheral equipment connected to the docking device to which the transaction equipment is attached is permitted based on the obtained communication connection permission and prohibition information and the attribute information of the cradle set.

The communication connection permission and prohibition information may be generated based on the attribute information of the cradle set and the identification information of the transaction equipment.

The transaction equipment may determine whether or not the communication connection with the peripheral equipment connected to the docking device to which the transaction equipment is attached is permitted based on the on or off of a power supply of the peripheral equipment connected to the docking device.

There is provided transaction equipment that performs a transaction process. The transaction equipment may include a connector for connecting the transaction equipment to a docking device capable of being connected to peripheral equipment used in the transaction process; a determinator that determines whether or not communication connection with the peripheral equipment connected to the docking device connected to the connector is permitted based on identification information of the transaction equipment; and a transaction processor that performs the communication connection with the peripheral equipment in which the communication connection is permitted, and performs the transaction process.

There is provided a transaction processing method in transaction equipment that performs a transaction process. The transaction processing method may include identifying connection of the transaction equipment with a docking device capable of being connected to peripheral equipment used in the transaction process, determining whether or not communication connection with peripheral equipment connected to a docking device connected to the transaction equipment is permitted based on identification information of the transaction equipment, and performing the transaction process using the peripheral equipment in which the connection is permitted in a case where the communication connection with the peripheral equipment is permitted.

There is provided a transaction processing system including: portable transaction equipment; and a docking device which is capable of being connected to peripheral equipment used in a transaction process and is capable of being attached to and detached from the transaction equipment. The transaction equipment may determine whether or not there is use restriction on a function of a cradle set including a docking device to which the transaction equipment is attached and peripheral equipment connected to the docking device based on identification information of the transaction equipment, and may perform the transaction process using the function of the cradle set in which the use is not restricted.

The transaction equipment may determine whether or not there is use restriction on the function of the cradle set to which the transaction equipment is attached based on a user attribute of the transaction equipment.

The transaction equipment may determine whether or not there is use restriction on the function of the cradle set to which the transaction equipment is attached based on identification information of the transaction equipment and an attribute of the cradle set.

The transaction equipment may obtain function use restriction information which is generated based on identification information of the transaction equipment and restricts the use of the function of the cradle set, may obtain attribute information of the cradle set to which the transaction equipment is attached, and may determine whether or not there is use restriction on the function of the cradle set to which the transaction equipment is attached based on the obtained function use restriction information and the attribute information of the cradle set.

The function use restriction information is generated based on the attribute information of the cradle set and the identification information of the transaction equipment.

The transaction equipment may determine whether or not there is use restriction on the function of the cradle set to which the transaction equipment is attached based on the on or off of the power supply of the peripheral equipment connected to the docking device or the docking device to which the transaction equipment is attached.

There is provided transaction equipment that performs a transaction process. The transaction equipment may include a connector for connecting the transaction equipment to a docking device capable of being connected to peripheral equipment used in the transaction process; a determinator that determines whether or not there is use restriction on a function of a cradle set including a docking device connected to the connector and peripheral equipment connected to the docking device based on identification information of the transaction equipment; and a transaction processor that performs the transaction process using the function of the cradle set in which the use is not restricted.

There is provided a transaction processing method in transaction equipment that performs a transaction process. The transaction processing method may include identifying connection of the transaction equipment with a docking device capable of being connected to peripheral equipment used in the transaction process, determining whether or not there is use restriction on a function of a cradle set including a docking device connected to the transaction equipment and peripheral equipment connected to the docking device based on identification information of the transaction equipment, and performing the transaction process using the function of the cradle set in which the use is not restricted.

There is provided a transaction processing system including: portable transaction equipment; and a docking device which is capable of being connected to peripheral equipment used in a transaction process and is capable of being attached to and detached from the transaction equipment. The transaction equipment may determine whether or not communication connection with a cradle set including a docking device to which the transaction equipment is attached and peripheral equipment connected to the docking device is permitted based on attribute information and individual equipment identification information of the transaction equipment, may performed communication connection with the cradle set in which the communication connection is permitted, and may perform the transaction process.

The transaction equipment may determine whether or not the communication connection with the cradle set is permitted based on attribute information and set identification information of the cradle set.

The transaction equipment may determine whether or not use restriction on the function of the cradle set based on the attribute information and the individual equipment identification information of the transaction equipment, and may perform the transaction process using the function of the cradle set in which the use is not restricted.

The transaction equipment may determine whether or not there is use restriction on the function of the cradle set based on the attribute information and the set identification information of the cradle set.

The attribute information of the transaction equipment may include information regarding use registration related to a predetermined employment position or responsible business in the transaction equipment or the log-on of the user.

The attribute information of the cradle set may include information regarding the on or off of a power supply of the peripheral equipment or the docking device included in the cradle set.

The transaction processing system may further include a management device communicating with the transaction equipment. The transaction equipment may include first transaction equipment and second transaction equipment which have the same attribute information. The first transaction equipment may retain first communication connection permission and prohibition information for permitting or prohibiting the communication connection of the first transaction equipment with the cradle set, and may determine whether or not communication connection with the cradle set is permitted based on the first communication connection permission and prohibition information. The second transaction equipment may retain second communication connection permission and prohibition information for permitting or prohibiting the communication connection of the second transaction equipment with the cradle set, and may determine whether or not communication connection with the cradle set is permitted based on the second communication connection permission and prohibition information. The management device may set information for prohibiting the communication connection of the first transaction equipment with the cradle set to the first communication connection permission and prohibition information and the second communication connection permission and prohibition information, and may set information for permitting the communication connection of the second transaction equipment with the cradle set to the first communication connection permission and prohibition information and the second communication connection permission and prohibition information, based on a use stop request of the first transaction equipment. The management device may set information for cancelling the prohibition of the communication connection of the first transaction equipment with the cradle set to the first communication connection permission and prohibition information and the second communication connection permission and prohibition information, and may set information for cancelling the permission of the communication connection of the second transaction equipment with the cradle set to the first communication connection permission and prohibition information and the second communication connection permission and prohibition information, based on a use return request of the first transaction equipment.

There is provided transaction equipment that performs a transaction process. The transaction equipment may include a connector for connecting the transaction equipment to a docking device capable of being connected to peripheral equipment used in the transaction process; a determinator that determines whether or not communication connection with a cradle set including a docking device connected to the connector and peripheral equipment connected to the docking device is permitted based on attribute information and individual equipment identification information of the transaction equipment; and a transaction processor that performs communication connection with a cradle set in which communication connection is permitted, and performs the transaction process.

There is provided a transaction processing method in transaction equipment that performs a transaction process. The transaction processing method may include identifying connection of the transaction equipment with a docking device capable of being connected to peripheral equipment used in the transaction process, determining whether or not communication connection with a cradle set including a docking device connected to the transaction equipment and peripheral equipment connected to the docking device is permitted based on attribute information and individual equipment identification information of the transaction equipment, performing communication connection with a cradle set in which communication connection is permitted, and performing the transaction process.

A transaction processing system, transaction equipment and a transaction processing method obtained by appropriately combining the first exemplary embodiment to the ninth exemplary embodiment described above may be achieved.

It has been described in the above-described present exemplary embodiment that a settlement process using a credit card (more specifically, a magnetic credit card, connect IC credit card, or non-contact IC credit card) is used as an example of a card transaction of a purchaser, but the present disclosure is not limited to the settlement process using the credit card. For example, the present disclosure may be applied to a settlement process using a debit card, electronic money, a prepaid card, a postpaid card, a point card, an electronic coupon, an electronic merchandise certificate or cash.

1. Transaction equipment comprising:
an application controller that controls the execution of a predetermined application, and checks whether or not the transaction equipment is connected to a docking device connected to at least one peripheral equipment used in the application,
wherein the application controller sets the transaction equipment to be in an operation restriction state in which an operation is restricted in a case where the connection check fails.

2. The transaction equipment according to claim 1,
wherein the application controller sets the transaction equipment to be in a locked state in which the operation is not able to be performed in the case where the connection check fails.

3. The transaction equipment according to claim 2,
wherein the application controller changes the state of the transaction equipment to an unlocked state in which the operation is able to be performed by an input of a predetermined password.

4. The transaction equipment according to claim 1,
wherein the application controller restricts at least a part of functions of the transaction equipment in the case where the connection check fails.

5. Transaction equipment comprising:
an application controller that controls the execution of a predetermined application, and checks whether or not the transaction equipment is connected to a docking device connected to at least one peripheral equipment used in the application,
wherein the application controller sets the transaction equipment to be in an operation restriction state in which an operation is restricted in a case where the connection check fails and the detachment of the transaction equipment from the docking device is not performed according to a predetermined procedure.

6. The transaction equipment according to claim 5,
wherein the application controller sets the transaction equipment to be in a locked state in which the operation is not able to be performed in the case where the connection check fails and the detachment of the transaction equipment from the docking device is not performed according to a predetermined procedure.

7. The transaction equipment according to claim 6,
wherein the application controller changes the state of the transaction equipment to an unlocked state in which the operation is able to be performed by an input of a predetermined password.

8. The transaction equipment according to claim 5,
wherein the application controller restricts at least a part of functions of the transaction equipment in the case where the connection check fails and the detachment of the transaction equipment from the docking device is not performed according to a predetermined procedure.

9. The transaction equipment according to claim 5,
wherein the application controller causes predetermined information stored in the transaction equipment so as not to be read in the case where the connection check fails and the detachment of the transaction equipment from the docking device is not performed according to a predetermined procedure.

10. Transaction equipment comprising:
an application controller that controls the execution of a predetermined application, and checks whether or not transaction equipment is connected to a docking device connected to at least one peripheral equipment used in the application,
wherein the application controller determines whether or not the detachment of the transaction equipment from the docking device is performed according to a predetermined procedure when the connection check fails, and changes the setting of the transaction equipment between a predetermined procedure case where the detachment is performed according to the predetermined procedure and an abnormality procedure case where the detachment is not performed according to the predetermined procedure.

11. The transaction equipment according to claim 10,
wherein the application controller sets passwords for changing the state of the transaction equipment to an unlocked state in which an operation is able to be performed so as to be different between the predetermined procedure case and the abnormality procedure case.

12. The transaction equipment according to claim 10,
wherein the application controller sets operations for changing the state of the transaction equipment to an unlocked state in which an operation is able to be performed so as to be different between the predetermined procedure case and the abnormality procedure case.

13. The transaction equipment according to claim 10,
wherein the application controller sets restricted functions of the transaction equipment so as to be different between the predetermined procedure case and the abnormality procedure case.

14. A transaction processing method in transaction equipment, comprising:
causing an application controller to control the execution of a predetermined application, and to check whether or not the transaction equipment is connected to a docking device connected to at least one peripheral equipment used in the application,
wherein the application controller sets the transaction equipment to be in an operation restriction state in which an operation is restricted in a case where the connection check fails.

15. A transaction processing method in transaction equipment, comprising:
causing an application controller to control the execution of a predetermined application, and to check whether or not the transaction equipment is connected to a docking device connected to at least one peripheral equipment used in the application,
wherein the application controller sets the transaction equipment to be in an operation restriction state in which an operation is restricted in a case where the connection check fails and the detachment of the transaction equipment from the docking device is not performed according to a predetermined procedure.

16. A transaction processing method in transaction equipment, comprising:
causing an application controller to control the execution of a predetermined application, and to check whether or not the transaction equipment is connected to a docking device connected to at least one peripheral equipment used in the application,
wherein the application controller determines whether or not the detachment of the transaction equipment from the docking device is performed according to a predetermined procedure when the connection check fails, and changes the setting of the transaction equipment between a predetermined procedure case where the detachment is performed according to the predetermined procedure and an abnormality procedure case where the detachment is not performed according to the predetermined procedure.

17. A transaction processing system comprising:
the transaction equipment according to claim 1; and
a docking device which is capable of being connected to peripheral equipment used in a transaction process and is capable of being attached to and detached from the transaction equipment.
